(19) United States
(12) Patent Application Publication
(10) Pub. No.: US 2024/0373463 A1
(43) Pub. Date: Nov. 7, 2024

(54) COMMUNICATION CONTROL DEVICE, COMMUNICATION DEVICE, COMMUNICATION CONTROL METHOD, AND COMMUNICATION METHOD

(71) Applicant: SONY GROUP CORPORATION, TOKYO (JP)

(72) Inventors: Sho FURUICHI, TOKYO (JP); Hiroto KURIKI, TOKYO (JP)

(21) Appl. No.: 18/682,457

(22) PCT Filed: Jul. 1, 2022
(86) PCT No.: PCT/JP2022/026490

§ 371 Date: Feb. 9, 2024

(30) Foreign Application Priority Data
Aug. 23, 2021 (JP) 2021-135860

(51) Int. Cl. H04W 74/0816; H04W 16/28; H04W 60/04; H04W 74/08

(52) U.S. Cl. CPC H04W 74/0816; H04W 16/28; H04W 60/04; H04W 74/0875

(57) ABSTRACT

To enhance spectrum use efficiency of a communication device while appropriately protecting a beam pattern allowable for a protection target from radio wave interference by the communication device. A communication control device of the present disclosure includes a processing unit configured to: detect a first communication device capable of transmitting a signal in a target period on the basis of setting information defining a period in which a plurality of communication devices is capable of transmitting the signal; and determine a beam pattern allowable for the first communication device in the target period on the basis of an interference amount given to a protection target by the first communication device.

### TECHNICAL FIELD

The present disclosure relates to a communication control device, a communication device, a communication control method, and a communication method.

### BACKGROUND ART

Hitherto, due to increase in a wireless environment in which various wireless systems are mixed and an enrichment of content provided wirelessly, a problem of exhaustion of radio resources (spectrum) that can be allocated to the wireless systems has emerged. Accordingly, as a means for extracting necessary radio resources, “dynamic spectrum sharing (dynamic spectrum access (DSA))” using temporal and spatial vacancies (white spaces) in a frequency band allocated to a specific wireless system has rapidly attracted attention.

In the United States, a mechanism of DSA called Citizens Broadband Radio Service (CBRS) is introduced in the 3550-3700 MHz band and is commercially deployed. The current operation is based on CBRS Baseline Standards (Non-Patent Documents 1, 3, 4, and the like) called Release 1 formulated by the standardization organization Wireless Innovation Forum. In CBRS Release 1, a spectrum access system (SAS) uses zero-dimensional (antenna gain, horizontal plane azimuth angle) static antenna pattern (beam pattern) information of a broadband radio service device (CBSD) in a protection process of a protected entity. In recent years, with the aim of more effective use of frequencies and the like, discussions on an advanced standard called Release 2 are in progress. In CBRS Release 2, a feature called an “enhanced antenna pattern” which is a mechanism using one-dimensional (horizontal plane beam pattern envelope, vertical plane beam pattern envelope) and two-dimensional (antenna gain, horizontal plane azimuth angle, vertical plane azimuth angle) static antenna pattern (beam pattern) information is defined in WINNF-TS-1001 (Non-Patent Document 6) and WINNF-TS-3002 (Non-Patent Document 7). In the future, introduction of dynamic beamforming utilizing an active antenna system (AAS) is expected as further advancement. Note that, here, the horizontal plane beam pattern envelope and the vertical plane beam pattern envelope are referred to as one-dimensional antenna pattern information, and a combination of an antenna gain, a horizontal plane azimuth angle, and a vertical plane azimuth angle is referred to as two-dimensional antenna pattern information in accordance with the description of Release 2 specification of WInnForum. However, the former may be referred to as two-dimensional antenna pattern information, the latter may be referred to as three-dimensional antenna pattern information, or the like.

A mechanism for enhancing spectrum use efficiency in a case where dynamic beamforming utilizing an active antenna system (AAS) is introduced is required.

### CITATION LIST

### Non-Patent Document

Non-Patent Document 1: WINNF-TS-0112-V1.9.1 “Requirements for Commercial Operation in the U.S. 3550-3700 MHz Citizens Broadband Radio Service Band”
Non-Patent Document 2: Electronic Code of Federal Regulations, Title 47, Chapter I, Subchapter A, Part 1, Subpart X Spectrum Leasing [available at https://ecfr.federalregister.gov/current/title-47/chapter-I/subchapter-D/part-96]
Non-Patent Document 3: WINNF-TS-0061-V1.5.1 Test and Certification for Citizens Broadband Radio Service (CBRS); Conformance and Performance Test Technical Specification; SAS as Unit Under Test (UUT) [available at https://cbrs.wirelessinnovation.org/release-1-of-the-baseline-standard-specifications]
Non-Patent Document 4: WINNF-TS-0016-V1.2.4 Signaling Protocols and Procedures for Citizens Broadband Radio Service (CBRS): Spectrum Access System (SAS)—Citizens Broadband Radio Service Device (CBSD) Interface Technical Specification [available at https://cbrs.wirelessinnovation.org/release-1-of-the-baseline-standard-specifications]
Non-Patent Document 5: 940660 D02 CBSD Handshake Procedures v02 [available at https://apps.fcc.gov/kdb/GetAttachment.html?id=RQe7oZJVSWt0fCcNi BV%2Bfw%3D%3D&desc=940660%20D02%20CPE-CBSD%20Handshake%20Procedures%20v02&tracking_number=229297]
Non-Patent Document 6: WINNF-TS-1001-V1.2.0 “CBRS Operational and Functional Requirements (Release 2)” [available at https://cbrs.wirelessinnovation.org/enhancements-to-baseline-specifications]
Non-Patent Document 7: WINNF-TS-3002-V1.1.1 “Signaling Protocols and Procedures for Citizens Broadband Radio Service (CBRS): Extensions to Spectrum Access System (SAS)—Citizens Broadband Radio Service Device (CBSD) Interface Technical Specification (Release 2)” [available at https://cbrs.wirelessinnovation.org/enhancements-to-baseline-specifications]
Non-Patent Document 8: WINNF-SSC-0008-V1.3.0, “Spectrum Sharing Committee Policy and Procedure Coordinated Periodic Activities Policy”
Non-Patent Document 9: “940660 D02 CPE-CBSD Handshake Procedures v02”, Federal Communications Commission Office of Engineering and Technology Laboratory Division, October 2019, available at https://apps.fcc.gov/oetcf/kdb/forms/FTSSearchResultPage.cfm?id=229297&switch=P

### SUMMARY OF THE INVENTION

### Problems to be Solved by the Invention

In view of the above problems, an object of the present disclosure is to improve spectrum use efficiency while appropriately protecting a protection target from radio wave interference by a communication device.

### Solutions to Problems

A communication control device of the present disclosure includes a processing unit configured to: detect a first communication device capable of transmitting a signal in a target period on the basis of setting information defining a period in which a plurality of communication devices is capable of transmitting the signal; and determine a beam pattern allowable for the first communication device in the target period on the basis of an interference amount given to a protection target by the first communication device.

### BRIEF DESCRIPTION OF DRAWINGS

FIG. 1 is a diagram illustrating a system model in an embodiment of the present disclosure.

FIG. 2 is a diagram illustrating a network configuration to which autonomous decision-making can be applied.

FIG. 3 is a diagram illustrating a network configuration to which centralized decision-making can be applied.

FIG. 4 is a diagram illustrating a network configuration in a case where both the centralized decision-making and distributed decision-making are applied.

FIG. 5 is a diagram describing a three-tier structure in CBRS.

FIG. 6 is a diagram describing a flow of signaling between terminals.

FIG. 7 is a block diagram of a communication system according to a first embodiment of the present disclosure.

FIG. 8 is a diagram illustrating an example of a neighborhood area set around a protected entity.

FIG. 9 is a diagram illustrating an example of TDD Configuration of two CBSDs.

FIG. 10 is an explanatory diagram of an interference cumulative pattern.

FIG. 11 is a diagram illustrating an example of calculating a common portion of a plurality of beam patterns.

FIG. 12 is a diagram illustrating an example of controlling a beam pattern in units of symbols.

FIG. 13 is a diagram illustrating an example of controlling a beam pattern in an arbitrary time section unit.

FIG. 14 is a sequence diagram illustrating an example of performing a registration procedure, an available spectrum information query procedure, a spectrum grant procedure, and CPAS.

FIG. 15 is a diagram illustrating an example of TCCS (group).

FIG. 16 is a flowchart of an example of processing of SAS according to the second embodiment.

FIG. 17 illustrates an example of an envelope indicated in information provided from a communication device.

FIG. 18 is a diagram illustrating an example in which a frequency channel is made available to a communication device included in a secondary use prohibited area.

FIG. 19 is a diagram illustrating an example of determining allowable transmission power of a communication device according to a direction.

FIG. 20 is a diagram illustrating an example in which an envelope is obtained by setting a plurality of calculation points in a protection zone.

FIG. 21 is a diagram illustrating another example in which an envelope is obtained by setting a plurality of calculation points in a protection zone.

FIG. 22 is a diagram illustrating an example of obtaining an envelope for prohibiting beam radiation in a direction in which an FSS exists.

FIG. 23 is a flowchart of processing for calculating transmission power allowed for the communication device by the IAP.

FIG. 24 is a flowchart of processing for calculating transmission power allowed for the communication device by the IAP for each direction.

### MODE FOR CARRYING OUT THE INVENTION

Hereinafter, embodiments of the present disclosure will be described in detail with reference to the drawings. In one or more embodiments illustrated in the present disclosure, elements included in each of the embodiments can be combined with each other, and the combined result also forms a part of the embodiments described in the present disclosure.

### 1. Assumed Representative Scenario

### <1.1 System Model>

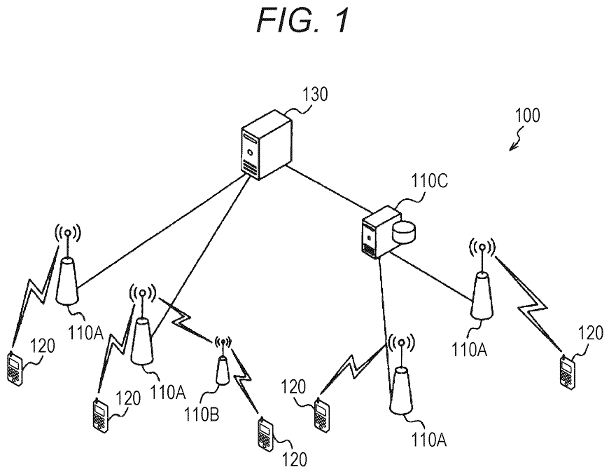

FIG. 1 illustrates a system model in an embodiment of the present invention. As illustrated in FIG. 1, this system model is represented by a communication network 100 including wireless communication, and typically includes the following entities.
Communication device 110
Terminal 120
Communication control device 130

Furthermore, this system model includes at least a primary system and a secondary system using the communication network 100. The primary system and the secondary system are configured by the communication device 110 or the communication device 110 and the terminal 120. Various communication systems can be treated as the primary system or the secondary system, but in the present embodiment, it is assumed that the primary system and the secondary system use some or all of a frequency band. Note that the respective frequency bands allocated to the primary system and the secondary system may partially or entirely overlap or may not overlap at all. That is, this system model will be described as a model of a wireless communication system related to dynamic spectrum sharing (dynamic spectrum access (DSA)). Note that this system model is not limited to systems related to dynamic spectrum sharing.

Typically, the communication device 110 is a wireless device that provides a wireless communication service to the terminal 120, such as a wireless base station (Base Station, Node B, eNB, gNB, or the like) or a wireless access point. That is, the communication device 110 provides a wireless communication service to enable wireless communication of the terminal 120. Furthermore, the communication device 110 may be a wireless relay device or an optical extension device called a remote radio head (RRH). In the following description, unless otherwise noted, the communication device 110 will be described as an entity constituting the secondary system.

The coverage (communication region) provided by the communication device 110 is allowed to have various sizes from a large size such as a macro cell to a small size such as a pico cell. Like a distributed antenna system (DAS), a plurality of communication devices 110 may form one cell. Furthermore, in a case where the communication device 110 has a capability of beamforming, a cell or a service area may be formed for each beam.

In the present disclosure, it is assumed that there are two different types of communication devices 110.

In the present disclosure, the communication device 110 that can access the communication control device 130 without using a wireless path that requires permission of the communication control device 130 is referred to as a “communication device 110A”. Specifically, for example, the communication device 110 capable of a wired Internet connection can be regarded as the “communication device 110A”. Furthermore, for example, even in a wireless relay device that does not have a wired Internet connection function, if a wireless backhaul link using a spectrum that does not require permission of the communication control device 130 is constructed with another communication device 110A, such a wireless relay device may also be regarded as the “communication device 110A”.

In the present disclosure, the communication device 110 that cannot access the communication control device 130 without a wireless path that requires permission of the communication control device 130 is referred to as a “communication device 110B”. For example, a wireless relay device that needs to construct a backhaul link using a spectrum that requires permission of the communication control device 130 can be regarded as a “communication device 110B”. Furthermore, for example, a device such as a smartphone having a wireless network provision function represented by tethering and using a spectrum that requires permission of the communication control device 130 in both the backhaul link and the access link may be handled as the “communication device 110B”.

The communication device 110 is not necessarily fixedly installed. For example, the communication device 110 may be installed in a mobile object such as an automobile. Furthermore, the communication device 110 does not necessarily need to exist on the ground. For example, the communication device 110 may be included in an object existing in the air or space, such as an aircraft, a drone, a helicopter, a high altitude platform station (HAPS), a balloon, or a satellite. Furthermore, for example, the communication device 110 may be included in an object existing on the sea or under the sea, such as a ship or a submarine. Typically, such a mobile communication device 110 corresponds to the communication device 110B, and performs wireless communication with the communication device 110A to secure an access path to the communication control device 130. As a matter of course, even the mobile communication device 110 can be handled as the communication device 110A as long as the spectrum used in the wireless communication with the communication device 110A is not managed by the communication control device 130.

In the present disclosure, unless otherwise specified, the description “communication device 110” includes both meanings of the communication device 110A and the communication device 110B, and may be replaced with either one.

The communication device 110 can be used, operated, or managed by various operators. For example, a mobile network operator (MNO), a mobile virtual network operator (MVNO), a mobile network enabler (MNE), a mobile virtual network enabler (MVNE), a shared facility operator, a neutral host network (NHN) operator, a broadcaster, an enterprise, an educational institution (educational institutions, respective boards of education of local governments, or the like), a real estate (building, apartment, or the like) administrator, an individual, and the like can be assumed as operators related to the communication device 110. Note that the operator related to the communication device 110 is not particularly limited. Further, the communication device 110A may be a shared facility used by a plurality of operators. Furthermore, different operators may perform installation, use, and management of the facilities.

The communication device 110 operated by the operator is typically connected to the Internet via a core network. Further, operation, management, and maintenance are performed by a function called Operation, Administration & Maintenance (OA&M). Furthermore, for example, as illustrated in FIG. 1, there may be an intermediate device (network manager) 110C that integrally controls the communication device 110 in the network. Note that there may be cases where the intermediate device is the communication device 110 or cases where the intermediate device is the communication control device 130.

The terminal 120 (User Equipment, User Terminal, User Station, Mobile Terminal, Mobile Station, or the like) is a device that performs wireless communication by a wireless communication service provided by the communication device 110. Typically, a communication device such as a smartphone corresponds to the terminal 120. Note that a device having a wireless communication function can correspond to the terminal 120. For example, a device such as a business camera having a wireless communication function can also correspond to the terminal 120 even if the wireless communication is not a main application. Furthermore, a communication device that transmits data to the terminal 120, such as a wireless station for broadcasting business (field pickup unit (FPU)) that transmits an image for television broadcasting or the like from an outside (site) of a broadcast station to the broadcast station in order to broadcast sports or the like, also corresponds to the terminal 120. Furthermore, the terminal 120 is not necessarily used by a person. For example, like what is called machine type communication (MTC), a device such as a factory machine or a sensor installed in a building may be network-connected to operate as the terminal 120. Furthermore, a device called customer premises equipment (CPE) provided to ensure connection to the Internet may behave as the terminal 120.

Furthermore, as represented by device-to-device (D2D) and vehicle-to-everything (V2X), the terminal 120 may include a relay communication function.

Furthermore, similarly to the communication device 110, the terminal 120 does not need to be fixedly installed or exist on the ground. For example, an object existing in the air or space, such as an aircraft, a drone, a helicopter, a satellite, or the like, may operate as the terminal 120. Furthermore, for example, an object existing on the sea or under the sea, such as a ship or a submarine, may operate as the terminal 120.

In the present disclosure, unless otherwise noted, the terminal 120 corresponds to an entity that terminates a wireless link using a spectrum that requires permission of the communication control device 130. However, depending on a function included in the terminal 120 or an applied network topology, the terminal 120 can perform an operation equivalent to that of the communication device 110. In other words, depending on the network topology, there may be cases where a device that can correspond to the communication device 110 such as a wireless access point corresponds to the terminal 120, or cases where a device that can correspond to the terminal 120 such as a smartphone corresponds to the communication device 110.

The communication control device 130 is typically a device that determines, permits, gives an instruction on, and/or manages communication parameters of the communication device 110. For example, database servers called TV white space database (TVWSDB), geolocation database (GLDB), spectrum access system (SAS), and automated frequency coordination (AFC) correspond to the communication control device 130. In other words, a database server having an authority and a role such as authentication and supervision of radio wave use related to secondary use of a frequency can be regarded as the communication control device 130.

The communication control device 130 also corresponds to a database server having a role different from the above-described role. For example, a control device that performs radio wave interference control between communication devices represented by a Spectrum Manager (SM) in EN 303 387 of the European Telecommunications Standards Institute (ETSI), a Coexistence Manager (CM) in the Institute of Electrical and Electronics Engineers (IEEE) 802.19.1-2018, a Coexistence Manager (CxM) in CBRSA-TS-2001, or the like also corresponds to the communication control device 130. Furthermore, for example, a registered location secure server (RLSS) defined in IEEE 802.11-2016 also corresponds to the communication control device 130. That is, not limited to these examples, an entity responsible for determination, use permission, instruction, management, and the like of the communication parameters of the communication device 110 may be referred to as the communication control device 130. Basically, the control target of the communication control device 130 is the communication device 110, but the communication control device 130 may control the terminal 120 subordinate to the communication device 110.

The communication control device 130 also corresponds to a combination of a plurality of database servers having different roles. For example, CBRS Alliance SAS (CSAS) which is a combination of SAS and CxM illustrated in CBRSA-TS-2001 can also be regarded as the communication control device 130.

The communication control device 130 can also be implemented by mounting software having a function equivalent to that of the database server on one database server. For example, a SAS having a function or software equivalent to CxM can also be regarded as the communication control device 130.

There may be a plurality of communication control devices 130 having similar roles. In a case where there is a plurality of communication control devices 130 having similar roles, at least one of the following three types of decision-making topologies can be applied to the communication control device 130.
Autonomous decision-making
Centralized decision-making
Distributed decision-making

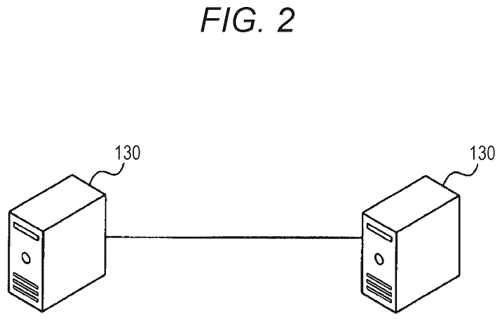

The autonomous decision-making is a decision-making topology in which an entity (the decision-making entity, here the communication control device 130) that makes a decision makes a decision independently from another decision-making entity. The communication control device 130 independently calculates necessary spectrum allocation and interference control. For example, in a case where a plurality of communication control devices 130 is arranged in a distributed manner as illustrated in FIG. 2, the autonomous decision-making can be applied.

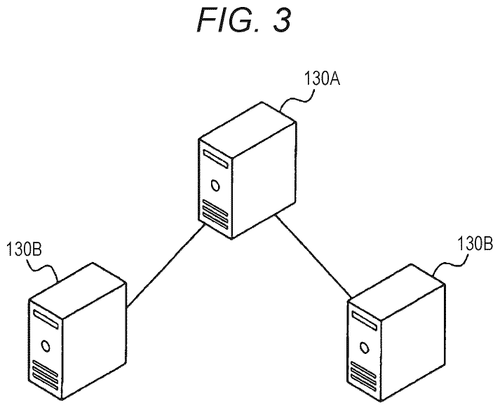

The centralized decision-making is a decision-making topology in which a decision-making entity delegates decision-making to another decision-making entity. In a case where the centralized decision-making is performed, for example, a model as illustrated in FIG. 3 can be assumed. FIG. 3 illustrates a model (what is called master-slave type) in which one communication control device 130 centrally controls a plurality of communication control devices 130. In the model of FIG. 3, the communication control device 130A, which is the master, can control the communication control devices 130B, which are a plurality of slaves, to intensively make decisions.

The distributed decision-making (distributed decision-making) is a decision-making topology in which a decision-making entity makes a decision in cooperation with another decision-making entity. For example, while a plurality of communication control devices 130 independently makes a decision as in the autonomous decision-making in FIG. 2, mutual adjustment of decision-making results, negotiation, and the like performed by each communication control device 130 after making a decision may correspond to “distributed decision-making”. Furthermore, for example, in the centralized decision-making in FIG. 3, for the purpose of load balancing or the like, performing dynamic delegation of decision-making authority to each slave communication control device 130B, deletion thereof, or the like by the master communication control device 130A can also be regarded as “distributed decision-making”.

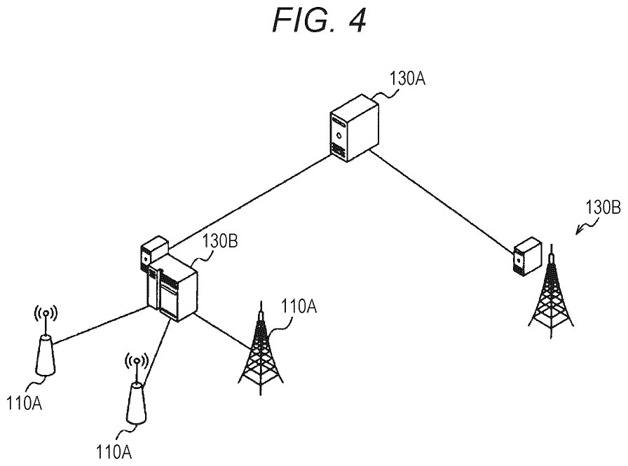

There may be cases where both the centralized decision-making and the distributed decision-making are applied. In FIG. 4, the slave communication control device 130B operates as an intermediate device that bundles the plurality of communication devices 110. It is not necessary for the master communication control device 130A to control the communication devices 110 bundled by the slave communication control device 130B, that is, the secondary system configured by the slave communication control device 130B. As described above, as a modification, implementation as illustrated in FIG. 4 is also possible.

The communication control device 130 may also acquire necessary information from entities other than the communication device 110 and the terminal 120 of the communication network 100 for its role. Specifically, for example, information necessary for protecting the primary system can be acquired from a database (regulatory database) managed or operated by a radio administration agency (national regulatory authority (NRA)) of a country or a region. Examples of the regulatory database include the Universal Licensing System (ULS) operated by the Federal Communications Commissions (FCC), and the like. Examples of information necessary for protecting the primary system include position information of the primary system, communication parameters of the primary system, out-of-band emission limit (OOBE), adjacent channel leakage ratio (ACLR), adjacent channel selectivity, fading margin, protection ratio (PR), and the like. In a region where a fixed numerical value, an acquisition method, a derivation method, and the like are defined by a law or the like in order to protect the primary system, it is desirable to use information defined by the law as information necessary for protecting the primary system.

Furthermore, a database that records the communication device 110 and the terminal 120 that have been subjected to conformity authentication, such as an equipment authorization system (EAS) managed by the Office of Engineering and Technology (OET) of the FCC, also corresponds to the regulatory database. From such a regulatory database, it is possible to acquire information regarding an operable spectrum of the communication device 110 or the terminal 120, information regarding maximum equivalent isotropic radiated power (EIRP), and the like. Naturally, the communication control device 130 may use these pieces of information for protecting the primary system.

Furthermore, it can also be assumed that the communication control device 130 acquires radio wave sensing information from a radio wave sensing system installed and operated for the purpose of radio wave detection in the primary system. As a specific example, in Citizens Broadband Radio Service (CBRS) in the United States, the communication control device 130 acquires radio wave detection information of a ship radar as a primary system from a radio wave sensing system called an environmental sensing capability (ESC). Furthermore, in a case where the communication device 110 and the terminal 120 have a sensing function, the communication control device 130 may acquire radio wave detection information of the primary system from these.

Furthermore, it can also be assumed that the communication control device 130 acquires the activity information of the primary system from a portal system that manages the activity information of the primary system. As a specific example, in Citizens Broadband Radio Service (CBRS) in the United States, the communication control device 130 acquires activity information of a primary system from a calendar-type system called Informing Incumbent Portal. Protection of the primary system is achieved by enabling a protection area called Dynamic Protection Area (DPA) on the basis of the acquired activity information. Protection of the primary system is also implemented by an equivalent system called Informing Incumbent Capability (IIC) in a similar manner.

The interface between the respective entities constituting this system model may be wired or wireless. For example, not only a wired line but also a wireless interface that does not depend on spectrum sharing may be used as an interface between the communication control device 130 and the communication device 110. Examples of the wireless interface that does not depend on spectrum sharing include a wireless communication line provided by a mobile network operator via a licensed band, Wi-Fi communication using an existing license-exempt band, and the like.

### <1.2 Terms Related to Spectrum and Sharing>

As described above, the present embodiment will be described assuming a dynamic spectrum sharing (Dynamic Spectrum Access) environment. As a representative example of the dynamic spectrum sharing, a mechanism defined by the CBRS in the United States (that is, a mechanism defined in Part 96 Citizens Broadband Radio Service of the FCC Rules of the United States) will be described.

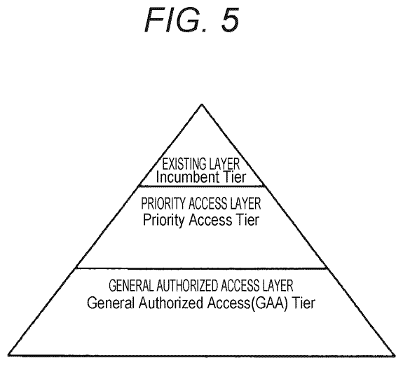

In the CBRS, as illustrated in FIG. 5, each of users in the frequency band is classified into one of three groups. This group is referred to as a tier. The three groups are referred to as an incumbent tier (existing layer), a priority access tier (priority access layer), and a general authorized access (GAA) tier (general authorized access layer), respectively.

The incumbent tier is a group including existing users who conventionally use frequency bands. The existing user is also generally referred to as a primary user. In the CBRS, the Department of Defense (DOD), fixed satellite operators, and new rule excepted radio broadband licensees (Grandfathered Wireless Broadband Licensees (GWBL)) in the United States are defined as existing users. The incumbent tier is not required to avoid interference to the priority access tier and the GAA tier with lower priorities or to suppress use of the frequency band. Furthermore, the incumbent tier is protected from interference by the priority access tier and the GAA tier. That is, users of the incumbent tier can use the frequency band without considering the existence of other groups.

The priority access tier is a group including users who use the frequency band on the basis of the above-described priority access license (PAL). A user of the priority access tier is also generally referred to as a secondary user. When the frequency band is used, the priority access tier is required to avoid interference and to suppress use of the frequency band for the incumbent tier having a higher priority than the priority access tier. On the other hand, neither avoiding interference nor suppressing use of the frequency band is required for the GAA tier having a lower priority than the priority access layer. Furthermore, the priority access tier is not protected from interference by the incumbent tier with a higher priority, but is protected from interference by the GAA tier with a lower priority.

The GAA tier is a group including frequency band users that do not belong to the incumbent tier and the priority access tier. Similarly to the priority access tier, in general, a user of the GAA tier is also referred to as a secondary user. However, since the priority of shared use is lower than that of the priority access tier, it is also referred to as a low priority secondary user. When the frequency band is used, the GAA tier is required to avoid interference and suppress use of the frequency band for the incumbent tier and the priority access tier having higher priorities. Furthermore, the GAA tier is not protected from interference by the incumbent tier and priority access tier with higher priority.

Although the CBRS mechanism has been described above as a representative example of the dynamic spectrum sharing, the present embodiment is not limited to the definition of CBRS. For example, as illustrated in FIG. 5, the CBRS generally employs a three-tier structure, but a two-tier structure may be employed in the present embodiment. Representative examples of the two-tier structure include authorized shared access (ASA), licensed shared access (LSA), evolved LSAs (eLSAs), TV band white space (TVWS), US 6 GHz band sharing, and the like. In the ASA, the LSA, and the eLSA, there is no GAA tier, and a structure equivalent to a combination of the incumbent tier and the priority access tier is employed. Further, in the TVWS and the US 6 GHz band sharing, there is no priority access tier, and a structure equivalent to a combination of the incumbent tier and the GAA tier is employed. Furthermore, there may be four or more tiers. Specifically, for example, four or more tiers may be generated by providing a plurality of intermediate layers corresponding to the priority access tiers and giving different priorities to the respective intermediate layers, and the like. Furthermore, for example, the tiers may be increased by similarly dividing the GAA tier and giving priorities, and the like. That is, each group may be divided.

Furthermore, the primary system of the present embodiment is not limited to the definition of CBRS. For example, as an example of the primary system, a wireless system such as TV broadcasting, a fixed microwave line (fixed system (FS)), a meteorological radar, a radio altimeter, a wireless train control system (communications-based train control), and a radio astronomy are assumed. In addition, it is not limited thereto, and any wireless system can be the primary system of the present embodiment.

Furthermore, as described above, the present embodiment is not limited to the environment of spectrum sharing. In general, in spectrum sharing or spectrum secondary use, an existing system that uses a target frequency band is referred to as a primary system, and a secondary user is referred to as a secondary system. However, in a case where the present embodiment is applied to an environment other than the spectrum sharing environment, they should be read by replacing with other terms. For example, a macro cell base station in a heterogeneous network (HetNet) may be the primary system, and a small cell base station or a relay station may be the secondary system. Furthermore, the base station may be a primary system, and a relay user equipment (UE) or a vehicle UE that implements D2D or V2X existing within its coverage may be the secondary system. The base station is not limited to a fixed type, and may be a portable type or a mobile type. In such a case, for example, the communication control device 130 of the present embodiment may be included in a core network, a base station, a relay station, a relay UE, or the like.

Furthermore, in a case where the present embodiment is applied to an environment other than the spectrum sharing environment, the term “frequency” in the present disclosure is replaced with another term shared by the application destination. For example, terms such as “resource”, “resource block”, “resource element”, “resource pool”, “channel”, “component carrier”, “carrier”, “subcarrier”, “bandwidth part (BWP)”, and “frequency range”, or another term having a meaning equivalent or similar thereto are assumed to be used.

### 2. Description of Various Procedures Assumed in Present Embodiment

Here, a basic procedure that can be used in the implementation of the present embodiment will be described. Note that up to <2.5> described later will be described on the assumption that the processing is mainly performed in the communication device 110A.

### <2.1 Registration Procedure>

A registration procedure is a procedure for registering information of a wireless system that intends to use the frequency band. More specifically, it is a procedure for registering a device parameter related to the communication device 110 of the wireless system in the communication control device 130. Typically, the registration procedure is started by that the communication device 110 representing a wireless system that intends to use the frequency band notifies the communication control device 130 of a registration request including a device parameter. Note that in a case where a plurality of communication devices 110 belongs to the wireless system that intends to use the frequency band, the device parameter of each of the plurality of communication devices is included in the registration request. Furthermore, a device that transmits the registration request as a representative of the wireless system may be appropriately determined.

### <2.1.1 Details of Required Parameters>

The device parameter refers to, for example, the following information.
Information regarding the user of the communication device 110 (hereinafter described as user information)
Information unique to the communication device 110 (hereinafter described as unique information)
Information regarding the position of the communication device 110 (hereinafter described as position information)
Information regarding an antenna included in the communication device 110 (hereinafter described as antenna information)
Information regarding the wireless interface included in the communication device 110 (hereinafter described as wireless interface information)
Legal information regarding the communication device 110 (hereinafter described as legal information)
Information regarding the installer of the communication device 110 (hereinafter described as installer information)
Information regarding the group to which the communication device 110 belongs (hereinafter, group information)

The device parameter is not limited to the above. Information other than these may be handled as the device parameter. Note that the device parameter does not need to be transmitted once, and may be transmitted a plurality of times. That is, a plurality of registration requests may be transmitted for one registration procedure. In this manner, one procedure or one process in the procedure may be performed a plurality of times. This similarly applies to the procedure described below.

The user information is information related to the user of the communication device 110. For example, a user ID, an account name, a user name, a user contact address, a call sign, and the like can be assumed. The user ID and the account name may be independently generated by the user of the communication device 110 or may be issued in advance by the communication control device 130. As the call sign, it is desirable to use a call sign issued by the NRA.

The user information can be used, for example, in an application of interference resolution. As a specific example, in the spectrum use notification procedure described in <2.5> to be described later, even if the communication control device 130 makes the use stop determination on the spectrum being used by the communication device 110 and gives an instruction based on the use stop determination, there may be a case where notification of the spectrum use notification request of the spectrum is continuously provided. In this case, suspecting a failure of the communication device 110, the communication control device 130 can give a behavior check request for the communication device 110 to the user contact address included in the user information. Not limited to this example, in a case where it is determined that the communication device 110 is performing an operation against communication control performed by the communication control device 130, the communication control device 130 can make a contact using the user information.

The unique information is information that can specify the communication device 110, product information of the communication device 110, information regarding hardware or software of the communication device 110, and the like.

The information that can specify the communication device 110 can include, for example, a manufacturing number (serial number) of the communication device 110, an ID of the communication device 110, and the like. The ID of the communication device 110 may be uniquely given by the user of the communication device 110, for example.

The product information of the communication device 110 can include, for example, information regarding an authentication ID, a product model number, a manufacturer, and the like. The authentication ID is, for example, an ID given from a certificate authority in each country or region, such as an FCC ID in the United States, a CE number in Europe, and a technical standards conformity certification (technical conformity) in Japan. An ID issued by an industry association or the like on the basis of a unique authentication program may also be regarded as the authentication ID.

The unique information represented by these may be used, for example, for a permission list (allowlist) or a denial list (denylist). For example, in a case where any piece of information regarding the communication device 110 in operation is included in the denial list, the communication control device 130 can instruct the communication device 110 to stop using the spectrum in the spectrum use notification procedure described in <2.5> described later. Moreover, the communication control device 130 can take a behavior of not canceling the usage stop measure until the communication device 110 is cancelled from the denial list. Furthermore, for example, the communication control device 130 can reject registration of the communication device 110 included in the denial list. Furthermore, for example, the communication control device 130 can also perform an operation that does not consider the communication device 110 corresponding to the information included in the denial list in the interference calculation of the present disclosure or that considers only the communication device 110 corresponding to the information included in the permission list in the interference calculation.

Note that, in the present disclosure, the FCC ID may be used as information regarding transmission power. For example, in an equipment authorization system (EAS) database, which is a type of regulatory database, information regarding a device for which authentication has been acquired can be acquired, and an application programming interface (API) thereof is also disclosed. For example, certified maximum EIRP information or the like can be included in the information together with the FCC ID. Since such power information is associated with the FCC ID, the FCC ID can be handled as transmission power information. Similarly, the FCC ID may be treated as equivalent to other information included in the EAS. Furthermore, not limited to the FCC ID, in a case where information associated with the authentication ID is present, the authentication ID may be treated as equivalent to the information.

The information regarding the hardware of the communication device 110 can include, for example, transmission power class information. For example, in Title 47 Code of Federal Regulations (C.F.R) Part 96 in the United States, two types of classes Category A and Category B are defined as the transmission power class information, and information regarding the hardware of the communication device 110 conforming to the definition can include information regarding which of the two types of classes it belongs to. Furthermore, in TS36.104 and TS 38.104 of 3rd Generation Partnership Project (3GPP), some classes of eNodeB and gNodeB are defined, and these definitions can also be used.

The transmission power class information can be used, for example, in an application of interference calculation. The interference calculation can be performed using the maximum transmission power defined for each class as the transmission power of the communication device 110.

The information regarding the software of the communication device 110 can include, for example, version information, a build number, and the like regarding an execution program in which processing necessary for interaction with the communication control device 130 is described. Furthermore, version information, a build number, and the like of software for operating as the communication device 110 may also be included.

The position information is typically information that can specify the position of the communication device 110. For example, it is coordinate information acquired by a positioning function represented by the Global Positioning System (GPS), Beidou, the Quasi-Zenith Satellite System (QZSS), Galileo, or the Assisted Global Positioning System (A-GPS). Typically, information related to latitude, longitude, ground level or sea level, altitude, and positioning error can be included. Alternatively, for example, the position information may be position information registered in an information management device managed by the National Regulatory Authority (NRA) or its entrusted institution. Alternatively, for example, coordinates of an X axis, a Y axis, and a Z axis with a specific geographical position as an origin may be used. Furthermore, together with such coordinate information, an identifier indicating whether the communication device 110 exists outdoors or indoors can be given.

Furthermore, the position information may include positioning accuracy information (location uncertainty). For example, both or one of a horizontal plane and a vertical plane may be provided as the positioning accuracy information. For example, the positioning accuracy information (location uncertainty) can be used as a correction value when calculating a distance to any point. Furthermore, for example, the positioning accuracy information can also be used as region information in which the communication device 110 may be located. In this case, it is used for processing of specifying spectrum information that can be used in the region indicated by the positioning accuracy information.

Furthermore, the position information may be information indicating a region in which the communication device 110 is located. For example, information indicating a region determined by the government, such as a postal code or an address, may be used. Furthermore, for example, the region may be indicated by a set of three or more geographic coordinates. These pieces of information indicating the region may be provided together with the coordinate information.

Furthermore, in a case where the communication device 110 is located indoors, information indicating the floor of a building where the communication device 110 is located can also be included in the position information. For example, an identifier indicating the floor number, the ground, or the underground, or the like can be included in the position information. Furthermore, for example, information indicating a further closed space inside a building, such as a room number and a room name in the building, can be included in the position information.

Typically, the positioning function is desirably included in the communication device 110. However, there may be cases where performance of the positioning function does not meet the required accuracy. Furthermore, even if performance of the positioning function satisfies the required accuracy, it may not always be possible to acquire the position information that satisfies the required accuracy depending on the installation position of the communication device 110. Therefore, a device different from the communication device 110 may include the positioning function, and the communication device 110 may acquire information related to the position from the device. The device having the positioning function may be an available existing device, or may be provided by an installer of the communication device 110. In such a case, it is desirable that the position information measured by the installer of the communication device 110 is written in the communication device 110.

The antenna information is typically information indicating performance, a configuration, and the like of an antenna included in the communication device 110. Typically, for example, information such as an antenna installation height, a tilt angle (downtilt), a horizontal orientation (azimuth), a boresight, an antenna peak gain, and an antenna model can be included.

Furthermore, the antenna information can also include information regarding a formable beam. For example, information such as a beam width, a beam pattern, and an analog or digital beamforming capability can be included.

Furthermore, the antenna information can also include information regarding performance and configuration of multiple input multiple output (MIMO) communication. For example, information such as the number of antenna elements and the maximum number of spatial streams (or the number of MIMO layers) can be included. Furthermore, codebook information to be used, weight matrix information, and the like can also be included. The weight matrix information includes a unitary matrix, a zero-forcing (ZF) matrix, a minimum mean square error (MMSE) matrix, and the like, which are obtained by singular value decomposition (SVD), eigen value decomposition (EVD), block diagonalization (BD), and the like. Furthermore, in a case where the communication device 110 includes a function such as maximum likelihood detection (MLD) that requires nonlinear calculation, information indicating the included function may be included in the antenna information.

Furthermore, the antenna information may include a zenith of direction, departure (ZoD). The ZoD is a type of radio wave arrival angle. Note that instead of being provided in notification from the communication device 110, the ZoD may be estimated and provided in notification by another communication device 110 from radio waves radiated from the antenna of the communication device 110. In this case, the communication device 110 may be a device that operates as a base station or an access point, a device that performs D2D communication, a moving relay base station, or the like. The ZoD may be estimated by a radio wave direction of arrival estimation technology such as multiple signal classification (MUSIC) or estimation of signal propagation via rotation invariance techniques (ESPRIT). Furthermore, the ZoD can be used by the communication control device 130 as measurement information.

The wireless interface information is typically information indicating a wireless interface technology included in the communication device 110. For example, identifier information indicating a technology used in GSM, CDMA2000, UMTS, E-UTRA, E-UTRA NB-IoT, 5G NR, 5G NR NB-IoT or a further next generation cellular system can be included as the wireless interface information. Furthermore, identifier information indicating a derivative technology based on Long Term Evolution (LTE)/5G such as MulteFire, Long Term Evolution-Unlicensed (LTE-U), or NR-Unlicensed (NR-U) can be included. Furthermore, identifier information indicating a standard technology such as a metropolitan area network (MAN) such as WiMAX or WiMAX2+ or a wireless LAN of the IEEE 802.11 series can also be included. Furthermore, identifier information indicating an extended global platform (XGP) or a shared XGP (sXGP) may be used. It may be identifier information of a communications technology for local power, wide area (LPWA). Further, identifier information indicating a proprietary wireless technology can also be included. Furthermore, a version number or a release number of the technical specification that defines these technologies may also be included as the wireless interface information.

Furthermore, the wireless interface information can also include frequency band information supported by the communication device 110. For example, the frequency band information can be represented by an upper limit frequency, a lower limit frequency, a center frequency, a bandwidth, a 3GPP operating band number, or a combination of at least two of these, or the like. Furthermore, one or more pieces of frequency band information can be included in the wireless interface information.

The frequency band information supported by the communication device 110 can further include information indicating capability of a band extension technology such as carrier aggregation (CA) or channel bonding. For example, combinable band information or the like can be included. Further, the carrier aggregation can also include information regarding a band desired to be used as a primary component carrier (PCC) or a secondary component carrier (SCC). Furthermore, the number of component carriers (the number of CCs) that can be aggregated at the same time can be included.

The frequency band information supported by the communication device 110 may further include information indicating a combination of frequency bands supported by the dual connectivity and the multi connectivity. In addition, information of another communication device 110 that cooperatively provides the dual connectivity and the multi connectivity may also be provided. The communication control device 130 may perform determination of the communication control disclosed in the present embodiment in consideration of another communication device 110 having a cooperative relationship or the like in subsequent procedures.

The frequency band information supported by the communication device 110 may also include information indicating radio wave usage priority such as PAL and GAA.

Furthermore, the wireless interface information can also include modulation scheme information supported by the communication device 110. For example, as a representative example, information indicating a primary modulation scheme such as frequency shift keying (FSK), n-value phase shift keying (PSK, where n is a multiplier of two, such as two, four, eight, or the like), and n-value quadrature amplitude modulation (QAM, where n is a multiplier of four, such as four, 16, 64, 256, 1024) can be included. Furthermore, information indicating a secondary modulation scheme such as orthogonal frequency division multiplexing (OFDM), scalable OFDM, DFT spread OFDM (DFT-s-OFDM), generalized frequency division multiplexing (GFDM), and filter bank multi carrier (FBMC) can be included.

Furthermore, the wireless interface information can also include information regarding an error correction code. For example, capabilities of a turbo code, a low density parity check (LDPC) code, a polar code, an erasure correction code, and the like, and coding rate information to be applied can be included.

The modulation scheme information and the information regarding the error correction code can also be expressed by a modulation and coding scheme (MCS) index as another aspect.

Furthermore, the wireless interface information can also include information indicating a function specific to each wireless technical specification supported by the communication device 110. For example, as a representative example, there is transmission mode (TM) information defined in LTE. In addition, those having two or more modes for a specific function can be included in the wireless interface information such as TM information. Furthermore, in the technical specification, in a case where the communication device 110 supports a function that is not essential in the specification even if there are not two or more modes, information indicating the supported function can also be included.

Furthermore, the wireless interface information can also include radio access technology (RAT) information supported by the communication device 110. For example, information indicating time division multiple access (TDMA), frequency division multiple access (FDMA), orthogonal frequency division multiple access (OFDMA), power division multiple access (PDMA), code division multiple access (CDMA), sparse code multiple access (SCMA), interleave division multiple access (IDMA), spatial division multiple access (SDMA), carrier sense multiple access/collision avoidance (CSMA/CA), carrier sense multiple access/collision detection (CSMA/CD), or the like can be included. Note that the TDMA, FDMA, and OFDMA are classified into orthogonal multiple access (OMA). The PDMA, CDMA, SCMA, IDMA, and SDMA are classified into non-orthogonal multiple access (NOMA). A representative example of the PDMA is a method implemented by a combination of superposition coding (SPC) and successive interference canceller (SIC). The CSMA/CA and CSMA/CD are classified into opportunistic access.

In a case where the wireless interface information includes information indicating the opportunistic access, information indicating details of the access method may be further included. As a specific example, information indicating which of frame based equipment (FBE) and load based equipment (LBE) defined in EN 301 598 of ETSI may be included.

In a case where the radio interface information indicates the LBE, the wireless interface information may further include LBE-specific information such as a priority class.

Furthermore, the wireless interface information can also include information regarding a duplex mode supported by the communication device 110. As a representative example, information regarding a method such as frequency division duplex (FDD), time division duplex (TDD), or full duplex (FD) can be included for example.

In a case where TDD is included as the wireless interface information, TDD frame structure information used or supported by the communication device 110 can be given. Furthermore, information related to the duplex mode may be included for each frequency band indicated by the frequency band information.

In a case where the FD is included as the wireless interface information, information regarding an interference power detection level may be included.

Furthermore, the wireless interface information can also include information regarding a transmission diversity method supported by the communication device 110. For example, space time coding (STC) or the like may be included.

Furthermore, the wireless interface information can also include guard band information. For example, information regarding a predetermined guard band size in the wireless interface can be included. Alternatively, for example, information regarding a guard band size desired by the communication device 110 may be included.

Regardless of the aspects described above, the wireless interface information may be provided for each frequency band.

The legal information is typically information regarding regulations that the communication device 110 has to comply with and defined by the radio administration agency or an equivalent agency in each country or region, authentication information acquired by the communication device 110, or the like. Typically, the information regarding the regulations can include, for example, upper limit information of out-of-band radiation, information regarding a blocking characteristic of the receiver, and the like. Typically, the authentication information can include, for example, type approval information, legal regulation information serving as a reference of authentication acquisition, and the like. The type approval information corresponds to, for example, FCC ID in the United States, the technical standards conformity certification in Japan, and the like. The legal regulation information corresponds to, for example, FCC regulation numbers in the United States, ETSI Harmonized Standard number in Europe, and the like.

Among the legal information, regarding numerical values, those defined in the standard specification of wireless interface technology may be substituted. The standard specification of the wireless interface technology corresponds to, for example, 3GPP TS 36.104, TS 38.104, or the like. An adjacent channel leakage ratio (ACLR) is defined therein. Instead of the upper limit information of the out-of-band radiation, the upper limit of the out-of-band radiation may be derived and used using the ACLR defined in the standard specification. Further, the ACLR itself may be used as necessary. Furthermore, adjacent channel selectivity (ACS) may be used instead of the blocking characteristic. Further, these may be used in combination, or an adjacent channel interference ratio (ACIR) may be used. Note that, in general, the ACIR has the following relationship with the ACLR and ACS.

$$[ Math . 1 ]$$

$$ACIR = {( \frac{1}{ACS} + \frac{1}{ACLR} )}^{- 1} \qquad ( 1 )$$

Note that although Expression (1) uses true value expression, Expression (1) may be expressed by logarithmic expression.

The installer information can include information capable of specifying a person who installs the communication device 110 (installer), unique information associated with the installer, and the like. Typically, the installer information can include information regarding a person who is responsible for the position information of the communication device 110, such as a certified professional installer (CPI) defined in Non-Patent Document 2. The CPI discloses certified professional installer registration ID (CPIR-ID) and CPI name. Furthermore, as unique information associated with the CPI, for example, a contact address (mailing address or contact address), an e-mail address, a telephone number, a public key identifier (PKI), and the like are disclosed. It is not limited thereto, and other information related to the installer may be included in the installer information as necessary.

The group information can include information regarding the communication device group to which the communication device 110 belongs. Specifically, for example, information related to the same or equivalent type of group as disclosed in WINNF-SSC-0010 can be included. Furthermore, for example, in a case where the communication operator manages the communication devices 110 in units of groups according to its own operation policy, information regarding the groups can be included in the group information.

The information listed so far may be estimated by the communication control device 130 from other information provided from the communication device 110 without the communication device 110 providing the information to the communication control device 130. Specifically, for example, the guard band information can be estimated from the wireless interface information. In a case where the wireless interface used by the communication device 110 is E-UTRA or 5G NR, it can be estimated on the basis of the transmission bandwidth specification of E-UTRA described in 3GPP TS36.104, the transmission bandwidth specification of 5G NR described in 3GPP TS38.104, and tables described in TS38.104 illustrated below.

TABLE 1
Table 5.6-1 Transmission bandwidth configuration
NRB in E-UTRA channel bandwidths (QUOTED
FROM Table 5.6-1 OF 3GPP TS36.104)

| | Channel bandwidth BW_{Channel} [MHz] | | | | | |
|---|---|---|---|---|---|---|
| | 1.4 | 3 | 5 | 10 | 15 | 20 |
| Transmission | 6 | 15 | 25 | 50 | 75 | 100 |
| bandwidth | | | | | | |
| configuration N_{RB} | | | | | | |

TABLE 2
Table 5.3.3-1: Minimum guardband (kHz) (FR1) (QUOTED FROM Table 5.3.3-1 OF 3GPP TS38.104)

| SCS | 5 | 10 | 15 | 20 | 25 | 30 | 40 | 50 | 60 | 70 | 80 | 90 | 100 |
|---|---|---|---|---|---|---|---|---|---|---|---|---|---|
| (kHz) | MHz | MHz | MHz | MHz | MHz | MHz | MHz | MHz | MHz | MHz | MHz | MHz | MHz |
| 15 | 242.5 | 312.5 | 382.5 | 452.5 | 522.5 | 592.5 | 552.5 | 692.5 | N.A | N.A | N.A | N.A | N.A |
| 30 | 505 | 665 | 645 | 805 | 785 | 945 | 905 | 1045 | 825 | 965 | 925 | 885 | 845 |
| 60 | N.A | 1010 | 990 | 1330 | 1310 | 1290 | 1610 | 1570 | 1530 | 1490 | 1450 | 1410 | 1370 |

TABLE 3
Table 5.3.3-2: Minimum guardband (kHz) (FR2)
(QUOTED FROM Table 5.3.3-2 OF 3GPP TS38.104)

| SCS | 50 | 100 | 200 | 400 |
|---|---|---|---|---|
| (kHz) | MHz | MHz | MHz | MHz |
| 60 | 1210 | 2450 | 4930 | N.A |
| 120 | 1900 | 2420 | 4900 | 9860 |

TABLE 4
Table 5.3.3-3: Minimum guardband (kHz)
of SCS 240 kHz SS/PBCH block (FR2) (QUOTED
FROM Table 5.3.3-3 OF 3GPP TS38.104)

| SCS | 100 | 200 | 400 |
|---|---|---|---|
| (kHz) | MHz | MHz | MHz |
| 240 | 3800 | 7720 | 15560 |

In other words, it is sufficient that the communication control device 130 can acquire the information listed so far, and the communication device 110 is not necessarily required to provide the information to the communication control device 130. Furthermore, the intermediate device 130B (for example, a network manager) that bundles the plurality of communication devices 110 does not need to provide the information to the communication control device 130A. Providing information by the communication device 110 or the intermediate device 130B to the communication control device 130 or 130A is merely one means of information provision in the present embodiment. The information listed so far means information that can be necessary for the communication control device 130 to normally complete this procedure, and means for providing the information does not matter. For example, in WINNF-TS-0061, such a method is called multi-step registration and allowed.

Furthermore, as a matter of course, the information listed so far is selectively applicable depending on the local legal system and technical specifications.

### <2.1.1.1 Supplement of Required Parameters>

In the registration procedure, in some cases, it is assumed that the device parameters related to not only the communication device 110 but also the terminal 120 are required to be registered in the communication control device 130. In such a case, the term “communication device” in the description given in <2.1.1> may be replaced with a term “terminal” or a similar term. Furthermore, a parameter specific to “terminal” that is not described in <2.1.1> may also be handled as a required parameter in the registration procedure. For example, there is a user equipment (UE) category defined in 3GPP, and the like.

### <2.1.2 Details of Registration Processing>

As described above, the communication device 110) representing the wireless system that intends to use the frequency band generates a registration request including the device parameter and notifies the communication control device 130 of the registration request.

Here, in a case where the installer information is included in the device parameters, the communication device 110 may perform tamper-proof processing or the like on the registration request by using the installer information. Furthermore, a part or all of the information included in the registration request may be subjected to encryption processing. Specifically, for example, a unique public key may be shared in advance between the communication device 110 and the communication control device 130, and the communication device 110 may encrypt information using a secret key corresponding to the public key. Examples of the encryption target include security sensitive information such as position information.

Note that there may be cases where the ID and the position information of the communication device 110 are disclosed, and the communication control device 130 holds in advance the ID and the position information of the main communication device 110 existing in its coverage. In such a case, since the communication control device 130 can acquire the position information from the ID of the communication device 110 that has transmitted the registration request, the position information does not need to be included in the registration request. Furthermore, it is also conceivable that the communication control device 130 returns a necessary device parameter to the communication device 110 that has transmitted the registration request, and in response to this, the communication device 110 transmits a registration request including the device parameter necessary for registration. In this manner, the information included in the registration request may be different depending on the case.

After receiving the registration request, the communication control device 130 performs registration processing of the communication device 110 and returns a registration response according to a processing result. If there is no shortage or abnormality of information necessary for registration, the communication control device 130 records the information in an internal or external storage device and provides notification of normal completion. Otherwise, notification of a registration failure is provided. In a case where the registration is normally completed, the communication control device 130 may allocate an ID to each of the communication devices 110 and notify the communication devices of the ID information at the time of response. In a case where the registration fails, the communication device 110 may provide notification of the corrected registration request again. Furthermore, the communication device 110 may change the registration request and try the registration procedure until it is normally completed.

Note that the registration procedure may be executed even after the registration is normally completed. Specifically, for example, the registration procedure can be re-executed in a case where the position information is changed beyond a predetermined standard due to movement, accuracy improvement, or the like. The predetermined standard is typically determined by the legal system in each country or region. For example, in 47 C.F.R. Part 15 in the United States, a Mode II personal/portable white space device, that is, a device using a free spectrum is required to perform registration again in a case where its position changes by 100 meters or more.

### <2.2 Available Spectrum Information Query Procedure (Available Spectrum Query Procedure)>

The available spectrum information query procedure is a procedure in which a wireless system that intends to use a frequency band inquires of the communication control device 130 for information regarding an available spectrum. Note that the available spectrum information query procedure does not necessarily need to be performed. Furthermore, the communication device 110 that makes an inquiry on behalf of the wireless system that intends to use the frequency band may be the same as or different from the communication device 110 that has generated the registration request. Typically, the communication device 110 that makes an inquiry notifies the communication control device 130 of a query request including information that can specify the communication device 110, and thereby the procedure is started.

Here, typically, the available spectrum information is information indicating a spectrum in which the communication device 110 can safely perform secondary use without giving fatal interference to the primary system.

The available spectrum information is determined, for example, on the basis of a secondary use prohibited area called an exclusion zone. Specifically, for example, in a case where the communication device 110 is installed in the secondary use prohibited area provided for the purpose of protecting the primary system using the frequency channel F1, a notification of the frequency channel F1 is not provided to the communication device 110 as an available channel.

The available spectrum information can also be determined, for example, by the degree of interference to the primary system. Specifically, for example, in a case where it is determined that the critical interference is given to the primary system even outside the secondary use prohibited area, the frequency channel may not be provided in notification as an available channel. An example of a specific calculation method is described in <2.2.2> described later.

Furthermore, as described above, there may be frequency channels that are not provided in notification as available due to conditions other than primary system protection requirements. Specifically, for example, in order to avoid interference that may occur between the communication devices 110 in advance, there may be cases where a frequency channel being used by another communication device 110 existing in the vicinity of the communication device 110 is not provided in notification as an available channel. In this manner, the available spectrum information set in consideration of interference with the other communication device 110 may be set as, for example, “use recommended spectrum information” and provided together with the available spectrum information. That is, the “use recommended spectrum information” is desirably a subset of the available spectrum information.

Even in a case of affecting the primary system, if the influence can be avoided by reducing the transmission power, the same frequency as that of the primary system or the communication device 110 in the vicinity may be provided in notification as an available channel. In such a case, typically, maximum allowable transmission power information is included in the available spectrum information. The maximum allowable transmission power is typically expressed by EIRP. The present embodiment is not necessarily limited to this, and may be provided by, for example, a combination of antenna power (conducted power) and antenna gain. Moreover, the antenna gain may be set to an allowable peak gain for each spatial direction.

### <2.2.1 Details of Required Parameters>

As the information that can specify the wireless system that intends to use the frequency band, for example, unique information registered at the time of the registration procedure, the above-described ID information, and the like can be assumed.

Furthermore, the query request can also include query requirement information. The query requirement information can include, for example, information indicating a frequency band for which it is desired to know whether or not it is available. Furthermore, for example, transmission power information can be included. The communication device 110 that makes an inquiry can include transmission power information, for example, in a case where it is desired to know only spectrum information in which it is likely that desired transmission power can be used. The query requirement information does not necessarily need to be included in the query request.

The information indicating the frequency band may also include information indicating a format of the available spectrum information. In the IEEE 802.11 standard, a channel number is defined for each band. For example, a flag for requesting availability of a channel defined in such wireless interface technical specification may be included. As another form, a flag for requesting availability of a unit spectrum range instead of a defined channel may be included. In a case where the unit spectrum is 1 MHz, available spectrum information is requested for each spectrum range of 1 MHz. In a case where this flag is used, the desired unit spectrum information may be enclosed in the flag.

Furthermore, the query request can also include a measurement report. The measurement report includes a result of measurement performed by the communication device 110 and/or the terminal 120. Some or all of the measurement results may be represented by raw data or may be represented by processed data. For example, standardized metrics represented by reference signal received power (RSRP), reference signal strength indicator (RSSI), and reference signal received quality (RSRQ) can be used for measurement.

### <2.2.2 Details of Available Spectrum Evaluation Processing>

After receiving the query request, the available spectrum is evaluated on the basis of the query requirement information. For example, as described above, the available spectrum can be evaluated in consideration of existence of the primary system, the secondary use prohibited area thereof, and the communication device 110 in the vicinity.

The communication control device may derive the secondary use prohibited area. For example, in a case where the maximum transmission power P_{MaxTx(dBm)} and the minimum transmission power P_{MinTx(dBm)} are defined, it is possible to calculate the range of the separation distance between the primary system and the secondary system from the following expression and determine the secondary use prohibited area.

$${{PL}^{- 1} ( {P}_{MaxTx ( dBm )} - {I}_{Th ( dBm )} )}_{( dB )} \leq d < {{PL}^{- 1} ( {P}_{MinTx ( dBm )} - {I}_{Th ( dBm )} )}_{( dB )} \qquad [ Math . 2 ]$$

I_{Th(dBm)} is an allowable interference power (a limit value of the allowable interference power), d is a distance between a predetermined reference point (Reference Point) and the communication device 110, and PL( )_{(dB)} is a function of a propagation loss. Thus, the frequency availability can be determined according to the positional relationship between the primary system and the communication device 110. In addition, in a case where transmission power information or power range information desired to be used by the communication device 110 is supplied in a request, the frequency availability can be determined by calculating PL⁻¹(P_{Tx(dBm)}−I_{Th(dBm)}) and comparing with the range expression.

The maximum allowable transmission power information may be derived. Typically, the maximum allowable transmission power information is calculated by using allowable interference power information in the primary system or a protection zone thereof, position information of a reference point for calculating an interference power level suffered by the primary system, registration information of the communication device 110, and a propagation loss estimation model. Specifically, as an example, it is calculated by the following mathematical expression.

$$[ Math . 3 ]$$

$${P}_{MaxTx ( dBm )} = {I}_{Th ( dBm )} + {PL ( d )}_{( dB )} \qquad ( 2 )$$

In Expression (2), the antenna gain in a transceiver is not included, but the antenna gain in the transceiver may be included according to the maximum allowable transmission power expression method (EIRP, conducted power, and the like) or the reception power reference point (antenna input point, antenna output point, and the like). Further, a safety margin or the like for compensating for variation due to fading may be included. Furthermore, feeder loss may be considered as necessary. In addition, it is possible to similarly calculate a neighboring channel by adding an Adjacent channel leakage ratio (ACRL) and an out-of-band radiation maximum value.

Furthermore, Expression (2) is described on the basis of the assumption that a single communication device 110 is an interference source (single station interference). For example, in a case where it is necessary to consider aggregated interference from a plurality of communication devices 110 at the same time, a correction value may be added. Specifically, for example, the correction value can be determined on the basis of three types (fixed/predetermined, flexible, flexible minimized) of interference margin distribution methods disclosed in Non-Patent Document 3 (ECC Report 186).

Note that the allowable interference power information itself is not necessarily directly available as in Expression (2). For example, in a case where a required signal power-to-interference power ratio (SIR) of the primary system, a signal to interference plus noise ratio (SINR), and the like are available, they may be converted into allowable interference power and used. Note that such conversion processing is not limited to this processing, and may be applied to processing of other procedures.

Note that although Expression (2) is expressed using logarithms, as a matter of course, it may be used by converting into true numbers at the time of implementation. Furthermore, all parameters in logarithmic notation described in the present disclosure may be used by appropriately converting into true numbers.

Furthermore, in a case where the above-described transmission power information is included in the query requirement information, the available spectrum can be evaluated by a method different from the above-described method. Specifically, for example, in a case where it is assumed that desired transmission power indicated by transmission power information is used, when an estimated interference quantity is less than allowable interference power in the primary system or a protection zone thereof, it is determined that the frequency channel is available, and a notification of the frequency channel is provided to the communication device 110.

Furthermore, for example, in a case where an area or a space in which the communication device 110 can use the frequency band is determined in advance similarly to an area of a radio environment map (REM), the available spectrum information may be simply derived on the basis of only coordinates (coordinates or latitude, longitude, and ground level of the X axis, the Y axis, and the Z axis of communication device 110) included in the position information of the communication device 110. Furthermore, for example, even in a case where a lookup table that associates coordinates of a position of the communication device 110 with available spectrum information is prepared, the available spectrum information described above may be derived on the basis of only the position information of the communication device 110. As described above, there are various methods for the method of determining the available spectrum, and it is not limited to the example of the present disclosure.

Furthermore, in a case where the communication control device 130 acquires information regarding capability of a band extension technology such as carrier aggregation (CA) or channel bonding as the frequency band information supported by the communication device 110, the communication control device 130 may include an available combination, a recommended combination, or the like thereof in the available spectrum information.

Furthermore, in a case where the communication control device 130 acquires information regarding a combination of frequency bands supported by the dual connectivity and the multi connectivity as the frequency band information supported by the communication device 110, the communication control device 130 may include information such as an available spectrum and a recommended spectrum in the available spectrum information for the dual connectivity and the multi connectivity.

Furthermore, in a case of providing the available spectrum information for the band extension technology as described above, when the imbalance of the maximum allowable transmission power occurs between the plurality of frequency channels, the available spectrum information may be provided after adjusting the maximum allowable transmission power of each frequency channel. For example, from a perspective of primary system protection, the maximum allowable transmission power of each frequency channel may be aligned with the maximum allowable transmission power of a frequency channel having a low maximum allowable power flux density (power spectral density (PSD)).

The evaluation of the available spectrum does not necessarily need to be performed after the query request is received. For example, after normal completion of the above-described registration procedure, the communication control device 130 may independently perform the procedure without a query request. In such a case, an REM, a lookup table, or an information table similar to those described above as an example may be created.

Furthermore, the radio wave usage priority such as PAL or GAA may also be evaluated. For example, in a case where the registered device parameter or the query requirement includes information regarding the priority of radio wave use, it may be determined whether spectrum use is possible on the basis of the priority, and the notification may be made. Furthermore, for example, as disclosed in Non-Patent Document 2, in a case where information (in Non-Patent Document 2, it is referred to as a cluster list) regarding the communication device 110 that performs high priority use (for example, PAL) from the user is registered in the communication control device 130 in advance, evaluation may be performed on the basis of the information.

After the evaluation of the available spectrum is completed, the communication control device 130 notifies the communication device 110 of the evaluation result.

The communication device 110 may select a desired communication parameter by using the evaluation result received from the communication control device 130. In a case where a spectrum grant procedure (to be described later) is not employed, the communication device 110 may start radio wave transmission using the selected desired communication parameter as a communication parameter.

### <2.3 Spectrum Grant Procedure>

The spectrum grant procedure is a procedure for the wireless system that intends to use the frequency band to receive the secondary use permission of the spectrum from the communication control device 130. The communication device 110 that performs the spectrum grant procedure as a representative of the wireless system may be the same as or different from the communication device 110 that has performed the procedure so far. Typically, the communication device 110 notifies the communication control device 130 of a spectrum use permission request including information that can specify the communication device 110, thereby starting the procedure. Note that, as described above, the available spectrum information query procedure is not essential. Therefore, the spectrum grant procedure may be performed next to the available spectrum information query procedure, or may be performed next to a registration procedure.

In the present embodiment, it is assumed that at least the following two types of spectrum use permission request methods can be used.
Designation method
Flexible method

The designation method is a request method in which the communication device 110 designates a desired communication parameter and requests the communication control device 130 to permit operation based on the desired communication parameter. The desired communication parameter includes, but is not particularly limited to, a frequency channel to be used, a maximum transmission power, and the like. For example, a wireless interface technology specific parameter (such as a modulation scheme or a duplex mode) may be designated. Furthermore, information indicating radio wave usage priority such as PAL and GAA may be included.

The flexible method is a request method in which the communication device 110 designates only a requirement regarding a communication parameter and requests the communication control device 130 to designate a communication parameter that can be permitted for secondary use while satisfying the requirement. Examples of the requirement related to the communication parameter include, but are not particularly limited to, a bandwidth, a desired maximum transmission power, or a desired minimum transmission power, and the like. For example, a wireless interface technology specific parameter (such as a modulation scheme or a duplex mode) may be designated. Specifically, for example, one or more TDD frame structures may be selected in advance and provided in notification.

Similarly to the query request, the spectrum use permission request may also include the measurement report in either the designation method or the flexible method. The measurement report includes a result of measurement performed by the communication device 110 and/or the terminal 120. The measurement may be represented by raw data or processed data. For example, standardized metrics represented by reference signal received power (RSRP), reference signal strength indicator (RSSI), and reference signal received quality (RSRQ) can be used for measurement.

Note that the scheme information used by the communication device 110 may be registered in the communication control device 130 at the time of the registration procedure described in <2.1>.

### <2.3.1 Details of Spectrum Use Permission Processing>

After receiving the spectrum use permission request, the communication control device 130 performs spectrum use permission processing on the basis of the spectrum use permission request method. For example, using the method described in <2.2>, it is possible to perform the spectrum use permission processing in consideration of the primary system, the secondary use prohibited area, the presence of the communication device 110 in the vicinity, and the like.

In a case where the flexible method is used, the maximum allowable transmission power information may be derived using the method described in <2.2.2>. Typically, the maximum allowable transmission power information is calculated by using allowable interference power information in the primary system or a protection zone thereof, position information of a reference point for calculating an interference power level suffered by the primary system, registration information of the communication device 110, and a propagation loss estimation model. Specifically, as an example, it is calculated by the above Expression (2).

Furthermore, as described above, Expression (2) is described on the basis of the assumption that the single communication device 110 is an interference source. For example, in a case where it is necessary to consider aggregated interference from a plurality of communication devices 110 at the same time, a correction value may be added. Specifically, for example, the correction value can be determined on the basis of three types of methods (fixed/predetermined, flexible, flexible minimized) disclosed in Non-Patent Document 3 (ECC Report 186).

The communication control device 130 can use various propagation loss estimation models in a spectrum grant procedure, available spectrum evaluation processing for an available spectrum information query request, and the like. In a case where a model is designated for each application, it is desirable to use the designated model. For example, in Non-Patent Document 2 (WINNF-TS-0112), a propagation loss model such as Extended Hata (eHATA) or Irregular Terrain Model (ITM) is employed for each application. Of course, the propagation loss model is not limited thereto.

There are also propagation loss estimation models that require information regarding radio wave propagation paths. The information regarding the radio wave propagation path can include, for example, information indicating inside and outside of a line of sight (Line of Sight (LOS) and/or Non Line of Sight (NLOS)), topographical information (undulations, sea levels, and the like), environmental information (Urban, Suburban, Rural, Open Sky, and the like), and the like. When using the propagation loss estimation model, the communication control device 130 may estimate these pieces of information from the registration information of the communication device 110 or the information of the primary system that is already acquired. Alternatively, in a case where there is a parameter designated in advance, it is desirable to use the parameter.

In a case where the propagation loss estimation model is not designated in a predetermined application, the propagation loss estimation model may be selectively used as necessary. For example, when estimating the interference power to the other communication device 110, a model that is calculated with a small loss such as a free space loss model is used, but when estimating the coverage of the communication device 110, a model that is calculated with a large loss can be used.

Furthermore, in a case where the designated propagation loss estimation model is used, as an example, the spectrum use permission processing can be performed by evaluating an interference risk. Specifically, for example, in a case where it is assumed that desired transmission power indicated by transmission power information is used, when an estimated interference quantity is less than the allowable interference power in the primary system or a protection zone thereof, it is determined that use of the frequency channel can be permitted, and a notification of the determination is provided to the communication device 110.

In any method of the designation method and the flexible method, similarly to the query request, the radio wave usage priority such as PAL or GAA may also be evaluated. For example, in a case where the registered device parameter or the query requirement includes information regarding the radio wave usage priority, it may be determined whether the spectrum use is possible on the basis of the priority, and the notification may be made. Furthermore, for example, in a case where information regarding the communication device 110 that performs high priority use (for example, PAL) from the user is registered in the communication control device 130 in advance, evaluation may be performed on the basis of the information. For example, in Non-Patent Document 2 (WINNF-TS-0112), information regarding the communication device 110 is referred to as a cluster list.

In addition, in any of the above calculations, when the position information of the communication device is used, the frequency availability may be determined by performing correction of the position information and the coverage by using the positioning accuracy information (location uncertainty).

The spectrum use permission processing is not necessarily performed due to reception of the spectrum use permission request. For example, after the normal completion of the above-described registration procedure, the communication control device 130 may independently perform without the spectrum use permission request. Furthermore, for example, the spectrum use permission processing may be performed at regular intervals. In such a case, the above-described REM, lookup table, or an information table similar thereto may be created. Thus, the spectrum that can be permitted is determined only by the position information, and thus the communication control device 130 can quickly return a response after receiving the spectrum use permission request.

### <2.4 Spectrum Use Notification (Spectrum Use Notification/Heartbeat)>

The spectrum use notification is a procedure in which the wireless system using the frequency band notifies the communication control device 130 of the use of the spectrum based on the communication parameter allowed to be used in the spectrum grant procedure. The communication device 110 that performs the spectrum use notification as a representative of the wireless system may be the same as or different from the communication device 110 that has performed the procedure so far. Typically, the communication device 110 notifies the communication control device 130 of a notification message including information that can specify the communication device 110.

The spectrum use notification is desirably performed periodically until the use of the spectrum is rejected from the communication control device 130. In that case, the spectrum use notification is also referred to as a heartbeat.

After receiving the spectrum use notification, the communication control device 130 may determine whether to start or continue the spectrum use (in other words, radio wave transmission at the permitted spectrum). Examples of the determination method include confirmation of the spectrum use information of the primary system. Specifically, it is possible to determine permission or rejection of start or continuation of spectrum use (radio wave transmission at the permitted spectrum) on the basis of a change in the use spectrum of the primary system, a change in the spectrum use status of the primary system in which the radio wave usage is not steady (for example, a ship radar of CBRS in the United States), and the like. If the start or continuation is permitted, the communication device 110 may start or continue the spectrum use (radio wave transmission at the permitted spectrum).

After receiving the spectrum use notification, the communication control device 130 may command reconfiguration of the communication parameters to the communication device 110. Typically, in a response of the communication control device 130 to the spectrum use notification, reconfiguration of the communication parameters can be commanded. For example, information regarding recommended communication parameters (hereinafter, recommended communication parameter information) can be provided. The communication device 110 to which the recommended communication parameter information has been provided desirably performs the spectrum grant procedure described in <2.4> again using the recommended communication parameter information.

### <2.5 Supplement of Various Procedures>

The procedures described above do not necessarily need to be implemented individually, as described below. For example, by substituting a third procedure including two different procedures, the two different procedures may be implemented. Specifically, for example, the registration request and the available spectrum information query request may be integrally provided in notification. Furthermore, for example, the spectrum grant procedure and the spectrum use notification may be integrally performed. As a matter of course, it is not limited to these combinations, and three or more procedures may be performed integrally. Furthermore, as described above, one procedure may be separately performed a plurality of times.

Furthermore, the expression “to acquire” or an expression equivalent thereto in the present disclosure does not necessarily mean to acquire according to the procedure described in the present disclosure. For example, although it is described that the position information of the communication device 110 is used in the available spectrum evaluation processing, it means that the information acquired in the registration procedure does not necessarily need to be used, and in a case where the position information is included in an available spectrum query procedure request, the position information may be used. In other words, the procedure for acquisition described in the present disclosure is an example, and acquisition by other procedures is also permitted within the scope of the present disclosure and within the scope of technical feasibility.

Furthermore, the information described to be included in a response from the communication control device 130 to the communication device 110 may be actively provided in notification from the communication control device 130 by a push method if possible. As a specific example, the available spectrum information, the recommended communication parameter information, a radio wave transmission continuation rejection notification, and the like may be provided in notification by the push method.

### <2.6 Various Procedures for Terminal>

So far, the description has been made mainly assuming the processing in the communication device 110A. However, in some embodiments, not only the communication device 110A but also the terminal 120 and the communication device 110B can operate under management of the communication control device 130. That is, a scenario in which the communication parameter is determined by the communication control device 130 is assumed. Even in such a case, basically, each procedure described in <2.1> to <2.4> can be used. However, unlike the communication device 110A, the terminal 120 and the communication device 110B need to use the spectrum managed by the communication control device 130 for the backhaul link, and cannot perform radio wave transmission without permission. Therefore, it is desirable to start backhaul communication for the purpose of accessing the communication control device 130 only after detecting a radio wave or an authorization signal transmitted by the communication device 110A (communication device 110 capable of providing wireless communication service or master communication device 110 of master-secondary type).

On the other hand, under the management of the communication control device 130, there may be cases where, also in the terminal or the communication device 110B, an allowable communication parameter is set for the purpose of protecting the primary system. However, the communication control device 130 cannot know the position information and the like of these devices in advance. Furthermore, these devices are also likely to have mobility. That is, the position information is dynamically updated. Depending on the laws, in a case where the position information changes by a certain amount or more, re-registration to the communication control device 130 may be required in some cases.

In consideration of such various use forms, operation forms, and the like of the terminal 120 and the communication device 110, in the operation form of the TVWS (Non-Patent Document 4) defined by the Office of Communications (Ofcom), the following two types of communication parameters are defined.
Generic operational parameters
Specific operational parameters

The generic operational parameters are communication parameters defined as “parameters that can be used by any slave WSD located within the coverage area of a predetermined master WSD (corresponding to the communication device 110)” in Non-Patent Document 4. A feature is that it is calculated by the WSDB without using the position information of the slave WSD.

The generic operational parameters can be provided by unicast or broadcast from the communication device 110 that is already permitted to perform radio wave transmission from the communication control device 130. For example, a broadcast signal represented by a contact verification signal (CVS) defined in Part 15 Subpart H of the FCC rule in the United States can be used. Alternatively, it may be provided by a broadcast signal specific to a wireless interface. Thus, the terminal 120 and the communication device 110B can be handled as the communication parameters used for radio wave transmission for the purpose of accessing the communication control device 130.

The specific operational parameters are communication parameters defined as “parameters usable by a specific slave white space device (WSD)” in Non-Patent Document 4. In other words, they are communication parameters calculated using the device parameter of the slave WSD corresponding to the terminal 120. A feature is that it is calculated by the white space database (WSDB) using the position information of the slave WSD.

The CPE-CBSD Handshake Procedure defined in Non-Patent Document 5 can be regarded as another form of the procedure related to the terminal. The CPE-CBSD does not have a wired backhaul line and accesses the Internet via the BTS-CBSD. Therefore, permission for radio wave transmission in the CBRS band cannot be acquired from a SAS without a special regulation or procedure. The CPE-CBSD Handshake Procedure allows the CPE-CBSD to perform radio wave transmission at the same maximum EIRP and the minimum necessary Duty Cycle as those of a terminal (EUD) until permission for radio wave transmission is acquired from the SAS. Accordingly, the communication device 110B can construct a line for acquiring permission for radio wave transmission from the communication control device 130 by setting the transmission EIRP to the maximum EIRP of the terminal and then performing wireless communication with the communication device 110A at the minimum necessary duty cycle. After the permission for the radio wave transmission is acquired, it is possible to use up to the maximum EIRP defined by the communication device within the range of the permission.

### <2.7 Procedure Occurring Between Communication Control Devices>

### <2.7.1 Information Exchange>

The communication control device 130 can exchange management information with another communication control device 130. At least the following information is desirably exchanged.
Information related to communication device 110
Area information
Protection target system information

The information related to the communication device 110 includes at least the registration information and the communication parameter information of the communication device 110 operating under permission of the communication control device 130. The registration information of the communication device 110 having no permitted communication parameter may be included.

The registration information of the communication device 110 is typically a device parameter of the communication control device 130 registered in the communication device 110 in the above-described registration procedure. Not all of the registered information is necessarily exchanged. For example, information that may correspond to personal information does not need to be exchanged. Furthermore, when the registration information of the communication device 110 is exchanged, the registration information may be encrypted and exchanged, or the information may be exchanged after the content of the registration information is made ambiguous. For example, information converted into a binary value or information signed using an electronic signature mechanism may be exchanged.

The communication parameter information of the communication device 110 is typically information related to the communication parameters currently used by the communication device 110. At least information indicating the use spectrum and the transmission power is desirably included. Other communication parameters may be included.

The area information is typically information indicating a predetermined geographical region. This information can include region information of various attributes in various modes.

For example, as in a PAL protection area (PPA) disclosed in Non-Patent Document 2 (WINNF-TS-0112), protection zone information of the communication device 110 serving as a high priority secondary system may be included in the area information. The area information in this case can be expressed by, for example, a set of three or more coordinates indicating the geographical position. Furthermore, for example, in a case where a plurality of communication control devices 130 can refer to a common external database, the area information is expressed by a unique ID, and the actual geographical region can be referred to from the external database using the ID.

Furthermore, for example, information indicating the coverage of the communication device 110 may be included. The area information in this case can also be expressed by, for example, a set of three or more coordinates indicating the geographical position. Further, for example, assuming that the coverage is a circle centered on the geographical position of the communication device 110, the coverage can also be expressed by information indicating the size of the radius. Furthermore, for example, in a case where a plurality of communication control devices 130 can refer to the common external database that records area information, the information indicating the coverage is expressed by a unique ID, and the actual coverage can be referred to from the external database using the ID.

Furthermore, as another aspect, information related to an area section determined in advance by the government or the like can also be included. Specifically, for example, it is possible to indicate a certain region by indicating an address. Furthermore, for example, a license area or the like can be similarly expressed.

Furthermore, as still another aspect, the area information does not necessarily express a planar area, and may express a three-dimensional space. For example, it may be expressed using a spatial coordinate system. Furthermore, for example, information indicating a predetermined closed space such as a floor number, a floor, and a room number of a building may be used.

The protection target system information is, for example, information of a wireless system treated as a protection target, such as the aforementioned existing layer (incumbent tier). Examples of the situation in which this information needs to be exchanged include a situation in which cross-border coordination is required. It is well conceivable that different protection targets exist in the same band between neighboring countries or regions. In such a case, the protection target system information can be exchanged between different communication control devices 130 in different countries or regions to which the communication control devices belong as necessary.

As another aspect, the protection target system information may include information of a secondary licensee and information of the wireless system operated by the secondary licensee. The secondary licensee is specifically a lessee of the license, and for example, it is assumed that the secondary licensee borrows PAL from the holder and operates the wireless system owned by itself. In a case where the communication control device 130 performs the rent management independently, information of the secondary licensee and information of the wireless system operated by the secondary licensee can be exchanged with another communication control device for the purpose of protection.

These pieces of information can be exchanged between the communication control devices 130 regardless of the decision-making topology applied to the communication control device 130.

Furthermore, these pieces of information can be exchanged in various manners. An example thereof will be described below.
ID designation method
Period designation method
Region designation method
Dump method

The ID designation method is a method of acquiring information corresponding to an ID given in advance to specify information managed by the communication control device 130. For example, it is assumed that the first communication control device 130 manages the communication device 110 with ID: AAA. At this time, the second communication control device 130 designates the ID: AAA to the first communication control device 130 and makes an information acquisition request. After receiving the request, the first communication control device 130 searches for information of ID: AAA, and provides notification of information regarding the communication device 110 of ID: AAA, for example, registration information communication parameter information, and the like in response.

The period designation method is a method in which information satisfying a predetermined condition can be exchanged in a designated specific period.

Examples of the predetermined condition include the presence or absence of information update. For example, in a case where acquisition of information regarding the communication device 110 in the specific period is designated by a request, the registration information of the communication device 110 newly registered within the specific period can be provided in notification in response. Furthermore, the registration information or the information of communication parameters of the communication device 110 whose communication parameter has been changed within the specific period can also be provided in notification in response.

Examples of the predetermined condition include whether the predetermined condition is recorded by the communication control device 130. For example, in a case where acquisition of information regarding the communication device 110 in the specific period is designated in the request, the registration information or the information of the communication parameters recorded by the communication control device 130 in the period can be provided in notification in response. In a case where the information is updated in the period, the latest information in the period can be provided in notification. Alternatively, an update history may be provided in notification for each piece of information.

In the region designation method, a specific region is designated, and information of the communication device 110 belonging to the region is exchanged. For example, in a case where acquisition of information regarding the communication device 110 in the specific region is designated by a request, the registration information or the information of the communication parameters of the communication device 110 installed in the region can be provided in notification by a response.

The dump method is a method of providing all information recorded by the communication control device 130. At least information and area information related to the communication device 110 are desirably provided by the dump method.

The above description of the information exchange between the communication control devices 130 is based on a pull method. That is, it is a form in which information corresponding to the parameter designated in the request is responded, and can be implemented by the HTTP GET method as an example. However, it is not limited to the pull method, and information may be actively provided to another communication control device 130 by the push method. As an example, the push method can be implemented by the HTTP POST method.

### <2.7.2 Command or Request Procedure>

The communication control device 130 may execute a command or a request with each other. Specifically, as an example, there is reconfiguration of communication parameters of the communication device 110. For example, in a case where it is determined that the first communication device 110 managed by the first communication control device 130 is greatly interfered with by the second communication device 110 managed by the second communication control device 130, the first communication control device 130 may request the second communication control device 130 to change the communication parameter of the second communication device 110.

As another example, there is reconfiguration of the area information. For example, in a case where calculation of coverage information and protection zone information regarding the second communication control device 130 managed by the second communication device 110 is incomplete, the first communication control device 130 may request the second communication control device 130 to reconfigure the area information. Besides this, the area information reconfiguration request may be made for various reasons.

### <2.8 Information Transmission Means>

A notification (signaling) between entities described above can be implemented via various media. E-UTRA or 5G NR will be described as an example. As a matter of course, it is not limited thereto when implementing.

### <2.8.2 Signaling Between Communication Control Device 130 and Communication Device 110>

The notification from the communication device 110 to the communication control device 130 may be performed, for example, in an application layer. For example, the Hyper Text Transfer Protocol (HTTP) may be used. Signaling can be performed by describing required parameters in the message body of the HTTP according to a predetermined manner. Moreover, in the case of using the HTTP, notification from the communication control device 130 to the communication device 110 is also performed according to the HTTP response mechanism.

### <2.8.3 Signaling Between Communication Device 110 and Terminal 120>

The notification from the communication device 110 to the terminal 120 may be performed using, for example, at least one of radio resource control (RRC) signaling, system information (SI), or downlink control information (DCI). Furthermore, examples of the downlink physical channel include a physical downlink control channel (PDCCH), a physical downlink shared channel (PDSCH), a physical broadcast channel (PBCH), an NR-PDCCH, an NR-PDSCH, an NR-PBCH, and the like, but the downlink physical channel may be implemented using at least one of these.

The notification from the terminal 120 to the communication device 110 may be performed using, for example, radio resource control (RRC) signaling or uplink control information (UCI). Furthermore, it may be implemented by using an uplink physical channel (physical uplink control channel (PUCCH), physical uplink shared channel (PUSCH), physical random access channel (PRACH)).

The signaling is not limited to the physical layer signaling described above, and the signaling may be performed at a higher layer. For example, at the time of implementation at the application layer, signaling may be implemented by describing a required parameter in a message body of the HTTP according to a predetermined manner.

### <2.8.4 Signaling Between Terminals 120>

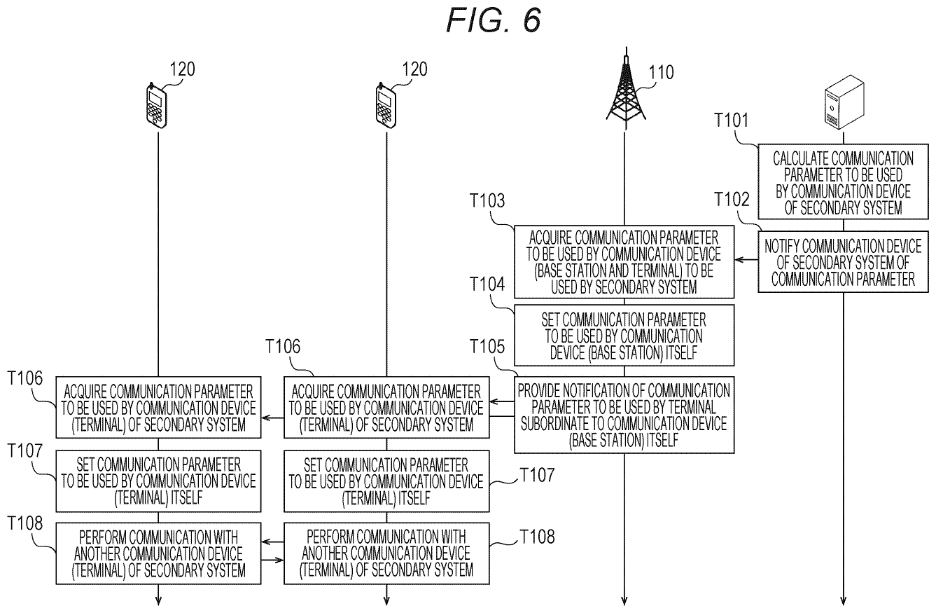

FIG. 6 illustrates an example of a flow of signaling in a case where device-to-device (D2D) or vehicle-to-everything (V2X), which is communication between the terminals 120, is assumed as communication of the secondary system. The D2D or V2X which is communication between the terminals 120 may be performed using a physical sidelink channel (physical sidelink control channel (PSCCH), physical sidelink shared channel (PSSCH), physical sidelink broadcast channel (PSBCH)). The communication control device 130 calculates a communication parameter to be used by the secondary system (T101) and notifies the communication device 110 of the secondary system of the calculated communication parameter (T102). A value of the communication parameter may be determined and provided in notification, or a condition indicating a range or the like of the communication parameter may be determined and provided in notification. The communication device 110 acquires a communication parameter to be used by the secondary system (T103), and sets the communication parameter to be used by the communication device 110 itself (T104). Then, a notification of a communication parameter to be used by the terminal 120 subordinate to the communication device 110 is provided to the terminal 120 (T105). Each terminal 120 subordinate to the communication device 110 acquires (T106) and sets (T107) the communication parameter to be used by the terminal 120. Then, communication with another terminal 120 of the secondary system is performed (T108).

The communication parameter in a case where the target frequency channel for spectrum sharing is used in the sidelink (direct communication between the terminals 120) may be provided in notification, acquired, or set in a form associated with a resource pool for sidelink in the target frequency channel. The resource pool is a radio resource for a sidelink set by a specific frequency resource or time resource. Examples of the frequency resource include a resource block, a component carrier, and the like. The time resource includes, for example, a radio frame, a subframe, a slot, a mini-slot, and the like. In a case where the resource pool is set in a frequency channel to be subjected to spectrum sharing, the resource pool is set in the terminal 120 by the communication device 110 on the basis of at least one of the RRC signaling, the system information, or the downlink control information. Then, the communication parameters to be applied in the resource pool and the sidelink are also set in the terminal 120 by the communication device 110 on the basis of at least one of the RRC signaling, the system information, or the downlink control information from the communication device 110 to the terminal 120. The notification of setting of the resource pool and the notification of the communication parameter to be used in the sidelink may be performed simultaneously or individually.

### 3. Embodiments of Present Invention

### First Embodiment

Many CBSDs in CBRS are based on the 3GPP specification and are operated by time division duplex (TDD) on the basis of the specifications of Band 48 to Band n48. In the CBRS Release 1 specification, the SAS performs a protection process of a protected entity on the assumption that all CBSDs emit radio waves (beam transmission) simultaneously. Further, it is assumed that beams transmitted by all CBSDs are fixed (parameters of all CBSDs are invariant). However, when it is assumed that many CBSDs are operated in TDD, the assumption that all the CBSDs emit radio waves simultaneously leads to overprotection of the protected entity, that is, a decrease in spectrum availability. Furthermore, when the CBSD includes the AAS and performs dynamic beamforming, it is contrary to the assumption that the parameters of all the CBSDs are invariant, and the SAS cannot appropriately perform the protection process of the protected entity. A method for enhancing spectrum use efficiency while appropriately protecting a protection target from radio wave interference by a communication device even in a case where dynamic beamforming is performed in a case where operation is performed in TDD is proposed.

More specifically, in the first embodiment, a case is assumed where a plurality of citizens broadband radio service devices (CBSDs) existing in a neighboring area of a protection target such as a protection target system or a protected entity performs signal transmission and signal reception with terminal devices in respective cells in a time division manner using the same frequency band or the same frequency channel. Transmission is downlink transmission, and reception is uplink reception. In this manner, each CBSD communicates with the terminal device by time division duplex (TDD). Unit periods (slots) of time division in each CBSD are synchronized, and each CBSD performs downlink transmission or uplink reception with a terminal device in a cell for each slot. Each CBSD can dynamically change a beam pattern using dynamic beamforming, and can transmit a signal (beam transmission) using the beam pattern. A spectrum access system (SAS) detects a CBSD capable of transmission for each slot of TDD, and determines an allowable beam pattern for the detected CBSD. That is, an allowable beam pattern is determined for one or a plurality of CBSDs capable of transmission along the time axis direction. The allowable beam pattern is determined such that the cumulative interference amount obtained by accumulating the radio wave interference amount given to the protection target by the CBSD satisfies the criterion (for example, such that the cumulative interference amount is equal to or less than the threshold). The interference amount is, for example, interference power, a metric based on the interference power, or the like. The interference power depends on the transmission power of the beam, the distance to the protected entity, the gain of the antenna on the transmission side, the gain of the antenna on the reception side, and the like. As a result, in a case where each CBSD performs dynamic beamforming with the terminal device, it is possible to improve the spectrum use efficiency while protecting the protection target from radio wave interference.

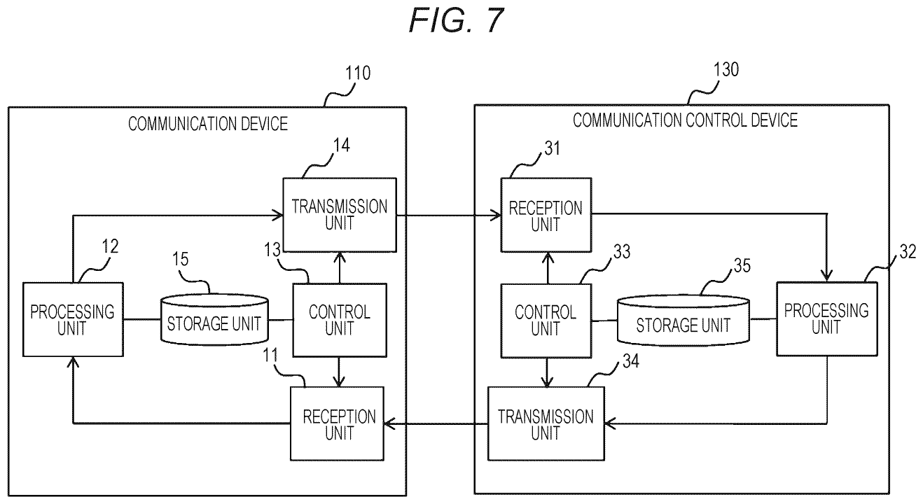

FIG. 7 is a block diagram of a communication system according to the first embodiment. The communication system in FIG. 7 includes a communication device 110 and a communication control device 130. In the present embodiment, the communication device 110 is a CBSD, and the communication control device 130 is an SAS. Although only one communication device 110 is illustrated in the drawing, the other communication devices 110 have a similar configuration.

The communication control device 130 includes a reception unit 31, a processing unit 32, a control unit 33, a transmission unit 34, and a storage unit 35. Each of the transmission unit 34 and the reception unit 31 includes at least one antenna. The transmission unit 34 performs processing of transmitting a signal in a wireless or wired manner with the communication device 110 and the other communication control device 130. The reception unit 31 performs processing of receiving a signal from the communication device 110 and the other communication control device 130 in a wireless or wired manner. The control unit 33 controls the entire communication control device 130 by controlling each element in the communication control device 130.

The storage unit 35 of the communication control device 130 stores in advance various types of information necessary for communication with the communication device 110 and the other communication control device 130. As an example, the storage unit 35 stores information of the registered communication device 110. For example, the information includes an ID of the communication device 110, position information, maximum transmission power information (EIRP capability value, maximum antenna power (maximum conducted power), and the like), dynamic beam pattern information (beam movable range information), information of antenna transmission power (conducted power), and the like. In addition, an ID of a grant (grant ID) for at least one of the beam pattern or the spectrum permitted to be used by the communication device 110 or the like may be stored in association with information for identifying the permitted beam pattern or spectrum.

The processing unit 32 performs various processes according to the present embodiment. For example, the processing unit 32 performs processing related to a registration procedure, a spectrum use query procedure, and a spectrum grant procedure with the CBSD. In addition, the processing unit 32 performs processing called Coordinated Periodic Activities among SASs (CPAS) with one or more other communication control devices 130. The CPAS is a process performed once every 24 hours among a plurality of SASs, and calculation processing (calculation processing for protecting a higher layer from interference of a lower layer) related to higher-tier protection of a protected entity or the like is performed. That is, the CPAS performs calculation and the like for protecting the protected entity from interference of a lower layer having a lower priority of radio wave use than the protected entity. The communication device 110 belongs to a hierarchy in which the priority of the use of the radio wave is lower than that of the protected entity.

The processing unit 32 detects all the communication devices 110 (first communication devices) capable of performing transmission in a target period among the plurality of communication devices 110 that performs signal transmission and signal reception in a time division manner. The target period is, for example, a slot of TDD. In this case, for example, the processing unit 32 detects the first communication devices capable of transmitting a signal for each slot of TDD on the basis of TDD Configuration of the plurality of communication devices 110. TDD Configuration is setting information that determines whether to transmit and receive signals for each communication device 110 for each slot of TDD. TDD Configuration (setting information) may be stored in the storage unit 35. Note that the transmission is downlink transmission to a terminal device existing in a cell of the communication device 110, and the reception is uplink reception from the terminal device existing in the cell of the communication device 110.

When there is one detected communication device 110 (first communication device), the processing unit 32 determines a beam pattern allowed for the first communication device in the target period on the basis of the radio wave interference amount given to the protection target system in a case where the beam pattern is used by the first communication device on the basis of the information regarding the formable beam pattern (beam movable range information) by the first communication device. The transmission unit 34 transmits information indicating a beam pattern allowed for the first communication device to the first communication device. The transmission unit 34 may transmit the information indicating the beam pattern to the first communication device in association with information for identifying a target period (for example, information for identifying a slot, a slot ID, or the like). There may be a plurality of beam patterns to be determined. In this case, as the information indicating the determined beam pattern, information for identifying each beam pattern may be transmitted, or a beam movable range including a plurality of beam patterns may be calculated, and the calculated movable range information may be transmitted.

When there is a plurality of detected communication devices 110 (first communication devices), the processing unit 32 determines a beam pattern allowed for the plurality of first communication devices in the target period on the basis of the cumulative interference interference amount obtained by accumulating the radio wave interference amount given to the protection target system in a case where the beam pattern is used by the plurality of first communication devices on the basis of the information regarding the formable beam pattern by the plurality of first communication devices. The transmission unit 34 transmits information indicating a beam pattern allowed for each of the plurality of first communication devices to the plurality of first communication devices. The transmission unit 34 may transmit the information indicating the beam pattern to the first communication device in association with information (for example, information for identifying a slot, a slot ID, or the like) for identifying a target period in which the beam pattern is allowed.

The processing unit 32 may determine a beam pattern common to a plurality of target periods (for example, a plurality of slots). For example, for the communication device 110, the processing unit 32 determines a beam pattern for each of a plurality of target periods (for example, the first target period and the second target period), and specifies a beam pattern portion in which the determined beam patterns are common. The processing unit 32 determines the specified beam pattern portion as an allowable beam pattern in common in the plurality of target periods.

The target period is, for example, a unit period of time division. The unit period is, for example, a slot of TDD. The target period is not limited to a slot, and may be a symbol period. Here, a slot includes a plurality of symbols, and a length of each symbol corresponds to a symbol period. Furthermore, the target period may be an arbitrary time section specified by the start timing and the end timing or by the start timing and the time length. For example, the arbitrary time section may be an arbitrary time section in a subframe in which a plurality of slots is arranged in the time axis direction. The arbitrary time section may be a continuous time starting from the middle of one slot to the middle of another slot.

The process of determining an allowable beam pattern to the CBSD (first communication device) in the time axis direction in this manner may be referred to as a process according to the present embodiment or a protection process of a protection target system.

The timing at which the processing unit 32 performs the protection process for the protected entity includes a timing at which a registration request for requesting registration of a device parameter is received from the communication device 110 or a timing at which a query request regarding an available spectrum is received from the communication device 110. Furthermore, it also includes a timing at which a use permission request for requesting use permission of the spectrum is received from the communication device 110 or the like. In addition, it includes a timing at which the processing unit 32 performs CPAS.

The communication device 110 includes a reception unit 11, a processing unit 12, a control unit 13, a transmission unit 14, and a storage unit 15. The transmission unit 14 and the reception unit 11 each include at least one antenna. The transmission unit 14 performs processing of transmitting a signal to the communication control device 130 and the other communication device 110 in a wireless or wired manner. The reception unit 11 performs processing of receiving a signal from the communication control device 130 or the other communication device 110 in a wireless or wired manner. The control unit 13 controls the entire communication device 110 by controlling each element in the communication device 110. For example, the control unit 13 controls beamforming in the transmission unit 14 on the basis of a beam pattern to be used.

The storage unit 15 of the communication device 110 stores in advance various types of information necessary for communication with the communication control device 130 or the other communication device 110. Furthermore, the storage unit 15 stores information regarding various types of performance, specifications, and the like of the communication device 110. For example, the storage unit 15 stores information such as an ID, position information, maximum transmission power information (EIRP capability value, maximum antenna power (maximum conducted power), and the like), dynamic beam pattern information (beam movable range information), antenna transmission power (conducted power) of the communication device 110, and the like.

The processing unit 12 performs various processes according to the present embodiment. For example, the processing unit 12 performs processing related to various procedures described above, for example, a registration procedure, a spectrum use query procedure, or a spectrum grant procedure, with the communication control device 130.

The processing unit 12 performs processing related to communication that performs signal transmission and signal reception in a time division manner. The transmission is downlink transmission to a terminal device 120 existing in a cell of the communication device 110, and the reception is uplink reception from the terminal device 120 existing in a cell of the communication device 110. The processing unit 12 performs communication on the basis of, for example, setting information (for example, TDD Configuration) that determines whether to transmit and receive signals for each unit period (for example, slot) in a time division manner. The setting information may be stored in the storage unit 15. The processing unit 12 receives, from the communication control unit 130 via the reception unit 11, information regarding the beam pattern allowed to be used in the target period among the transmittable time. The processing unit 12 performs transmission to the terminal device 120 in the target period by using the beam pattern based on the received information. As an example, the target period may be a unit period of time division. The unit period is, for example, a slot of TDD. The target period is not limited to a slot, and may be a period of symbols included in a slot. The slot includes a plurality of symbols, and a length of each symbol corresponds to a period of symbols. Furthermore, the target period may be an arbitrary time section specified by the start timing and the end timing or by the start timing and the time length.

Each processing block of the communication control device 130 and the communication device 110 is configured by a hardware circuit, software (program or the like), or both of them. The storage unit 35 and the storage unit 15 are configured by any storage device such as a memory device, a magnetic storage device, or an optical disk. The storage unit 35 and the storage unit 15 may not be in the communication control device 130 and the communication device 110, but be externally connected to the communication control device 130 and the communication device 110 wirelessly or by wire. The transmission unit 34 and the reception unit 31 in the communication control device 130 and the transmission unit 14 and the reception unit 11 in the communication device 110 may include one or a plurality of network interfaces according to the number or types of connectable networks.

Hereinafter, the communication system according to the present embodiment will be described in detail assuming that the communication device 110 is a CBSD and the communication control device 130 is an SAS.

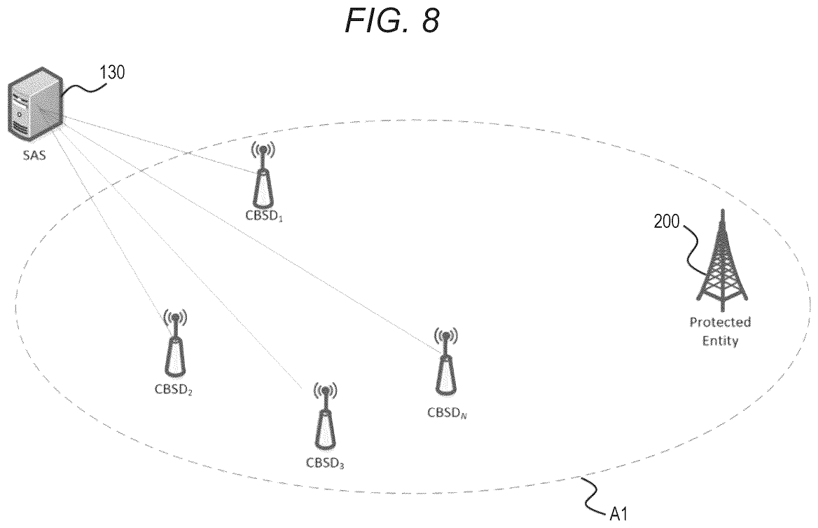

FIG. 8 illustrates an example of a neighborhood area A1 set around the protected entity. The neighborhood area A1 is defined in order to be able to specify a grant of the CBSD using the same frequency band as that of the protected entity as a target of the protection process by the SAS. That is, among the CBSDs in the neighborhood area A1, the grant of the CBSD using the same frequency band as that of the protected entity is a target of the protection process by the SAS. The grant is issued by the SAS in order to allow the CBSD existing in the vicinity of the protected entity to transmit radio waves. The grant includes, as an example, an ID of the grant, a value indicating a frequency band allowed to be used, and an allowed transmission power value. The grant may further include information of a beam pattern allowed to be used (information of a beam movable range allowed to be used) and the like.

In the example of FIG. 8, there are N CBSDs (CBSD₁, CBSD₂, CBSD₃, . . . CBSD_{N}) in the neighborhood area A1. Although each CBSD may have a plurality grants, it is assumed here for simplicity of illustration that all of the N CBSDs each have only one grant of the same spectrum (total number of grants=N). Of course, during implementation of the present invention, each CBSD may have a plurality of grants. In this case, the method of the present embodiment may be applied in units of grants, may be commonly applied to all grants, or may be commonly applied to any combination of grants.

By acquiring the grant from the SAS in advance, the CBSD can perform radio wave transmission (signal transmission) with the transmission power value indicated by the grant in the frequency band (frequency channel) indicated by the grant. The grant may designate one or more usable beam patterns (or movable ranges of usable beams), and in this case, a signal is transmitted to the terminal device 120 by using any beam pattern selected from the designated one or more beam patterns.

Each CBSD communicates with one or a plurality of terminal devices 120 (see FIG. 1) in coverage (cell) by TDD. Each CBSD may perform dynamic beamforming that dynamically changes the beam pattern. That is, each CBSD can form a plurality of beam patterns. Each CBSD communicates with the terminal device 120 using a beam pattern permitted by the SAS for each slot in which transmission is permitted among the slots of TDD. Note that the target with which each CBSD communicates is not limited to the terminal device, and other CBSDs or the communication control device 130 may be included.

In the present embodiment, in a case where each CBSD performs TDD communication with a terminal device in a cell by using dynamic beamforming, spectrum use efficiency is enhanced while accumulation (sum) of radio wave interference to a protected entity by the CBSD is suppressed to an allowable value (threshold value) or less.

The SAS 130 (communication control device) of the present embodiment calculates an allowable beam pattern in the time axis direction for each CBSD on the basis of the beam pattern capability information (beam movable range or the like) of each CBSD and the TDD Configuration. More specifically, for each slot, the allowable beam pattern is calculated for each CBSD group capable of transmission on the basis of the cumulative interference amount given to the protected entity. The CBSD becomes an interference source, and a cumulative pattern of interference also changes according to a combination of the interference sources. In each cumulative pattern, the cumulative interference amount of interference changes according to the beam pattern actually used by each CBSD. The SAS 130 calculates a beam pattern that improves the spectrum use efficiency while suppressing the cumulative interference amount with the protected entity.

Slots are synchronized between CBSDs. That is, the communication of each CBSD is multiplexed on the time axis. Each CBSD can perform either downlink transmission (transmission of a signal to the terminal device 120) or uplink reception (reception of a signal from the terminal 120) in each slot. Whether each CBSD is capable of downlink transmission or uplink reception in each slot is defined in the TDD Configuration of each CBSD. A slot in which any one of downlink transmission and uplink reception can be performed may be defined in TDD Configuration. As long as all CBSDs do not use the same TDD Configuration, the combination of CBSDs that emit radio waves (perform downlink transmission) changes for each slot.

Hereinafter, an example in which the SAS determines a beam pattern used by CBSDs for each slot will be described using a scenario in which two CBSDs are present as an example.

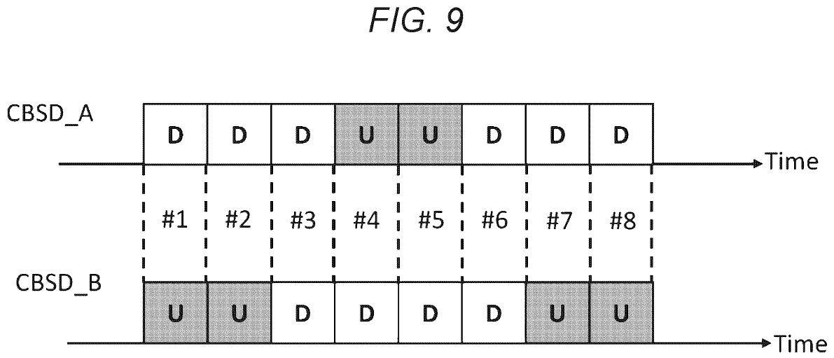

FIG. 9 illustrates an example of TDD Configuration for two CBSDs (CBSD_A and CBSD_B). In CBSD_A, downlink transmission is permitted in the slots #1, #2, #3, #6, #7, and #8, and uplink reception is permitted (downlink transmission is prohibited) in the slots #4 and #5. In CBSD_B, downlink transmission is permitted in the slots #3, #4, #5, and #6, and uplink reception is permitted (downlink transmission is prohibited) in the slots #1, #2, #7, and #8.

From the TDD Configuration of CBSD_A and CBSD_B, three types of interference cumulative patterns occur. [1] Interference cumulative pattern in a case where only CBSD A emits (slots #1, #2, #7, and #8) radio waves [2] Interference cumulative pattern in a case where only CBSD B emits (slots #4 and #5) radio waves

[3] Interference cumulative pattern in a case where CBSDs A and B simultaneously emit (slots #3 and #6) radio waves

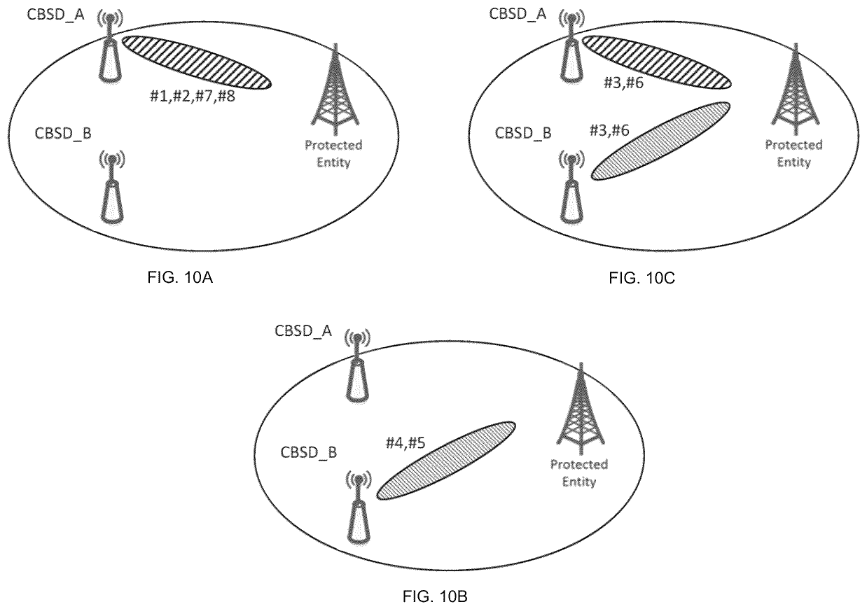

FIG. 10 is an explanatory diagram of interference cumulative patterns [1] to [3]. FIG. 10(A) illustrates an example in which the interference cumulative pattern [1] occurs. Only CBSD_A emits radio waves, and interference by a single station of CBSD_A is given to the protected entity. FIG. 10(B) illustrates an example in which the interference cumulative pattern [2] occurs. Only CBSD_B emits radio waves, and interference by a single station of CBSD_B is given to the protected entity. FIG. 10(C) illustrates an example in which the interference cumulative pattern [3] occurs. Both CBSD_A and CBSD_B emit radio waves, and cumulative interference by CBSD_A and CBSD_B is given to the protected entity.

The SAS specifies any one of the cumulative patterns [1] to [3] for each slot, and determines the allowable beam pattern of the CBSD on the basis of the specified cumulative pattern.

[1] In the interference cumulative pattern (slots #1, #2, #7, and #8), since CBSD_B does not emit (transmit) a radio wave, the allowable beam pattern (referred to as BP₁) of CBSD_A is determined on the assumption that interference is given to the protected entity by a single station of CBSD_A.

The determination method of the allowable beam pattern may be any method as long as the interference amount given to the protected entity can be suppressed to be equal to or less than the allowable value. For example, for each of a plurality of beam patterns that can be formed by CBSD_A, an interference amount at a protection point (for example, a two-dimensional or three-dimensional position) predetermined for the protected entity is calculated from a peak direction, a gain, and the like of the beam pattern. Among these beam patterns, a beam pattern in which the interference amount at the protection point satisfies the criterion (for example, the interference amount is less than or equal to an allowable value or is minimized) is selected. In a case where there is a plurality of protection points, a beam pattern in which the interference amount at all of the plurality of protection points satisfies the criterion may be selected. In a case where a plurality of beam patterns can be selected, all or some of the plurality of beam patterns may be selected. Alternatively, one or a plurality of beam patterns having the highest communication quality with the terminal device 120 or having a communication quality equal to or higher than a threshold value may be selected. Any index such as SINR or an average error rate can be used as the communication quality. The protection point or the plurality of protection points corresponds to an example of a protection target of the present embodiment. In a case where a plurality of beam patterns is selected, an arbitrary beam pattern among the plurality of beam patterns may be used in the CBSD.

[2] In the interference cumulative pattern (slots #4 and #5), since CBSD_A does not emit (transmit) a radio wave, an allowable beam pattern (referred to as BP₂) is determined for CBSD_B on the assumption that interference is given to the protected entity by a single station of CBSD_B. The determination method of the beam may be similar to the case of [1].

[3] In the interference cumulative pattern (slots #3 and #6), an allowable beam pattern (BP_{3A} and BP_{3B}) is determined for CBSD_A and CBSD_B, respectively, on the assumption that cumulative interference by CBSD_A and CBSD_B is given to the protected entity.

For example, the interference amount at the protection point is calculated for each of the plurality of beam patterns that can be formed by each of CBSD_A and CBSD_B. A set of beam patterns of CBSD_A and CBSD_B in which the cumulative interference amount obtained by accumulating (adding) the interference amount at the protection point satisfies the criterion (the cumulative interference amount is less than or equal to the allowable value or is minimized) is selected. In a case where there is a plurality of protection points, a set of beam patterns in which the cumulative interference amount at all of the plurality of protection points satisfies the criterion may be selected. In a case where a plurality of sets of beam patterns can be selected, a set of beam patterns in which the average or the like of the communication quality in which CBSD_A and CBSD_B communicate with the terminal device 120 in the cell is the highest or is equal to or greater than a threshold value may be selected. Any index such as SINR or an average error rate can be used as the communication quality. In addition, a plurality of sets of beam patterns may be selected. For example, for a certain beam pattern of CBSD_B, in a case where both of the two beam patterns of CBSD_A satisfy the criterion, two sets may be selected. That is, two sets in which each of the two beam patterns of CBSD_A is combined with a certain beam pattern of CBSD_B can be selected.

The determination method of the allowable beam pattern described above is an example, and other methods may be used.

In the example of FIG. 9, the SAS generates allowable beam pattern information BP_{Acceptable, A} and BP_{Acceptable, B} described below for CBSD_A and CBSD_B. The SAS transmits BP_{Acceptable, A} and BP_{Acceptable, B} to CBSD_A and CBSD_B, respectively.
CBSD_A:BP_{Acceptable, A}={BP₁, BP₁, BP_{3A}, n/a, n/a, BP_{3A}, BP₁, BP₁}
CBSD_B:BP_{Acceptable, B}={n/a, n/a, BP_{3B}, BP₂, BP₂, BP_{3B}, n/a, n/a}

BP_{Acceptable, A} and BP_{Acceptable, B} include information designating a beam pattern usable in each slot for CBSD_A and CBSD_B. The order of the elements in parentheses corresponds to the slot number. “n/a” means that an allowable beam pattern is not set in the slot.

CBSD_A and CBSD_B control the beam pattern to be formed for each slot according to the allowable beam pattern information received from the SAS. In a case where a plurality of allowable beam patterns is designated, a beam pattern to be used may be selected from the plurality of designated beam patterns.

The format in which the SAS notifies the allowable beam pattern does not need to be the above format. As a method other than the method in which the SAS notifies BP_{Acceptable, A} and BP_{Acceptable, B}, the SAS may determine a beam pattern that can be used in common in all or a plurality of transmittable slots for each of CBSD_A and CBSD_B, and may set information indicating the determined beam pattern as allowable beam pattern information.

For example, for CBSD_A, the common portion BP_{common, A} of the beam pattern BP₁ and the beam pattern BP_{3A} is set as an allowable beam pattern in common in all transmittable slots. Similarly, for example, for CBSD_B, the common portion BP_{common, B} of the beam pattern BP₁ and the beam pattern BP_{3B} is set as an allowable beam pattern in common in all transmittable slots.

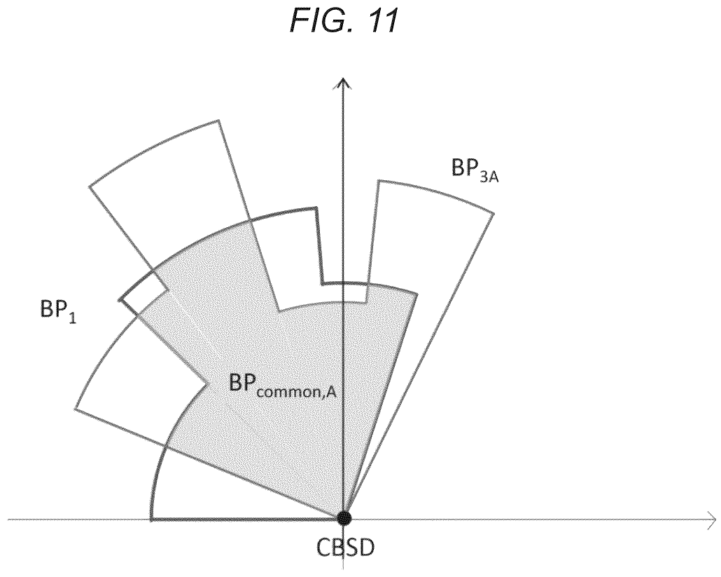

FIG. 11 illustrates an example of calculating a common portion BP_{common, A} of the beam pattern BP₁ and the beam pattern BP_{3A} with respect to CBSD_A. The beam pattern BP₁ and the beam pattern BP_{3A} are illustrated in a coordinate system including an orientation of 0 to 359 degrees in plan view. A portion where the beam pattern BP₁ and the beam pattern BP_{3A} overlap each other corresponds to the allowable beam pattern BP_{common, A} in common in all the transmittable slots.

The SAS may acquire, from CBSD_A in advance, wish information indicating a notification of which form of beam pattern information of BP_{Acceptable, A} and BP_{common, A} is provided to CBSD_A. That is, the SAS may receive the wish information from CBSD_A in the reception unit. The SAS may determine beam pattern information in any format on the basis of the wish information, and transmit the beam pattern information in the determined format to CBSD_A. Alternatively, the SAS may transmit beam pattern information of both BP_{Acceptable, A} and BP_{common, A}. The wish information indicating that a notification of the beam pattern information is provided in the form of BP_{Acceptable, A} corresponds to the first wish information in which it is desired to acquire the information of the beam pattern to be individually applied for each of the plurality of target periods (the first target period and the second target period). The wish information indicating that a notification of the beam pattern information is provided in the form of BP_{common, A} corresponds to the second wish information in which it is desired to acquire the information of the beam pattern commonly applied to the plurality of target periods (the first target period and the second target period). In a case where the first wish information is received, the SAS transmission unit transmits information indicating the first beam pattern determined for the first target period and the second beam pattern determined for the second target period to CBSD_A. In a case where the second wish information is received, information indicating a common portion of the first and second beam patterns is transmitted to CBSD_A as an allowable beam pattern in both the first target period and the second target period.

Alternatively, a notification of which form of beam pattern information to be provided may be set in advance as one of the control policies of SAS. Alternatively, the setting of the control policy may be changed periodically. Alternatively, the setting of the control policy may be changed irregularly by an arbitrary trigger.

The arbitrary trigger may be reception of a setting change instruction in a case where the SAS administrator manually transmits the setting change instruction from the administrator terminal to the SAS. Alternatively, the arbitrary trigger may be a timing at which a predetermined event is satisfied. For example, in a case where the CBSD can transmit the above wish information at an arbitrary timing, the fact that the SAS has received the wish information may be set as the predetermined event.

In the example of FIG. 9, there are two CBSDs, but the method of the present embodiment can be similarly applied to a case where there are three or more CBSDs. In other words, the SAS may determine an allowable beam pattern to the plurality of CBSDs on the basis of the cumulative interference amount or the like given to the protection target by the plurality of CBSDs.

### [Example of Controlling Beam Pattern in Time Unit Other Than Slot]

In the above-described example, the SAS controls the beam pattern of each CBSD in units of slots (slot level), but may control the beam pattern in units of symbols.

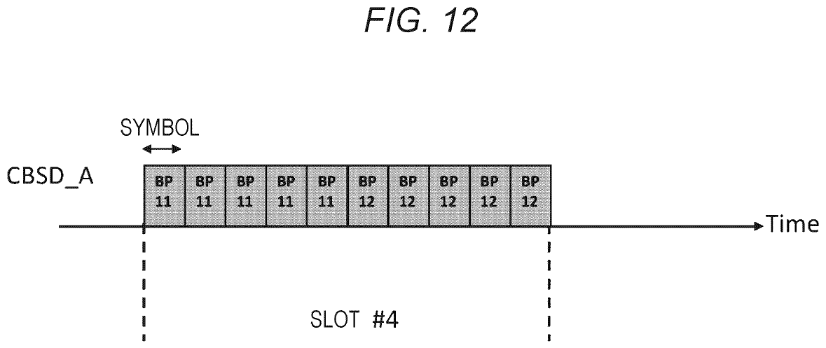

FIG. 12 illustrates an example in which the beam pattern is controlled in units of symbols. A slot #4 in CBSD_A is illustrated. The slot #4 includes a plurality of symbols. In a case where it is sufficient to consider interference by a single station of CBSD_A in the slot #4 (in the case of the interference cumulative pattern of [1] described above), it is assumed that two beam patterns BP₁₁ and BP₁₂ can be selected for CBSD_A. In the example of the drawing, the beam pattern BP₁₁ is used in the first half slot group, and the beam pattern BP₁₂ is used in the second half slot group. As another example, the beam pattern may be switched every certain symbol period. By switching the beam pattern within the slot in this manner, the communication quality can be averaged or stabilized in units of slots. Although the example of CBSD_A has been described in FIG. 12, the beam pattern of CBSD_B can be similarly controlled in units of symbols.

Although the case of the slot in which the interference by the single station is only required to be considered has been described in the example of FIG. 12, the beam pattern is only required to be controlled in units of slots even in the slot in which the cumulative interference from both CBSD_A and CBSD_B needs to be considered (in the case of the interference cumulative pattern of [3] described above).

In addition, the SAS may determine a beam pattern that can be used within an arbitrary time section (time range) for CBSD.

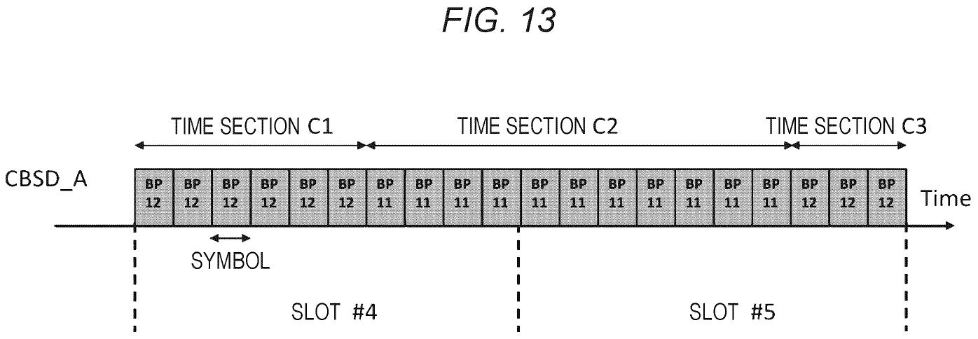

FIG. 13 illustrates an example of controlling the beam pattern in an arbitrary time section. Slots #4 and #5 in CBSD_A are illustrated. The time section C1 corresponds to the first to sixth time sections in the slot #4. The first symbol corresponds to the start timing of the time section C1, and the sixth symbol corresponds to the end timing of the time section C1. The six symbol lengths corresponding to the six symbols correspond to the time length of the time section C1. The time section C2 corresponds to a time section from the seventh symbol in the slot #4 to the seventh symbol in the slot #5. The time section C3 corresponds to the eighth to tenth time sections in the slot #5. The beam pattern BP₁₂ is used for the time section C1, the beam pattern BP₁₁ is used for the time section C2, and the beam pattern BP₁₂ is used for the time section C3. The SAS may set the time section by acquiring information of the time section desired by the CBSD from the CBSD. Alternatively, the SAS may autonomously determine a time section to be applied to the CBSD. The SAS may transmit the information of the beam pattern determined for the time section to the CBSD as the allowable beam pattern information. The information transmitted to the CBSD may include information specifying the time section.

The setting example of the time section illustrated in FIG. 13 is an example, and the time section may be set by another method. For example, the time section may be set at a constant cycle (for example, every three symbols). In addition, the time section may be determined on the basis of the performance value of the antenna.

Although the example in which the beam pattern is set in a slot unit, a symbol unit, or an arbitrary time section unit has been described, the beam pattern may be set in a subframe unit that is a structure in which a plurality of slots is arranged or the like. As described above, in the present embodiment, it is possible to set a beam pattern to be used for an arbitrary period.

### [Specific Example of Timing to Perform Processing of Determining Beam Pattern of Each CBSD in Time Axis Direction (Protection Process of Protected Entity)]

As the timing at which the SAS performs the beam pattern determination processing (protection process of the protection point entity) of each CBSD, the following timings (a) to (d) are included in the CBRS. As a matter of course, the timing of performing the present processing may be another timing. In addition, in addition to the CBRS, the beam pattern determination processing (protection process of the protection point entity) may be performed at an equivalent timing to (a) to (d).
(a) After completion of registration of CBSD
(b) After reception of spectrum inquiry request
(c) After reception of spectrum use permission request (also referred to as grant request)
(d) Coordinated Periodic Activities among SASs (CPAS)
(a) As described in <2.1 Registration Procedure>, the registration of the CBSD means that the SAS performs a registration procedure with the CBSD to register information (device parameters) of the CBSD that intends to use the frequency band or the channel. Typically, the registration procedure is started when the communication device 110 transmits a registration request including a device parameter to the SAS.
(b) As described in <2.2 Available Spectrum Information Query Procedure (Available Spectrum Query Procedure)>, the spectrum inquiry request is a request that the CBSD trying to use the frequency band inquires of the SAS about the information regarding the available spectrum. The query request may also include query requirement information. The query requirement information may include, for example, information indicating a frequency band for which it is desired to know whether or not it is available.
(c) As described in <2.3 Spectrum Grant Procedure>, the spectrum use permission request is a request that is transmitted by the CBSD in order to receive the use permission of the spectrum from the SAS in the spectrum grant procedure. The spectrum use permission request includes two types of request methods: a designation method and a flexible method. In the designation method, the CBSD designates a desired communication parameter (for example, frequency channel, maximum transmission power, and the like), and the SAS determines availability of the desired communication parameter. In the flexible method, CBSD designates only a requirement (for example, bandwidth, desired maximum transmission power, desired minimum transmission power, TDD configuration (TDD frame structure), and the like) related to a communication parameter, and the SAS designates a communication parameter that can be used while satisfying the requirement.
(d) As described above, the CPAS is executed once every 24 hours among a plurality of SASs, and performs calculation processing or the like related to higher-tier protection of a protected entity or the like.

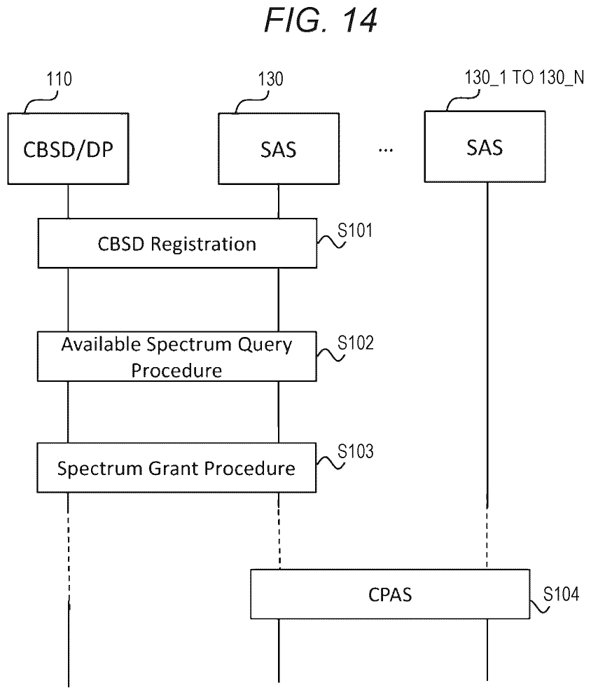

FIG. 14 is a sequence diagram illustrating an example of performing a registration procedure, an available spectrum information query procedure, a spectrum grant procedure, and CPAS. Instead of the CBSD, a domain proxy (DP) may perform the processing. The SAS 130 starts the registration procedure by receiving the registration request from the CBSD 110, and transmits the registration response to the CBSD 110 after completion of the registration processing (S101). The SAS 130 starts an available spectrum information query procedure by receiving the spectrum inquiry request from the CBSD 110, and transmits an inquiry response to the CBSD 110 after completion of the processing (S102). The SAS 130 starts the spectrum grant procedure by receiving the spectrum use permission request from the CBSD 110, and transmits a spectrum use permission response to the CBSD 110 after completion of the processing (S103). The SAS 130 performs CPAS with one or more other SASs 130_1 to 130_N once every 24 hours (S104).

The determination processing of the beam pattern at the timings (a) to (c) (that is, the timings of steps S101 to S103) can be performed in a case where either the spectrum use permission request of the designation method or the flexible method is adopted.

At this time, in addition to the CBSD for which the beam pattern is to be determined this time, there may be another CBSD in which transmission is already performed in the same slot as the CBSD and the allowable beam pattern has been determined before. In this case, for the other CBSDs, the allowable beam pattern may be determined again, or for the other CBSDs, the allowable beam pattern may be determined only for the CBSD targeted at this time while maintaining the allowable beam pattern determined before.

Among the designation method and the flexible method, in a case where the flexible method is adopted, it is particularly effective for both SAS and CBSD. The reason for this is as follows.

In the fixed method, since the CBSD designates the desired frequency channel, the beam pattern cannot be determined in advance before the SAS receives the spectrum use permission request. That is, since the SAS does not know in advance which frequency channel the CBSD designates, the SAS cannot specify which neighborhood area of the protected entity the CBSD belongs to. On the other hand, in the flexible method, since the SAS can designate the frequency channel permitted to the CBSD, the beam pattern to be used for the CBSD can be determined on the assumption of the frequency channel permitted to the CBSD in advance.

Typically, the SAS may determine an allowable beam pattern for the CBSD at the timing of (b) or (c) (the timing of step S102 or S103), and transmit information (allowable beam pattern information) designating the determined beam pattern to the CBSD. The allowable beam pattern information can also be included in a spectrum inquiry response that is a response to the spectrum inquiry request or a spectrum use permission response that is a response to the spectrum use permission request. The allowable beam pattern information can be included in the registration request that is a response to the above-described registration request. (c) At the timing of (the timing of step S103), a part or all of the allowable beam patterns may be selected, and the selected beam pattern may be associated with the grant (spectrum use permission) to be issued.

(d) The timing of (the timing of step S104) is particularly effective in a case where the spectrum use permission request of the fixed method is adopted. The SAS may acquire the TDD Configuration information and the beam pattern information in the time axis direction as the wish information in addition to the desired frequency channel and the maximum equivalent isotropic radiated power (EIRP) in the spectrum use permission request from the CBSD. The SAS may determine an allowable beam pattern in the time axis direction on the basis of the acquired information, and issue a grant associated with the determined allowable beam pattern in the time axis direction. In addition, the TDD Configuration information may be associated with a grant to be issued.

The SAS may also determine beam patterns not desired by the CBSD if the interference of a single station or the cumulative interference by a plurality of stations does not satisfy the criteria (details are described below). The beam pattern information in the time axis direction acquired from the CBSD by the SAS is not necessarily in the format of BP_{Acceptable, A} described above. For example, the beam pattern capability information (movable range or the like) of the CBSD can be handled as the beam pattern information in the time axis direction. In the movable range, the SAS is only required to determine a beam pattern that can be permitted for the CBSD. The movable range includes a plurality of beam patterns on which the CBSD can be formed.

The SAS does not need to obtain the TDD Configuration information and the beam pattern information in the time axis direction that are desired by the CBSD through the spectrum use permission request. The SAS may acquire the information via a registration request, a query request, or the like received from the CBSD in advance.

The SAS desirably puts the grant issued to the CBSD into a stop (SUSPENDED) state until the CPAS is executed. After the CPAS determines that a frequency band, a beam pattern, and the like associated with the grant are available, the grant may be put into a valid state. However, this does not apply to a case where it can be determined that the cumulative interference amount satisfies the criterion (does not exceed the threshold) even if the radio wave is emitted under the grant issued by the CBSD, that is, a case where there is an interference margin.

In the CPAS, a cumulative interference amount (including a case of interference by a single station) in the protected entity is calculated for each slot by using the frequency channel, the maximum EIRP, the TDD Configuration, and the allowable beam pattern in the time axis direction of the issuing grant. The calculation method of the cumulative interference amount is similar to the calculation method of the cumulative interference amount in the interference cumulative pattern described above.

In a case where the cumulative interference amount satisfies the criterion in all the slots (for example, in a case where the cumulative interference amount is equal to or less than the threshold), there is no problem in the frequency channel, the maximum EIRP, the TDD Configuration, and the allowable beam pattern information in the time axis direction of the issuing grant. In this case, the SAS can permit the emission of the radio wave related to the grant (make the grant valid) and notify the CBSD of the permission of the frequency channel or the like as the heartbeat response in the heartbeat procedure after the CPAS ends. The notification of the permission may include TDD Configuration and allowable beam pattern information in the time axis direction to be used by the CBSD.

On the other hand, in a case where the cumulative interference amount does not satisfy the criterion in any of the slots (for example, in a case where the cumulative interference exceeds the threshold value), in the heartbeat procedure after the CPAS ends, the SAS cannot permit the CBSD to emit radio waves under the condition associated with the issued grant. However, the SAS may make a modification related to any one or more of the frequency channel of the grant, the maximum EIRP, and the allowable beam pattern information in the time axis direction, and provide the modified information to the CBSD. The CBSD may determine a desired frequency channel or the like again on the basis of the provided information.

For example, the SAS is only required to determine (correct) a frequency channel and a maximum EIRP on the basis of a result of IAP or the like by performing a process called an Iterative Allocation Process (IAP) as in the related art for the frequency channel and the maximum EIRP. Then, the SAS may provide the determined information to the CBSD. Note that the IAP is a method of distributing the interference margin (interference allowable power) of the protected entity to each CBSD by repeating the reduction of the transmission power of the CBSD by a certain amount until the cumulative interference amount with the protected entity becomes equal to or less than the threshold (allowable value).

On the other hand, for the beam pattern information in the time axis direction, information corresponding to the above-described allowable beam pattern information (BP_{Acceptable, A}, BP_{common, A}) in the time axis direction may be generated and provided to the CBSD. As an example of the correction, for example, it is conceivable to perform processing of setting the allowable beam pattern in the specific slot to “n/a” or limiting the allowable beam pattern in the specific slot (limiting the movable range of the allowable beam). In addition, it is also conceivable to correct the TDD Configuration so that the cumulative interference amount satisfies the criterion.

In a case where it is necessary to correct only the allowable beam pattern information in the time axis direction among the beam pattern information in the frequency channel, the maximum EIRP, and the time axis direction, the SAS may permit the emission of the radio wave related to the grant while providing information obtained by correcting the allowable beam pattern information in the time axis direction to the CBSD. In other words, if only the correction of the allowable beam pattern information in the time axis direction associated with the grant is performed, the SAS may permit the emission of the radio wave related to the grant.

As described above, according to the present embodiment, it is possible to more effectively implement application of dynamic beamforming by the CBSD while eliminating a decrease in spectrum use efficiency (spectrum availability).

### (Modification 1)

In the first embodiment, it is assumed that all the plurality of CBSDs in the neighborhood area can perform dynamic beamforming, but at least one of the plurality of CBSDs may not be compatible with dynamic beamforming. A CBSD (non-compatible CBSD) not compatible with dynamic beamforming is only required to be assumed to use a beam pattern determined in advance in each slot (downlink slot) in the time axis direction, for example. Under this assumption, the allowable beam pattern in the time axis direction is only required to be calculated by performing processing similar to that of the first embodiment on the CBSD capable of executing dynamic beamforming.

### (Modification 2)

The transmission power of each CBSD may be variable, and the SAS may calculate the allowable beam pattern in the time axis direction and control the transmission power of the allowable beam pattern. By controlling the transmission power, the interference amount in the protection target can be controlled (reduced), and more allowable beam patterns can be selected. The SAS may transmit the information indicating the transmission power to the CBSD together with the information indicating the allowable beam pattern. The transmission power of the CBSD to be controlled is, for example, antenna transmission power (conducted power). The antenna transmission power is, for example, power of a radio frequency signal supplied from a radio frequency (RF) circuit to the antenna.

### (Modification 3)

In the first embodiment described above, it is assumed that a plurality of communication devices performs TDD communication, but the method described in the first embodiment is also applicable to a case other than a case where a plurality of communication devices 110 performs TDD communication. For example, the communication control device may individually schedule transmittable periods of a plurality of communication devices, and the method described in the first embodiment may be applied to one or more communication devices having the same transmittable period.

### 3.2 Second Embodiment

In the first embodiment described above, the allowable beam pattern in the time axis direction is calculated using the beam pattern capability information (information of a plurality of beam patterns that can be formed by the CBSD, beam movable range information, or the like) and the TDD Configuration of each CBSD in consideration of the cumulative pattern of interference. As a result, the application of the dynamic beamforming by the CBSD is more effectively implemented while solving the problem of the decrease in the spectrum use efficiency (Spectrum availability).

In the first embodiment, an allowable beam pattern is calculated focusing only on protection of a protected entity. However, when more effective operation of the CBSD is pursued, coexistence between CBSDs is very important by securing both protection of the protected entity and coexistence between CBSDs (coexistence), particularly by adjusting TDD Configuration. Coexistence between CBSDs means that a plurality of CBSDs can use the same spectrum with high spectrum use efficiency.

For example, the CBRSA-TS-2001 discloses that a Coexistence Manager (CxM), which is a control device that performs radio wave interference control between CBSDs, calculates a TDD Configuration Connected Set (TCCS), and adjusts the TDD Configuration on the basis of the TCCS. The TCCS is a graph in which CBSDs are represented by nodes and nodes of the CBSDs having a relationship of radio wave interference with each other are connected by edges. That is, the TCCS represents a set of CBSDs that give interference to each other.

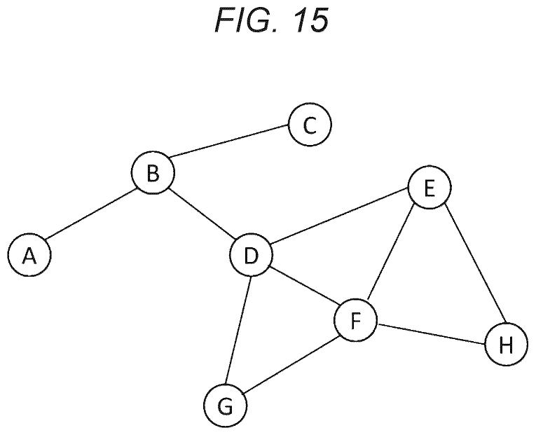

FIG. 15 illustrates an example of the TCCS (group). Each node indicates a CBSD. The alphabet in each node is a symbol identifying the CBSD. The edge connecting the nodes means that the CBSDs corresponding to the nodes at both ends are in a relationship in which radio waves can be detected. That is, the CBSDs in the TCCS are in a relationship in which radio waves can be detected with at least one other CBSD (a relationship in which radio wave interference is present).

By performing adjustment based on the TCCS, a desired TDD Configuration or a Fallback TDD Configuration is determined for each CBSD. In this case, there may be a CBSD that can use the desired TDD Configuration and a CBSD that uses Fallback TDD Configuration. It can also be said that the desired TDD Configuration corresponds to the first priority TDD Configuration, and the fallback TDD Configuration corresponds to the second priority TDD Configuration.

When such processing (coexistence process) is performed after the processing (protection process of the protected entity) of the first embodiment, CBSD in which the TDD Configuration to be used is changed may occur. In this case, the result of the protection process of the protected entity becomes invalid, and the process needs to be performed again, so that the processing efficiency decreases. The second embodiment solves this problem.

The SAS according to the second embodiment has a function of performing a coexistence process (a function corresponding to CxM).

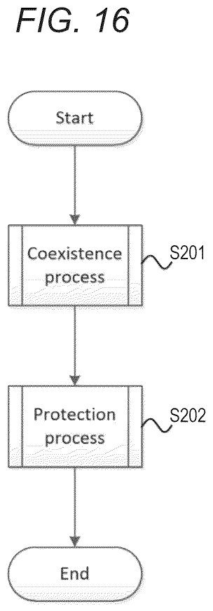

FIG. 16 is a flowchart of an example of processing of the SAS according to the second embodiment. The present processing is performed by the processing unit 32 of SAS. The SAS first performs a coexistence process using information about each CBSD, that is, desired TDD Configuration information, fallback TDD Configuration information, and beam pattern capability information (movable range or the like) (S501).

The SAS performs allocation of a frequency channel to the CBSD, construction of a TCCS, and the like in a coexistence process. The SAS divides a plurality of CBSDs into one or more groups on the basis of the presence or absence of mutual radio wave interference, and each divided group corresponds to the TCCS. A communication device belonging to a divided group (TCCS) has a radio wave interference relationship with at least one other communication device belonging to the group.

After constructing the TCCS, the SAS determines the TDD Configuration for each CBSD belonging to the same TCCS. TDD Configuration is setting information that determines whether downlink transmission and uplink reception can be performed for each slot of TDD (unit period of time division). Any method may be used as a method of determining the TDD Configuration. For example, the TDD Configuration desired by each CBSD may be compared, the TDD Configuration most desired may be commonly determined for the CBSDs for which the TDD Configuration is desired, and the fallback TDD Configuration may be determined for the other CBSDs. Alternatively, a desired TDD Configuration may be determined for each of the CBSDs in a relationship in which radio wave interference does not occur even if radio waves are simultaneously emitted (omni transmission) omnidirectionally between the CBSDs in the TCCS, and a fallback TDD Configuration may be determined for the other CBSDs. The determination may be made by other methods. Furthermore, the SAS provisionally determines an allowable beam pattern in the time axis direction for each CBSD on the basis of each TDD Configuration. The provisional determination of the allowable beam pattern in the time axis direction corresponds to determining a candidate of the allowable beam pattern in the time axis direction.

The SAS handles the allowable beam pattern (that is, the candidate of the allowable beam pattern) provisionally determined for each CBSD as the beam pattern capability information of each CBSD in the first embodiment described above. As described above, the SAS determines a plurality of beam patterns or movable ranges of beams that can be formed by each CBSD used in the processing of the first embodiment on the basis of the presence or absence of radio wave interference between CBSDs in the TSSC (group). The SAS performs the processing of the above-described first embodiment on the basis of the beam pattern capability information (a plurality of beam patterns or movable ranges of beams that can be formed by each CBSD) and the determined TDD Configuration (S502).

Similarly to the first embodiment, the timing to perform the processing of FIG. 16 may be the timings of (a) to (d) described above or other timings.

By performing the processing illustrated in FIG. 16, it is possible to efficiently determine the operation parameters (the TDD Configuration and the allowable beam pattern in the time axis direction) that can be used by the CBSD while securing both the protection of the protected entity and the coexistence between the CBSDs. For example, when the allowable beam pattern provisionally determined in step S501 has no problem in protection of the protected entity (when the cumulative interference amount satisfies the criterion), the provisionally determined allowable beam pattern can be used as it is as a final parameter. Even if there is a problem (even if the cumulative interference amount does not satisfy the criterion), only some of the parameters are restricted in the processing of step S502 (the allowable beam pattern is limited, that is, the movable range of the beam is narrowed, or the like), and there is no influence on the coexistence between the CBSDs.

Note that, in the coexistence process in step S501 in FIG. 16, when the TDD Configuration Connected Set (TCCS) is constructed, a metric for constructing the TCCS (typically, an interference amount of radio waves between CBSDs) may be calculated for each slot in consideration of dynamic beamforming. For example, the maximum or average interference amount may be calculated in consideration of that the CBSD moves the beam in a range of the beam pattern capability information.

In this case, the SAS does not need to set an edge between the two CBSDs in a case where the metric is equal to or less than the threshold in all the slots. The SAS may set an edge between two CBSDs in a case where the metric exceeds a threshold in at least one or more slots.

Furthermore, for example, in a case where the metric is equal to or less than the threshold in all the slots by applying a limitation to the beam pattern in a specific slot, the beam pattern reflecting the limitation may be provisionally determined as the allowable beam pattern in the time axis direction in step S501.

Furthermore, for example, Interference Coordination Group (ICG), which is a subgroup of CBRS Alliance Coexistence Group (a group of CBSDs managed by CxM), can perform interference control by itself. For the CBSD belonging to the ICG, in a case where an edge is set between the CBSD and the CBSD not belonging to the ICG, the beam pattern in the time axis direction may be limited, and the limited beam pattern may be temporarily set as the allowable beam pattern. For the inside of the ICG, CxM (included in SAS in this example) may not perform the coexistence process (interference control) and the ICG may perform the coexistence process.

In addition, similarly to the first embodiment, a common portion of beam patterns that can be used in a plurality of slots may be determined as an allowable beam pattern that can be used in common in these slots.

### 4 Third Embodiment

In the CBRS, on the basis of various pieces of information regarding the communication device provided in the spectrum grant procedure, various pieces of information regarding the communication device provided from another communication control device, and information of the primary system, the Cooperative Periodic Activities among SASs (CPAS) is executed once a day, thereby calculating the use permission of the spectrum and the recommended communication parameter for the CBSD. According to Non-Patent Document 1 and Non-Patent Document 8, during CPAS, a plurality of pieces of interference margin allocation processing is sequentially performed such as:
Calculation of FSS OOBE Purge List for Fixed-Satellite Service (FSS) TT & C;
Iterative Allocation Process (IAP) for protecting an FSS, an Environmental Sensing Capability (ESC) Sensor, a PAL Protection Area (PPA), and a Grandfathered Wireless Protection Zone (GWPZ); and
Calculation of DPA Move List for Dynamic Protection Area (DPA).

However, each calculation performed during CPAS in CBRS is a calculation method assuming a static antenna pattern. Therefore, only use permission of the antenna pattern for each grant of the communication device and calculation of the maximum allowable transmission power are possible. In a case where dynamic beamforming utilizing AAS is introduced, it is not assumed that an envelope of an allowable beam to a communication device is calculated. Therefore, in a case where dynamic beamforming utilizing AAS is introduced, frequency resources cannot be sufficiently effectively utilized.

In a case where dynamic beamforming utilizing AAS is introduced, in each procedure, an envelope of a beam that can be formed by the communication device may be provided to the communication control device as a communication parameter. In the present embodiment, a communication control device determines an allowable envelope on the basis of interference to a protection target (primary system) from information of an envelope of a beam provided as a communication parameter from a communication device, and provides the information of the allowable envelope to the communication device. The communication device performs dynamic beamforming such that a maximum equivalent isotropic radiated power (EIRP) falls within a range of a provided allowable envelope. By using such a method, in a case where dynamic beamforming utilizing AAS is introduced, it is possible to improve the spectrum use efficiency while protecting the primary system.

### <4.1.1 Available Spectrum Information Query Procedure>

In the available spectrum information query procedure of the CBRS, the availability of the frequency channel based on the secondary use prohibited area or the like, the maximum allowable transmission power information for the frequency based on the distance to the protection target or the like, and the like are determined by performing the available spectrum evaluation processing, and are provided to the communication device as the available spectrum information.

In the available spectrum evaluation processing in the available spectrum information query procedure in the present embodiment, information of an envelope of a beam that can be formed by the communication device 110 in the SAS (communication control device 130) is provided from a CBSD (communication device 110) that secondarily uses a spectrum that is the same as or adjacent to the spectrum used by the protection target. The processing unit 32 of the communication control device 130 determines an envelope (allowable envelope) that can be actually used by the communication device 110 on the basis of the information on the envelope of the beam provided from the communication device 110 and the position of the protection target. The processing unit 32 of the communication control device 130 provides the available spectrum information including the information of the determined envelope to the communication device 110 via the transmission unit 34.

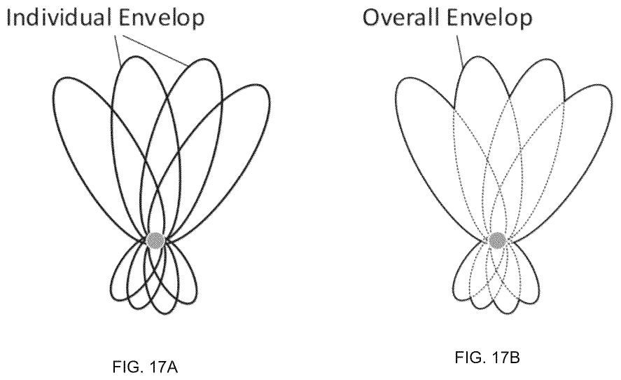

FIG. 17 illustrates an example of an envelope indicated in the information provided from the communication device 110. FIG. 17(a) illustrates an envelope of one beam (individual envelope). FIG. 17(b) illustrates an overall envelope covering the entire envelope of two or more beams.

The information provided from the communication device 110 may indicate either the envelope in FIG. 17(a) or the envelope in FIG. 17 (b).

The envelope may be an envelope of the EIRP when the beam is transmitted, or may be an envelope of a beam gain.

Although only the envelope in the azimuth angle direction is illustrated in FIG. 17, the envelope may be similarly defined in the elevation angle direction.

In the following description, it is assumed that the communication control device 130 acquires the information on the envelope P_{EIRP}^{init}(ϕ,θ)_{(dBm)} of the EIRP as the information on the initial value of the envelope that can be formed by the communication device 110. ϕ is an azimuth angle, and θ is an elevation angle.

### <4.1.1.1 Available Spectrum Evaluation Processing>

In the available spectrum evaluation processing of the CBRS, in a case where the communication device is included in the secondary use prohibited area, it is determined that the frequency channel corresponding to the secondary use prohibited area is not available, and a notification is not provided to the communication device as the available channel. On the other hand, in the present embodiment, even in a case where the communication device is included in the secondary use prohibited area, the envelope in which the radio wave transmission is prohibited or the allowable transmission power is limited with respect to the direction in which the protection target exists is defined, so that the corresponding frequency channel can be used for the communication device. Thus, the spectrum use efficiency can be improved.

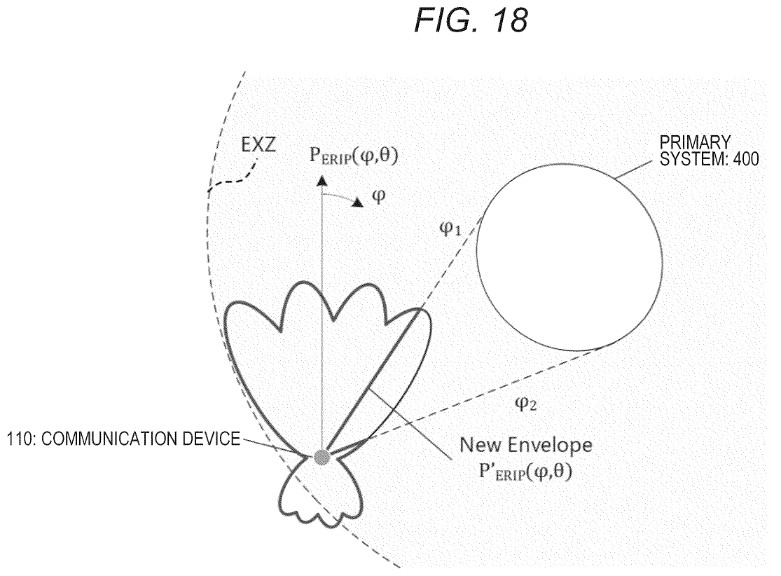

FIG. 18 illustrates an example in which the communication device included in the secondary use prohibited area is prohibited from transmitting radio waves in the direction in which the protection target exists, so that the frequency channel is made available. In the frequency channel corresponding to the secondary use prohibited area EXZ, the processing unit 32 of the communication control device 130 sets the direction (up to the azimuth angle direction ϕ₁≤ϕ≤ϕ₂ in this case) of the primary system 400 viewed from the communication device 110 as a range prohibited when the corresponding frequency channel is used. P′_{EIRP}(ϕ,θ)_{(dBm)} where the allowable transmission power is set to negative infinity in logarithmic display or 0 in true value as in Expression (3) may be set as a new envelope. At this time, the communication device 110 can also use the azimuth angle direction ϕ₁≤ϕ≤ϕ₂ as long as the frequency channel is other than the frequency channel corresponding to EXZ. This envelope corresponds to a shape obtained by changing the envelope provided from the communication device to a shape that prevents radio wave transmission in the direction of the protection target.

$$[ Math . 4 ]$$

$${{P}_{EIRP}^{′} ( {ϕ}_{p} , θ )}_{( dBm )} = \{ \begin{matrix}- ∞ & ( {ϕ}_{1} \leq ϕ \leq {ϕ}_{2} ) \\ {{P}_{EIRP}^{init} ( ϕ , θ )}_{( dBm )} & otherwise\end{matrix} \qquad ( 3 )$$

Alternatively, a notification of a range (ϕ₁ to ϕ₂) of the unavailable azimuth angle direction itself may be provided together with the corresponding frequency channel. Further, a range ϕ₁−ϕₘ≤ϕ≤ϕ₂+ϕₘ obtained by adding a margin Δϕ of a certain value to ϕ₁≤ϕ≤ϕ₂ may be set as the use prohibited range.

Note that, in a case where the protection zone of the primary system 400 is a point, a range ϕ₁−ϕₘ≤ϕ≤ϕ₁+ϕₘ obtained by adding a margin in the azimuth angle direction θ₁ of the primary system may be set as the use prohibited range.

The prohibited range may be set not only in the azimuth angle direction θ but also in the elevation angle direction.

In addition, in a case where the communication device 110 is included in a plurality of secondary use prohibited areas in common, a new envelope may be calculated in each of the secondary use prohibited areas, and a notification of an overlapping portion of all the envelopes may be provided to the communication device 110.

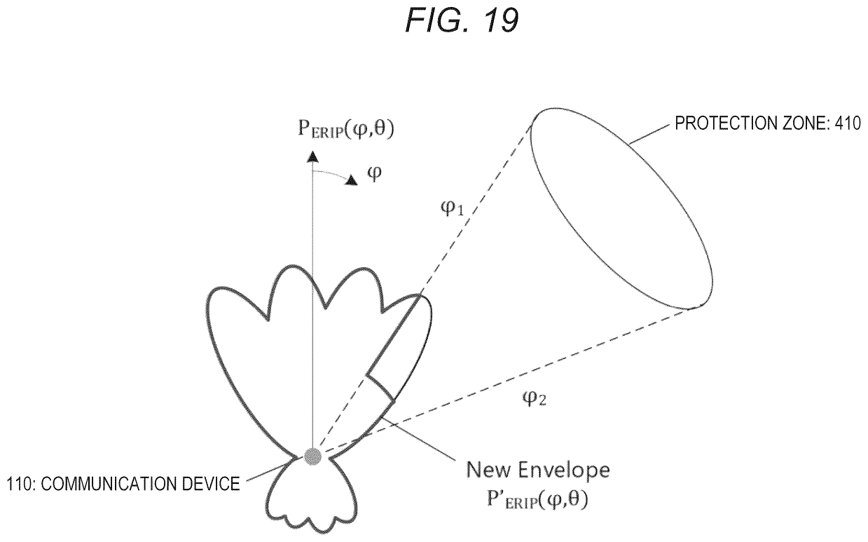

FIG. 19 illustrates an example in which the allowable transmission power of the communication device is determined for each direction (azimuth angle direction in this example). The communication control device 130 specifies a direction (here, up to an azimuth angle direction ϕ₁≤ϕ≤ϕ₂) of the protection zone 410 of the primary system viewed from the communication device 110 as a calculation target range. The communication control device 130 calculates allowable transmission power in each direction included in ϕ₁≤ϕ≤ϕ₂ on the basis of the allowable interference power amount of the primary system 400 and the propagation loss between the communication device 110 and the primary system 400 for the corresponding range, and sets P_{EIRP}(ϕ,θ)_{(dBm)} in ϕ₁≤ϕ≤ϕ₂. The communication control device 130 generates a new envelope on the basis of this P′_{EIRP}(ϕ,θ)_{(dBm)} and notifies the communication device 110 of the new envelope as an allowable envelope. In the new envelope at this time, for example, the value in the direction other than the range (ϕ₁ to ϕ₂) in the azimuth angle direction may be the value (initial value) of the envelope provided from the communication device 110, and the value in each direction included in ϕ₁≤ϕ≤ϕ₂ may be changed to P′_{EIRP}(ϕ,θ)_{(dBm)}. In the CBRS, the maximum allowable transmission power (allowable transmission power) is determined for each communication device in the available spectrum evaluation processing. However, in the present embodiment, as illustrated in FIG. 19, the allowable transmission power is individually set not only for each communication device but also for each direction, whereby the spectrum use efficiency can be improved.

In FIG. 19, the calculation target range is specified and the allowable transmission power is calculated only in the azimuth angle direction, but similarly, the calculation target range may be set also in the elevation angle direction θ, and the allowable transmission power may be calculated and the envelope may be calculated.

Note that the calculation of the maximum allowable transmission power in the available spectrum evaluation processing may be performed in a case where it is sufficient to consider interference from a single communication device that does not consider cumulative interference from a plurality of communication devices (in a case where there is no problem with single entry), or in a case where calculation in consideration of cumulative interference from a plurality of communication devices can be performed in the available spectrum evaluation processing.

In actual calculation, allowable transmission power is calculated for one or more calculation points p set in the protection zone 410 of the primary system 400. The azimuth angle and the elevation angle in the calculation point p direction are defined as ϕₚ,θₚ, respectively. The transmission power P′_{EIRP}(ϕₚ,θₚ)_{(dBm)} allowed in the calculation point p direction at this time can be expressed by the following Expression (5) using the allowable interference power I_{Th(dBm)} and the propagation loss PL(d)_{(dB)}.

$$[ Math . 5 ]$$

$${{P}_{EIRP}^{′} ( {ϕ}_{p} , {θ}_{p} )}_{( dBm )} = {I}_{Th ( dBm )} + {PL ( d )}_{( dB )} \qquad ( 5 )$$

In a case where a plurality of calculation points is set in the protection zone 410, the allowable transmission power P′_{EIRP}(ϕₚ,θ_{P})_{(dBm)} is calculated for two or more ϕₚ,θₚ combinations in the azimuth angle direction ϕ₁≤ϕ≤ϕ₂ and the elevation angle θ₁≤θ≤θ₂.

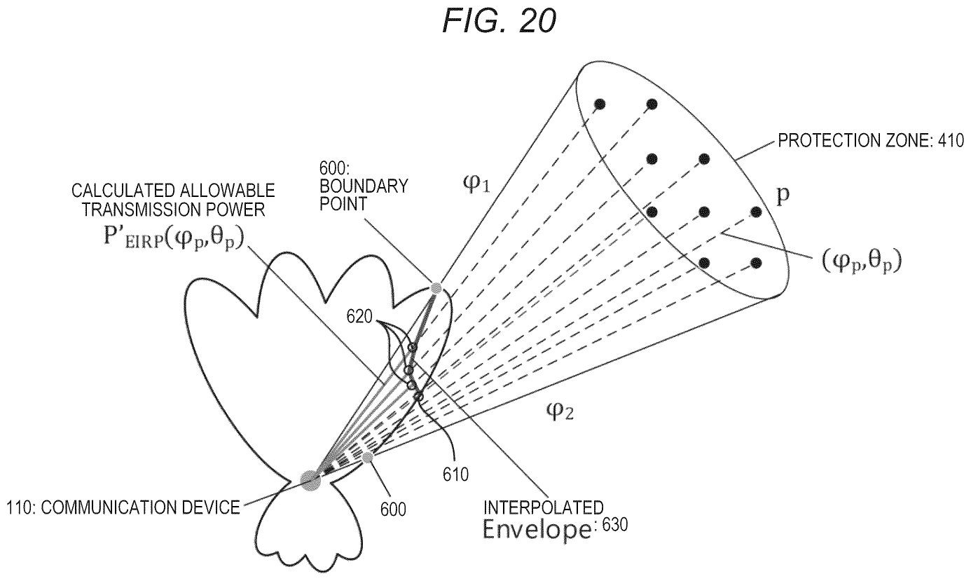

FIG. 20 illustrates an example in which the envelope is obtained by setting a plurality of calculation points in the protection zone 410.

The envelope is obtained by setting a plurality of calculation points within a calculation target range (calculation target range corresponding to the protection zone 410) based on at least one of the azimuth angle or the elevation angle. First, a point 620 representing the allowable transmission power P′_{EIRP}(ϕₚ,θₚ)_{(dBm)} corresponding to the plurality of calculation points p, a point 600 (boundary point) representing the initial value (P_{EIRP}^{init}(ϕ,θ)_{(dBm)}) of the envelope at the boundary of the calculation target range, and a point 610 representing the initial value (P_{EIRP}^{init}(ϕ,θ)_{(dBm)}) of the envelope on the line connecting the calculation point p and the communication device 110 are calculated, and these points are linearly interpolated or these points 600 to 620 are connected by a straight line to obtain a new envelope 630. Alternatively, these points 600 to 620 may be interpolated in two or more dimensions to form a new envelope. Here, three types of points of the point 600 to 620 are used, but two types of points, for example, only two kinds of points of the point 620 and the point 600 may be used.

Note that, for a calculation point or a range where both of the corresponding points 610 and 620 exist, it is desirable to obtain an envelope using a smaller value of P′_{EIRP}(ϕₚ,θₚ)_{(dBm)} and P_{EIRP}^{init}(ϕ,θ)_{(dBm)} (that is, the value of the envelope is always set not to exceed P_{EIRP}^{init}(ϕ,θ)_{(dBm)} which is the initial value of the envelope notified from the communication device 110).

In addition, in a case where the protection zone 410 of the primary system 400 is only a point p₁, ϕₚ_{ᵢ}+ϕₘ and θₚ_{₁}−θₘ to θₚ_{₁}+θₘ from a range ϕₚ_{₁}−ϕₘ obtained by adding a margin in the direction ϕₚ_{₁},θₚ_{₁} of the primary system 400 may be set as the calculation target range. A line connecting the point representing the allowable transmission power in ϕₚ_{₁} and the point representing the initial value (P_{EIRP}^{init}(ϕ,θ)_{(dBm)}) of the envelope at the boundary of the calculation target range (see boundary point 600 in FIG. 20), an interpolation between the points, or the like can be used as a new envelope.

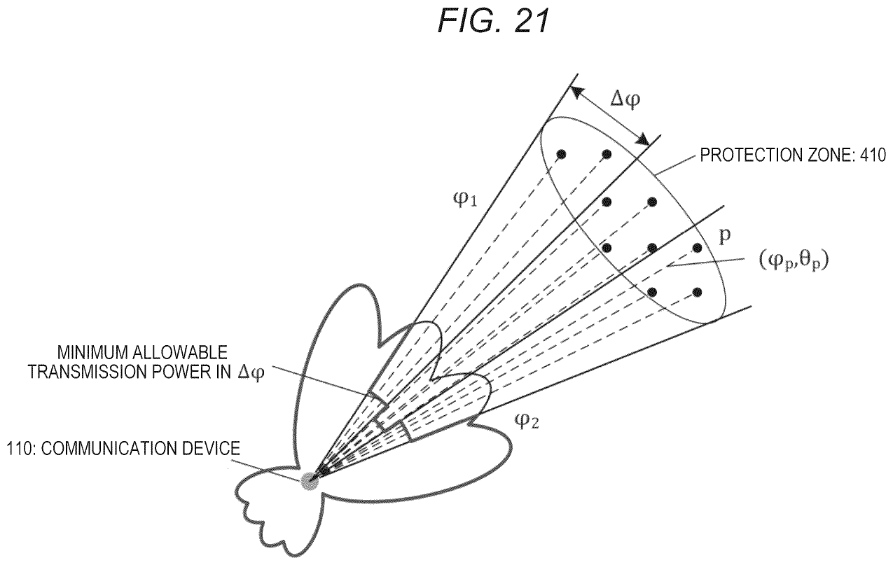

FIG. 21 illustrates another example in which the envelope is obtained by setting a plurality of calculation points in the protection zone 410. The calculation target range ϕ₁≤ϕ≤ϕ₂ and θ₁≤θ≤θ₂ is divided at regular intervals Δϕ,Δθ. The minimum value of the allowable transmission power P′_{EIRP}(ϕₚ,θₚ)_{(dBm)} of ϕₚ,θₚ included in each range is an envelope of the range. That is, when a certain range after the division is denoted by ϕₖ≤ϕ≤ϕₖ+Δϕ=ϕₖ₊₁ and θₗ≤θ≤ₗ+Δθ=θₗ₊₁, the value of the envelope of the range can be expressed by

$${min}_{{{ϕ}_{k} \leq {ϕ}_{p} \leq {ϕ}_{k + 1}}_{{θ}_{l} \leq {θ}_{p} \leq {θ}_{l + 1}} ,} {{P}_{EIRP}^{′} ( {ϕ}_{p} , {θ}_{p} )}_{( dBm )} .$$

### <4.1.2 Spectrum Grant Procedure>

In the spectrum grant procedure of the CBRS, the communication control device (SAS) permits the communication device (CBSD) to use the spectrum by the spectrum use permission processing, and can provide the communication device with the recommended communication parameter including the spectrum range and the maximum allowable transmission power information. In the present embodiment, in the spectrum grant procedure, the processing unit 32 of the communication control device 130 performs the spectrum use permission processing on the basis of the envelope of the beam provided from the communication device 110, and provides the communication device with the permission (grant) of the spectrum use and the recommended communication parameter including the available envelope. It should be noted that the envelope may be either an envelope of one beam (individual envelope) or an overall envelope covering the entire envelope of two or more beams.

For example, the processing unit 32 of the communication control device 130 receives a use permission request of a spectrum including information on an envelope of a beam desired to be used from the communication device 110, and determines whether or not the envelope of the beam is included in an allowable envelope calculated by any of the various methods described in <4.1.1.1>. In a case where the envelope of the requested beam is included in the allowable envelope, the processing unit 32 of the communication control device 130 determines an envelope of any shape within the range of the allowable envelope as the envelope that is allowed to be used by the communication device 110, and transmits a use permission response including a spectrum use permission (grant) designating the determined envelope to the communication device 110. The arbitrary envelope may be the envelope of the beam desired by the communication device 110, may be an envelope obtained by adjusting the shape of the envelope of the beam desired by the communication device 110, or may be an envelope of a shape arbitrarily determined by the communication control device 130 by another method. In a case where the envelope of the beam requested from the communication device 110 is not included in the allowable envelope, the processing unit 32 of the communication control device 130 transmits a response indicating that the envelope of the requested beam is unavailable to the communication device 110. At this time, information of the calculated allowable envelope may be included in the response transmitted to the communication device 110 as the recommended communication parameter. The communication device 110 may determine a beam desired to be used again on the basis of the received information, and transmit a use permission request of a spectrum including information of an envelope of the determined beam.

The processing unit 32 of the communication control device 130 can also issue a spectrum use permission (grant) for each envelope. In other words, the communication device 110 can also obtain the spectrum use permission for each envelope. In the case of the Individual Envelope, the processing unit 32 of the communication control device 130 can issue two or more grants for each envelope of a plurality of beams for one communication device. In addition, parameters such as an envelope to be provided to the communication device 110 as recommended communication parameters may be calculated by Cooperative Periodic Activities among SASs (CPAS) in the CBRS.

### <4.1.2.1 Spectrum Grant Procedure>

In the spectrum use permission processing in the spectrum grant procedure, the processing unit 32 of the communication control device 130 performs processing similar to <4.1.1.1> on the basis of the information of the envelope provided from the communication device 110, and calculates a new envelope. The processing unit 32 of the communication control device 130 may notify the communication device 110 of a recommended communication parameter instructing use of the calculated new envelope. Note that, also in the spectrum use permission processing, the maximum allowable transmission power may be calculated in a case where it is sufficient to consider interference from a single communication device that does not consider cumulative interference from a plurality of communication devices (in a case where there is no problem with single entry), or in a case where calculation in consideration of cumulative interference from a plurality of communication devices can be performed in the available spectrum evaluation processing.

### <4.1.3 Spectrum Use Notification>

In the spectrum use notification (heartbeat procedure) of the CBRS, the communication control device (SAS) can receive the spectrum use notification notifying that the use of the use permitted spectrum from the communication device (CBSD), determine whether or not the spectrum use of each grant permitted by <4.1.2> is permitted (permission of continuous use of the spectrum or the like related to the grant), and notify the communication device of the determination result. Further, the communication control device can provide a recommended communication parameter designating the spectrum range and the maximum allowable transmission power information to the communication device.

In the present embodiment, the processing unit 32 of the communication control device 130 that has received the spectrum use notification may provide the communication device 110 with the recommended communication parameters including the envelope available in each grant, and instruct to reconfigure the communication parameters (reconfigure the envelope). Here, a representative example of a parameter such as an envelope provided to the communication device 110 as the recommended communication parameter is calculated by the CPAS in the CBRS. Alternatively, in a case where a direction in which transmission is to be prohibited or a direction in which transmission power is to be reduced occurs due to a situation change of the primary system (a situation change of the protection target), the processing unit 32 of the communication control device 130 may calculate a new envelope by performing processing similar to <4.1.1.1> on the basis of the envelope provided from the communication device 110. That is, the envelope permitted to the communication device 110 may be changed on the basis of the information of the envelope provided from the communication device 110 according to the situation change of the primary system. In a case where a new envelope has been calculated (in a case where a permissive envelope has been changed), the processing unit 32 of the communication control device 130 may notify the communication device 110 of a recommended communication parameter instructing the new envelope. As a situation change of the primary system, there may be various changes such as addition or deletion of a new primary system, enlargement or reduction of a protection zone, addition or deletion of a protection point, and a change in a use spectrum of a primary system.

In addition, in order to determine whether or not to use the spectrum of the grant, the processing unit 32 of the communication control device 130 simultaneously receives an envelope from the communication device 110 and compares the received envelope with a previously-calculated allowable envelope to determine whether or not the received envelope is included in the allowable envelope. In a case where the envelope from the communication device 110 is not included in the allowable envelope, that is, in a case where the received envelope partially deviates from the allowable envelope, the processing unit 32 of the communication control device 130 may instruct the communication device 110 to reconfigure the communication parameters including the change of the envelope, or may reject the use of the envelope (spectrum use) for the communication device 110.

### <4.1.4 Information Exchange>

In the present embodiment, in the exchange of the management information between the communication control device 130 and another communication control device, the information on the envelope of the beam acquired from the communication device 110 in the spectrum grant procedure or the like may be included as the information on the communication device 110.

Furthermore, in the CBRS, information regarding a protection zone of the communication device 110, which is a secondary system with a higher priority than GAA, such as PAL Protection Area (PPA) disclosed in Non-Patent Document 1 (WINNF-TS-0112), is also exchanged as area information with another communication control device. The processing unit 32 of the communication control device 130 may determine the PPA of the communication device 110 on the basis of the envelope of the beam provided from the communication device 100 in a spectrum grant procedure or the like, and exchange information of the determined PPA as area information with another communication control device. Specifically, the processing unit 32 of the communication control device 130 may regard the envelope of the beam provided from the communication device 110 as a static three-dimensional antenna pattern, and perform the calculation of PPA, for example, according to the method disclosed in Non-Patent Document 1. Note that, in a case where the envelope at this time is Individual Envelope, the processing unit 32 of the communication control device 130 may perform calculation of PPA for each Individual Envelope and combine the calculation results to obtain one PPA. Alternatively, the processing unit 32 of the communication control device 130 may exchange information on the PPAs calculated for each Individual Envelope with another communication control device as individual PPAs.

<4.2 Extension of Cooperative Periodic Activities among SASs (CPAS) in CBRS>

In the CBRS, the use permission of the spectrum and the calculation of the recommended communication parameter are performed by executing Cooperative Periodic Activities among SASs (CPAS) once a day on the basis of various pieces of information regarding the communication device provided in the spectrum use permission procedure and provided from another communication control device and information of the primary system.

According to Non-Patent Document 1 and Non-Patent Document 8 (WINNF-SSC-0008), during CPAS, a plurality of pieces of interference margin allocation processing is sequentially performed such as:
Calculation of a Fixed Satellite Service (FSS) Out Of Band Emission (OOBE) Purge List for a Fixed Satellite Service (FSS) TT & C;
Iterative Allocation Process (IAP) for protecting an FSS, an Environmental Sensing Capability (ESC) Sensor, a PAL Protection Area (PPA), and a Grandfathered Wireless Protection Zone (GWPZ); and
Calculation of DPA Move List for Dynamic Protection Area (DPA).

In the present embodiment, an extension is provided so that the communication control device 130 can perform the CPAS based on the envelope provided from the communication device 110 in the spectrum grant procedure and the envelope acquired from another communication control device.

Hereinafter, a detailed procedure in a case where the communication control device 130 extends each calculation performed during CPAS on the basis of an envelope provided from the communication device 110 or an envelope mainly from another communication control device in information exchange will be described.

### <4.2.1 Extension of Calculation of FSS OOBE Purge List>

The FSS OOBE Purge List is a list for protecting a fixed satellite service earth station (FSS earth station). In the CBRS, in a case where the primary system starts using radio waves that can interfere with beams related to the grant stored in the list, the communication control device needs to discard the grant. On the other hand, in the present embodiment, an envelope that prohibits the emission of the beam in the direction ϕ₁, θ₁ in which the FSS exists is obtained for the communication device having the grant included in the Purge List. In a case of detecting the start of use of the spectrum by the primary system (FSS), the processing unit 32 of the communication control device 130 transmits instruction data instructing to change the envelope of the beam used by the communication device 110 to an allowable envelope calculated by a method to be described later for the grant related to the spectrum included in the Purge List. In the CBRS, it is necessary to discard the grant as described above, but in the present embodiment, since the spectrum can be continuously used by changing the envelope of the beam, the spectrum use efficiency can be improved. Hereinafter, calculation of the Purge List according to the present embodiment will be described in detail.

First, the processing unit 32 of the communication control device 130 regards the envelope of the beam provided from the communication device 110 as a static three-dimensional antenna pattern, and creates a Purge List (FSS OOBE Purge List) for FSS TT & C according to Non-Patent Document 1, for example. Here, a communication device having the grant that is not included in the Purge List can be used for subsequent processing without changing the provided envelope.

The processing unit 32 of the communication control device 130 obtains an envelope that prohibits the emission of the beam in the direction ϕ₁, θ₁ in which the FSS exists for the communication device having the grant included in the Purge List.

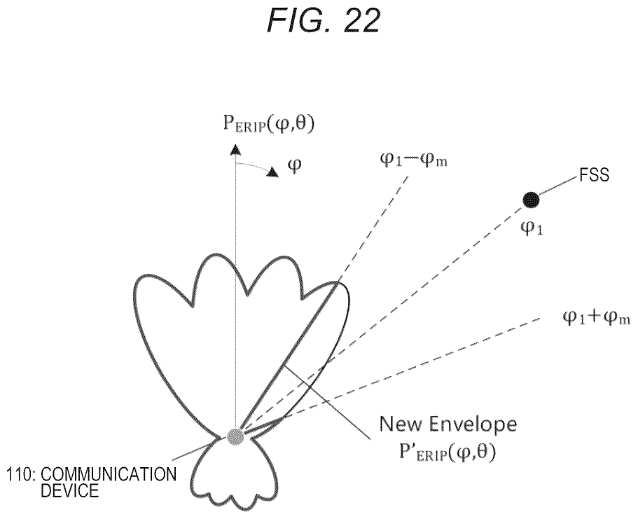

FIG. 22 illustrates an example of obtaining an envelope that prohibits beam radiation in the direction ϕ₁, θ₁ in which the FSS exists. The position of the FSS is expressed as a point. Therefore, a range ϕ₁−ϕₘ≤ϕ≤ϕ₁+ϕₘ,θ₁−θₘ≤θ≤θ₁+θₘ obtained by adding a certain margin to ϕ₁, θ₁ is set as a use prohibited range, and P′_{EIRP}(ϕ,θ)_{(dBm)} where the allowable transmission power is set to negative infinity in logarithmic display or 0 in a true value is set as a new envelope.

Alternatively, the transmission power at the position of ϕ₁, θ₁ may be set to negative infinity or 0 in a true value, linear interpolation may be performed between ϕ₁−ϕₘ,θ₁+θₘ and between θ₁−θₘ,θ₁+θₘ, or a straight line may be connected between them to calculate the envelope of the range (of ϕ₁−ϕₘ≤ϕ≤ϕ₁+ϕₘ,θ₁−θₘ≤θ≤θ₁+θₘ) (see FIG. 20 described above for linear interpolation and the like).

Note that, since the calculation of the Purge List is performed by dividing the spectrum range of the grant into a plurality of portions (channels) for convenience of calculation, the final envelope needs to be an overlapping portion of the envelopes of the respective channels. In addition, even in a case where there is a plurality of FSSs, the overlapping portion of the envelope calculated in each case is the final envelope of one grant.

### <4.2.2 Extension of Iterative Allocation Process (IAP)>

First, a processing flow of the IAP used in the CBRS will be described. The processing unit 32 of the communication control device 130 calculates the transmission power P of the communication device n so that the cumulative interference power satisfies the following condition (6) at all of one or more calculation points set in the protection zone of the primary system.

$$[ Math . 6 ]$$

$${I}_{accept ( dBm )} \geq 10 \cdot log \{ {\sum }_{n = 1}^{{N}_{p}} {10}^{\frac{{I}_{n \to p ( dBm )}}{10}} \} \qquad ( 6 )$$

Here, I_{accept(dBm)} is a threshold of interference power (cumulative interference power) allowable by the primary system.

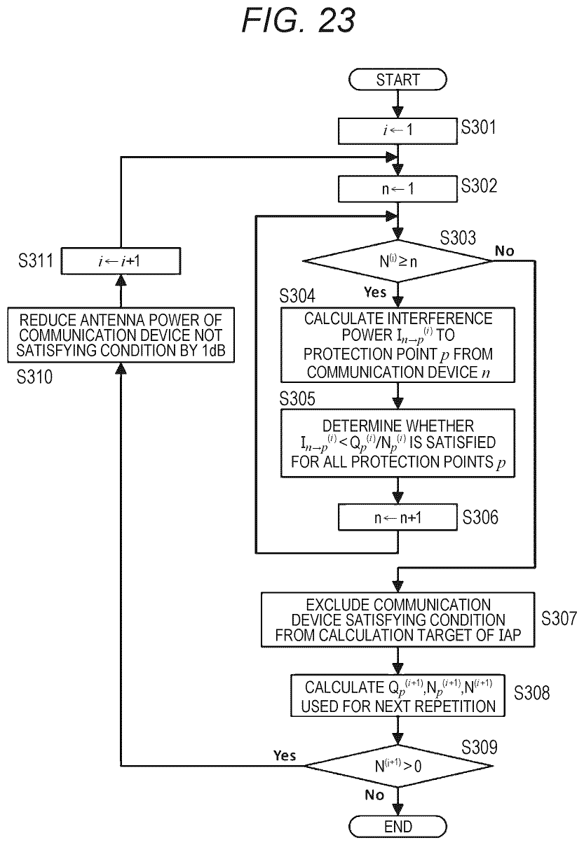

FIG. 23 is a flowchart of a process for obtaining transmission power P′ₙ_{_{(dBm)}} allowed for the communication device n by the IAP after the condition of Expression (6) is satisfied. Note that, in the following description, the number of repetitions of IAP is represented by i(i≥1). Note that, in the CBRS, the IAP is performed by dividing the spectrum range of the grant into channels having a width of 5 MHz for convenience of calculation, but the following is a description of a case where calculation is performed for only one channel. In order to actually obtain the maximum allowable transmission power of the grant, it is necessary to aggregate calculation results of all channels.

First, the number of repetitions i is set to 1 (S301). A communication device that is a calculation target of the IAP for any calculation point (protection point) p is represented by n (1≤n≤N⁽ⁱ⁾). N⁽ⁱ⁾ is the total number of communication devices that are IAP calculation targets for any one or more calculation points when the number of repetitions is i. Assuming that n=1, interference power to each calculation point p is calculated for the communication device n (S302, S303, S304).

The interference power I_{n→p(dBm)}⁽ⁱ⁾ for the calculation point p when the number of repetitions of IAPs is i can be expressed by following Expression (7).

$$[ Math . 7 ]$$

$${I}_{n \to p ( dBm )}^{( i )} = {P}_{n ( dBm )}^{( i )} + {{G}_{n} ( {ϕ}_{n \to p} , {θ}_{n \to p} )}_{( dB )} - {L}_{n \to p ( dB )} + {{G}_{PS} ( {ϕ}_{p \to n} , {θ}_{p \to n} )}_{( dB )} \qquad ( 7 )$$

P_{n(dBm)}⁽ⁱ⁾ is the antenna power of the communication device n, which is set when the number of repetitions of IAPs is i. Note that the initial value P_{n(dBm)}⁽¹⁾ of Pₙ⁽ⁱ⁾ may be the desired antenna power requested by the communication device 110 to the communication control device 130.

Next, it is determined whether the interference from the communication device n is equal to or less than the allowable value for all the calculation points p (S305). Here, a value obtained by dividing the total amount of interference margin Q_{p(dBm)}⁽ⁱ⁾ related to a calculation point p at which there is a communication device to which an interference margin is not allocated at the time when the number of repetitions is i by the number Nₚ⁽ⁱ⁾ of communication devices that require calculation of interference to the calculation point p is set as an allowable value of interference power to the calculation point p per communication device. Therefore, in step S305, it is determined whether the following condition (8) is satisfied for all the calculation points p.

$$[ Math . 8 ]$$

$${I}_{n \to p ( dBm )}^{( i )} < 10 \cdot log \{ {10}^{\frac{{Q}_{p ( dBm )}^{( i )}}{10}} / {N}_{p}^{( i )} \} \qquad ( 8 )$$

Note that the initial value of the total amount of unallocated interference margin may be Q_{p(dBm)}⁽¹⁾=I_{accept(dBm)}, and an initial value of the number of communication devices 110 for which calculation of interference to a calculation point p is required may be Nₚ⁽¹⁾=Nₚ.

Steps S304 and S305 described above are executed for all N⁽ⁱ⁾ communication devices 110. That is, steps S304 and S305 are executed for all the communication devices n in order from 1 to N⁽ⁱ⁾ (S303, S306).

The communication device n satisfying the condition (8) for all the calculation points p is excluded from the calculation target of the IAP after the next repetition (S307). Note that the maximum antenna power P_{n(dBm)}⁽ⁱ⁾ set in the communication device n at the time of exclusion is the maximum antenna power P′_{n(dBm)} allowed by the communication device n.

Then, the total amount of interference margin Q_{p(dBm)}⁽ⁱ⁺¹⁾ in the next i+1 repetition is calculated by summing up interference power I_{n→p(dBm)}⁽ⁱ⁾ for all the communication devices excluded from the calculation target and subtracting the summed value from the total amount of interference margin Qₚ⁽ⁱ⁾ (S308).

In addition, the number of communication devices that fail to satisfy the condition (8) among the Nₚ⁽ⁱ⁾ communication devices that require the calculation of the interference to the calculation point p is set as the number Nₚ⁽ⁱ⁺¹⁾ of communication devices that require the calculation of the interference in the next i+1 repetition (S308).

Furthermore, at the time of the number of repetitions i+1, the total number N⁽ⁱ⁺¹⁾ of communication devices that are IAP calculation targets for any one or more calculation points is calculated (S308 of the same).

In a case where there remains a communication device that has not satisfied the condition (8) at any one or more calculation points p (protection points), that is, in a case where N⁽ⁱ⁺¹⁾>0 (Yes in S309), the antenna power of the communication device that has not satisfied the condition is reduced by 1 dB (S310) and used in the next i+1 repetition (S311). That is, the antenna power used in the i+1 repetition can be expressed as P_{n(dBm)}⁽ⁱ⁺¹⁾=P_{n(dBm)}⁽ⁱ⁾−1.

IAP is repeated until all the communication devices satisfy the condition of (8) for all the calculation points p, that is, until N⁽ⁱ⁺¹⁾=0. As a result, the maximum antenna power P′ₙ allowed for all the communication devices can be obtained.

In a case where the IAP illustrated in the flowchart of FIG. 23 described above is extended to the envelope, similarly to the case of obtaining the maximum allowable transmission power by <4.1.1.1>, the direction (here, the azimuth angle direction ϕ₁≤ϕ≤ϕ₂ and the elevation angle θ₁≤θ≤θ₂) of the protection zone of the primary system 400 viewed from the communication device 110 is specified as the calculation target range, similarly to FIG. 20. The allowable transmission power P_{EIRP}(ϕ_{n→p},θ_{n→p})_{(dBm)} is obtained for each direction ϕ_{n→p},θ_{n→p} from the communication device n to the calculation point p. A point (see point 620 in FIG. 20) representing the allowable transmission power P′_{EIRP}(ϕ_{n→p},θ_{n→p})_{(dBm)} corresponding to all the plurality of calculation points p, a point (see boundary point 600 in FIG. 20) representing the initial value of the envelope at the boundary of the calculation target range, and a point (see point 610 in FIG. 20) representing the initial value of the envelope on the line connecting the calculation point p and the communication device 110 are calculated, and these points are linearly interpolated or connected by a straight line to obtain a new envelope 630. Alternatively, these points may be interpolated in two or more dimensions to form a new envelope.

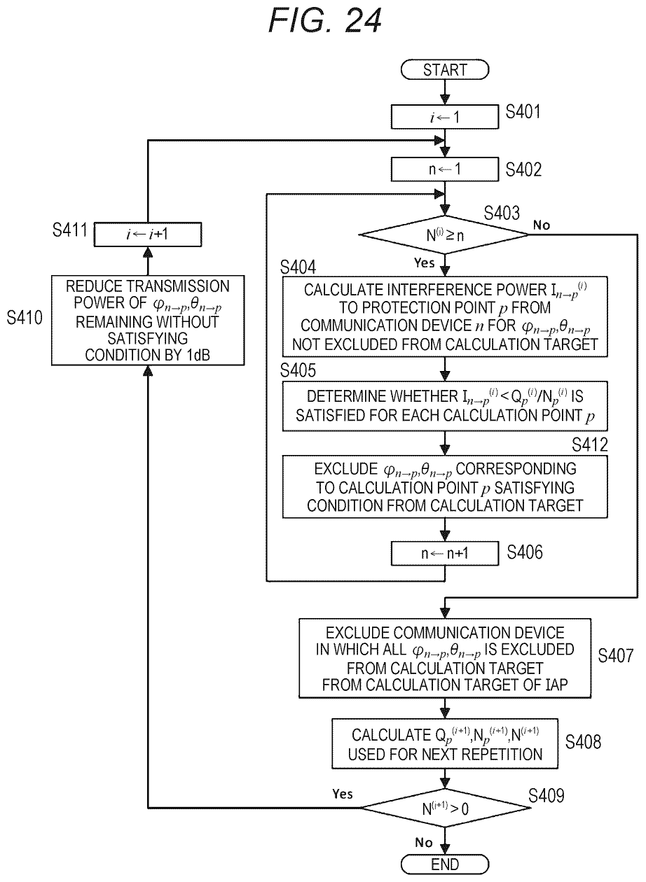

FIG. 24 illustrates an example of a flowchart of processing for obtaining the allowable transmission power P′_{EIRP}(ϕ_{n→p},θ_{n→p})_{(dBm)} by the IAP. Steps S401 to S403, S406, S408, S409, and S411 are the same as steps S301 to S303, S306, S308, S309, and S311 in FIG. 23. Steps S404, S405, S407, and S410 are extended from steps S304, S305, S307, and S310 in FIG. 23, and step S412 is added.

N⁽ⁱ⁾ is the total number of communication devices for which one or more ϕ_{n→p},θ_{n→p} are IAP calculation targets when the number of repetitions is i. First, the processing of steps S404, S405, and S412 is executed for the communication device n in order from n=1 to N⁽ⁱ⁾.

In step S404, the interference power from the communication device n to each calculation point p (protection point) is calculated. In the conventional IAP (see FIG. 23), since only the communication device in which the interference power becomes the allowable value (specified value) or less at all the calculation points p is excluded from the calculation target, the interference power is calculated for all the calculation points to confirm whether the interference power is the allowable value or less. On the other hand, in a case where the IAP is performed based on the envelope in the present embodiment, since ϕ_{n→p},θ_{n→p} in which the condition is satisfied is excluded from the calculation target, the calculation of the interference power is performed only for ϕ_{n→p},θ_{n→p} which is not excluded from the calculation target at that time (S404). The interference power I_{n→p(dBm)}⁽ⁱ⁾ for the calculation point p when the number of repetitions of IAPs is i can be expressed by following Expression (9).

$$[ Math . 9 ]$$

$${I}_{n \to p ( dBm )}^{( i )} = {{P}_{n , EIRP}^{( i )} ( {ϕ}_{n \to p} , {θ}_{n \to p} )}_{( dB )} - {L}_{n \to p ( dB )} + {{G}_{PS} ( {ϕ}_{p \to n} , {θ}_{p \to n} )}_{( dB )} \qquad ( 9 )$$

P_{n,EIRP}⁽ⁱ⁾(ϕ_{n→p},θ_{n→p})_{(dB)} is the transmission power in the direction ϕ_{n→p},θ_{n→p} of the communication device n, which is set when the number of repetitions of IAPs is i. This P_{n,EIRP}⁽ⁱ⁾(ϕ_{n→p},θ_{n→p})_{(dB)} is the EIRP including the antenna gain of the communication device n. Note that the initial value P_{n,EIRP}⁽¹⁾(ϕ_{n→p},θ_{n→p})_{(dB)} of P_{n,EIRP}⁽ⁱ⁾(ϕ_{n→p},θ_{n→p})_{(dB)} may be transmission power obtained from the initial value of the direction ϕ_{n→p},θ_{n→p} of the envelope provided from the communication device 110.

Next, it is determined whether interference from the communication device n is equal to or less than an allowable value for each calculation point p (S405). Here, a value obtained by dividing the total amount Q_{p(dBm)}⁽ⁱ⁾ of the interference margin regarding the calculation point p at which there is a communication device to which the interference margin is not allocated when the number of repetitions is i by the number Nₚ⁽ⁱ⁾ of communication devices that require calculation of interference to the calculation point p is set as the allowable value of the interference power to the calculation point p per communication device. In the present embodiment, it is determined whether the following condition (10) is satisfied for each calculation point p.

$$[ Math . 10 ]$$

$${I}_{n \to p ( dBm )}^{( i )} < 10 \cdot log \{ {10}^{\frac{{Q}_{p ( dBm )}^{( i )}}{10}} / {N}_{p}^{( i )} \} \qquad ( 10 )$$

ϕ_{n→p},θ_{n→p} corresponding to the calculation points p satisfying the condition (10) are excluded from the calculation target of the IAP after the next repetition (S411). The maximum transmission power P_{n,EIRP}⁽ⁱ⁾(ϕ_{n→p},θ_{n→p})_{(dB)} set at the time of exclusion is allowable transmission power P′_{EIRP}(ϕ_{n→p},θ_{n→p})_{(dBm)} in the ϕ_{n→p},θ_{n→p} direction of the communication device n.

Steps S404, S405, and S411 described above are executed for all N⁽ⁱ⁾ communication devices 110. That is, steps S404, S405, and S411 are executed for all the communication devices n in order from 1 to N⁽ⁱ⁾ (S403, S406).

The communication device of which all ϕ_{n→p},θ_{n→p} is excluded from the calculation target is excluded from the calculation target of the IAP itself (S407).

The interference power I_{n→p(i)(dBm)}⁽ⁱ⁾ corresponding to the excluded ϕ_{n→p},θ_{n→p} direction is summed for all the communication devices, and the summed value is subtracted from the total amount Qₚ⁽ⁱ⁾ of the interference margin to obtain the remaining total amount Q⁽ⁱ⁺¹⁾ of the interference margin at the calculation point p in the next i+1 repetition (S408).

In addition, among the Nₚ⁽ⁱ⁾ communication devices, the number of communication devices that do not satisfy the condition (10) and where ϕ_{n→p},θ_{n→p} remain is the number Nₚ⁽ⁱ⁺¹⁾ of communication devices that require interference calculation for each calculation point p in the next i+1 repetition (same S408).

At the time of the next repetition number i+1, the total number N⁽ⁱ⁺¹⁾ of communication devices of which one or more ϕ_{n→p},θ_{n→p} are IAP calculation targets is calculated (same S408).

For a communication device having a direction that does not satisfy the condition of (10), the transmission power of ϕ_{n→p},θ_{n→p} that does not satisfy the condition of (10) and remains as a calculation target is reduced by 1 dB or any other value, and the reduced transmission power is used in step S404 of the next i+1 repetition. That is, the transmission power in the ϕ_{n→p},θ_{n→p} direction used in the i+1 repetition in the communication device not excluded in step S407 can be expressed by P_{n,EIRP}⁽ⁱ⁺¹⁾(ϕ_{n→p},θ_{n→p})_{(dB)}=P_{n,EIRP}⁽ⁱ⁾(ϕ_{n→p},θ_{n→p})_{(dB)}−1.

The above procedure is repeated until there is no communication device of the calculation target, that is, until N)=0 (S409). As a result, it is possible to obtain all the allowable transmission power P′_{n,EIRP}(ϕ_{n→p},θ_{n→p})_{(dBm)} within the calculation target range (azimuth angle direction ϕ₁≤ϕ≤ϕ₂ and elevation angle θ₁≤θ≤θ₂) of each communication device.

Note that, since IAP is performed by dividing the spectrum range of the grant into a plurality of portions (channels) for convenience of calculation, the final envelope needs to be an overlapping portion of the envelope of each channel.

In addition, in a case where IAP is performed on a plurality of primary systems, an overlapping portion of the envelope calculated in each of the primary systems becomes a final envelope of one grant. Alternatively, the minimum allowable transmission power among the allowable transmission powers calculated for the plurality of primary systems (protection targets) for each direction may be calculated, and the allowable envelope may be determined on the basis of the minimum allowable transmission power for each direction.

### <4.1.2.3 Calculation of DPA Move List>

The processing unit 32 of the communication control device 130 regards the envelope of each grant determined according to the FSS Purge List and IAP as a static three-dimensional antenna pattern, and calculates a Dynamic Protection Area (DPA) Move List according to Non-Patent Document 1, for example. The DPA Move List is a list for protecting the DPA. In the present embodiment, for the grant stored in the list, the communication device 110 needs to temporarily stop radio wave transmission during a period in which a radar or the like as a primary system uses a radio wave that can interfere with a beam (the above-described envelope) related to the grant.

As described above, according to the present embodiment, by using the information of the envelope provided from the communication device or another communication control device, it is possible to calculate the information of the envelope that can be transmitted with larger transmission power for a beam with small interference while suppressing transmission power for a beam with large interference with the primary system, and provide the information to the communication device. This makes it possible to more effectively utilize dynamic beamforming while protecting the primary system.

Note that the embodiments described above illustrate examples for embodying the present disclosure, and the present disclosure can be implemented in various other forms. For example, various modifications, substitutions, omissions, or combinations thereof are possible without departing from the gist of the present disclosure. Such modifications, substitutions, omissions, and the like are also included in the scope of the present disclosure and are similarly included in the invention described in the claims and the equivalent scopes thereof.

Furthermore, the effects of the present disclosure described in the present specification are mere examples, and other effects may be provided.

Note that the present disclosure can have the following configurations.

### [Item 1]

A communication control device including a processing unit configured to:
detect a first communication device capable of transmitting a signal in a target period on the basis of setting information defining a period in which a plurality of communication devices is capable of transmitting the signal; and
determine a beam pattern allowable for the first communication device in the target period on the basis of an interference amount given to a protection target by the first communication device.

### [Item 2]

The communication control device according to item 1,
in which the processing unit determines a beam pattern allowable for a plurality of the first communication device in the target period on the basis of a cumulative interference amount given to the protection target by the plurality of the first communication device.

### [Item 3]

The communication control device according to item 1 or 2,
in which the processing unit is configured to: determine a first beam pattern for the first communication device for a first target period, and determines a second beam pattern for the first communication device for a second target period;
identify a pattern portion in which the first beam pattern and the second beam pattern are common; and
set the pattern portion in common as a beam pattern allowable for the first communication device in both the first target period and the second target period.

### [Item 4]

The communication control device according to any one of items 1 to 3,
in which the setting information is information defining which of transmission of the signal and reception of the signal is performed for each unit period of time division for the plurality of communication devices that performs the transmission of the signal and the reception of the signal in the time division.

### [Item 5]

The communication control device according to item 4,
in which the target period is at least one of the unit period.

### [Item 6]

The communication control device according to item 5,
in which the unit period is a slot.

### [Item 7]

The communication control device according to item 4,
in which the unit period is a slot, and
the target period is a symbol period.

### [Item 8]

The communication control device according to item 4,
in which the target period is an arbitrary time section specified by a start timing and an end timing or an arbitrary time section specified by a start timing and a time length.

### [Item 9]

The communication control device according to any one of items 1 to 8,
in which the transmission of the signal by the plurality of communication devices is downlink transmission to terminal devices present in cells of the plurality of communication devices.

### [Item 10]

The communication control device according to any one of items 1 to 9, further including
a reception unit that receives a registration request for requesting registration of a device parameter of the first communication device,
in which the processing unit determines the beam pattern allowable for the first communication device for the target period in which the first communication device can transmit the signal in response to reception of the registration request.

### [Item 11]

The communication control device according to any one of items 1 to 10, further including
a reception unit that receives a query request regarding an available spectrum of the first communication device,
in which the processing unit determines the beam pattern allowable for the first communication device for the target period in which the first communication device can transmit the signal in response to reception of the query request.

### [Item 12]

The communication control device according to any one of items 1 to 11, further including
a reception unit that receives a use permission request for requesting a use permission of a spectrum by the first communication device,
in which the processing unit determines the beam pattern allowable for the first communication device for the target period in which the first communication device can transmit the signal in response to reception of the use permission request.

### [Item 13]

The communication control device according to any one of items 1 to 12,
in which the plurality of communication devices belongs to a lower layer having a lower priority of radio wave use than the protection target, and
the processing unit performs calculation processing for protecting the protection target from interference by the lower layer in cooperation with another communication control device, and performs detection of the first communication device for the target period and determination of the beam pattern allowable for the first communication device in the calculation processing.

### [Item 14]

The communication control device according to any one of items 4 to 8,
in which the processing unit divides the plurality of communication devices into one or more groups,
the communication devices belonging to the group are in a relationship in which radio wave interference occurs with at least one other communication device belonging to the group, and
the processing unit determines the setting information for each of the communication devices belonging to the group.

### [Item 15]

The communication control device according to item 14,
in which the processing unit is configured to:
provisionally determine a plurality of beam patterns allowable for the communication devices in the group on the basis of presence or absence of interference between the communication devices in the group; and
select a beam pattern allowable for the first communication device from the plurality of beam patterns provisionally determined.

### [Item 16]

The communication control device according to item 3, further including:
a reception unit that receives, from the first communication device, first wish information for wishing to acquire information of a beam pattern individually applied to the first target period and the second target period, or second wish information for wishing to acquire information of a beam pattern commonly applied to the first target period and the second target period; and
a transmission unit that transmits information indicating the first beam pattern and the second beam pattern to the first communication device in a case where the first wish information is received, and transmits information indicating the pattern portion in common to the first communication device as a beam pattern allowable for the first communication device in the first target period and the second target period in a case where the second wish information is received.

### [Item 17]

The communication control device according to any one of items 1 to 16,
in which the processing unit is configured to: select a beam pattern allowable for the first communication device from a plurality of beam patterns formable by the first communication device; or determine a beam pattern allowable for the first communication device on the basis of a beam movable range by the first communication device.

### [Item 18]

The communication control device according to any one of items 1 to 17,
in which the processing unit determines transmission power to be used when the first communication device transmits the signal in the beam pattern.

### [Item 19]

The communication control device according to any one of items 1 to 18, further including
a transmission unit that transmits information indicating the beam pattern determined to the first communication device.

### [Item 20]

A communication control method including:
detecting a first communication device capable of transmitting a signal in a target period on the basis of setting information defining a period in which a plurality of communication devices is capable of transmitting the signal; and
determining a beam pattern allowable for the first communication device in the target period on the basis of an interference amount given to a protection target by the first communication device.

### [Item 21]

A communication device that performs transmission of a signal and reception of a signal in a time division manner,
the communication device including:
a reception unit that receives information regarding a beam pattern allowable for the communication device in a target period of a period in which the signal can be transmitted; and
a processing unit that transmits the signal using the beam pattern based on the information in the target period.

### [Item 22]

A communication method by a communication device that performs transmission of a signal and reception of a signal in a time division manner,
the communication method including:
receiving information regarding a beam pattern allowable for the communication device in a target period of a period in which the signal can be transmitted; and
transmitting the signal using the beam pattern based on the information in the target period.

### [Item 23]

A communication control device including:
a processing unit that acquires information of an envelope of a beam that can be formed by a communication device secondarily using a spectrum same as or adjacent to a spectrum used by a protection target to be protected from radio wave interference, and determines an envelope allowable for the communication device on the basis of the information of the envelope and a position of the protection target.

### [Item 24]

The communication control device according to item 23,
in which the processing unit provides information of the envelope allowable to the communication device.

### [Item 25]

The communication control device according to item 23,
in which the processing unit receives a use permission request of a spectrum including information on an envelope of a beam desired to be used from the communication device, and
the processing unit determines, in a case where an envelope of the beam is included in the envelope allowable, an envelope of an arbitrary shape within a range of the envelope allowable as an envelope allowed for the communication device, and transmits a use permission response including a use permission of the envelope determined to the communication device.

### [Item 26]

The communication control device according to item 25,
in which, in a case where the envelope of the beam is not included in the envelope allowable, the processing unit transmits a response including information indicating unavailability of the envelope of the beam desired and a recommended communication parameter indicating information of the envelope allowable to the communication device.

### [Item 27]

The communication control device according to any one of items 23 to 26,
in which the processing unit changes the envelope to a shape that prevents radio wave transmission in a direction of the protection target, and determines the envelope changed as the envelope allowable.

### [Item 28]

The communication control device according to any one of items 23 to 27,
in which the processing unit determines allowable transmission power in a direction of the protection target on the basis of an allowable interference power amount of the protection target, and changes the envelope on the basis of the allowable transmission power to set the envelope allowable.

### [Item 29]

The communication control device according to item 25 or 26,
in which the processing unit receives a spectrum use notification notifying that the spectrum is used from the communication device, and
the processing unit changes the envelope permitted to the communication device according to a situation of the protection target, and transmits a response including information instructing use of the envelope changed to the communication device.

### [Item 30]

The communication control device according to item 23,
in which the processing unit transmits instruction data instructing to change an envelope of a beam used by the communication device to the envelope allowable in a case of detecting that the spectrum is started to be used by the protection target.

### [Item 31]

The communication control device according to any one of items 23 to 30,
in which the processing unit determines allowable transmission power for each of a plurality of directions with respect to the communication device on the basis of a position of the protection target and an allowable interference power amount of the protection target, and determines the envelope allowable on the basis of the allowable transmission power for each of the directions.

### [Item 32]

The communication control device according to item 31,
in which the processing unit calculates a minimum allowable transmission power among the allowable transmission power of a plurality of the protection target for each of the plurality of directions on the basis of a position of the plurality of the protection target and an allowable interference power amount of the plurality of the protection target, and determines the envelope allowable on the basis of the minimum allowable transmission power for each of the directions.

### [Item 33]

A communication control method including:
acquiring information of an envelope of a beam that can be formed by a communication device secondarily using a spectrum same as or adjacent to a spectrum used by a protection target to be protected from radio wave interference; and
determining an envelope allowable for the communication device on the basis of the information of the envelope and a position of the protection target.

### REFERENCE SIGNS LIST

11 Reception unit
12 Processing unit
13 Control unit
14 Transmission unit
Storage unit
31 Reception unit
32 Processing unit
33 Control unit
34 Transmission unit
Storage unit
110, 110A, 110B, 110C Communication device
120 Terminal
130, 130A, 130B, 130_1 to 130_N Communication control device

1. A communication control device comprising a processing unit configured to:
detect a first communication device capable of transmitting a signal in a target period on a basis of setting information defining a period in which a plurality of communication devices is capable of transmitting the signal; and
determine a beam pattern allowable for the first communication device in the target period on a basis of an interference amount given to a protection target by the first communication device.

2. The communication control device according to claim 1,
wherein the processing unit determines a beam pattern allowable for a plurality of the first communication device in the target period on a basis of a cumulative interference amount given to the protection target by the plurality of the first communication device.

3. The communication control device according to claim 1,
wherein the processing unit is configured to: determine a first beam pattern for the first communication device for a first target period, and determine a second beam pattern for the first communication device for a second target period;
identify a pattern portion in which the first beam pattern and the second beam pattern are common; and
set the pattern portion in common as a beam pattern allowable for the first communication device in both the first target period and the second target period.

4. The communication control device according to claim 1,
wherein the setting information is information defining which of transmission of the signal and reception of the signal is performed for each unit period of time division for the plurality of communication devices that performs the transmission of the signal and the reception of the signal in the time division.

5. The communication control device according to claim 4,
wherein the target period is at least one of the unit period.

6. The communication control device according to claim 5,
wherein the unit period is a slot.

7. The communication control device according to claim 4,
wherein the unit period is a slot, and
the target period is a symbol period.

8. The communication control device according to claim 4,
wherein the target period is an arbitrary time section specified by a start timing and an end timing or an arbitrary time section specified by a start timing and a time length.

9. The communication control device according to claim 1,
wherein the transmission of the signal by the plurality of communication devices is downlink transmission to terminal devices present in cells of the plurality of communication devices.

10. The communication control device according to claim 1, further comprising
a reception unit that receives a registration request for requesting registration of a device parameter of the first communication device,
wherein the processing unit determines the beam pattern allowable for the first communication device for the target period in which the first communication device can transmit the signal in response to reception of the registration request.

11. The communication control device according to claim 1, further comprising
a reception unit that receives a query request regarding an available spectrum of the first communication device,
wherein the processing unit determines the beam pattern allowable for the first communication device for the target period in which the first communication device can transmit the signal in response to reception of the query request.

12. The communication control device according to claim 1, further comprising
a reception unit that receives a use permission request for requesting a use permission of a spectrum by the first communication device,
wherein the processing unit determines the beam pattern allowable for the first communication device for the target period in which the first communication device can transmit the signal in response to reception of the use permission request.

13. The communication control device according to claim 1,
wherein the plurality of communication devices belongs to a lower layer having a lower priority of radio wave use than the protection target, and
the processing unit performs calculation processing for protecting the protection target from interference by the lower layer in cooperation with another communication control device, and performs detection of the first communication device for the target period and determination of the beam pattern allowable for the first communication device in the calculation processing.

14. The communication control device according to claim 4,
wherein the processing unit divides the plurality of communication devices into one or more groups,
the communication devices belonging to the group are in a relationship in which radio wave interference occurs with at least one other communication device belonging to the group, and
the processing unit determines the setting information for each of the communication devices belonging to the group.

15. The communication control device according to claim 14,
wherein the processing unit is configured to: provisionally determine a plurality of beam patterns allowable for the communication devices in the group on a basis of presence or absence of interference between the communication devices in the group; and
select a beam pattern allowable for the first communication device from the plurality of beam patterns provisionally determined.

16. The communication control device according to claim 3, further comprising:
a reception unit that receives, from the first communication device, first wish information for wishing to acquire information of a beam pattern individually applied to the first target period and the second target period, or second wish information for wishing to acquire information of a beam pattern commonly applied to the first target period and the second target period; and
a transmission unit that transmits information indicating the first beam pattern and the second beam pattern to the first communication device in a case where the first wish information is received, and transmits information indicating the pattern portion in common to the first communication device as a beam pattern allowable for the first communication device in the first target period and the second target period in a case where the second wish information is received.

17. The communication control device according to claim 1,
wherein the processing unit is configured to:
select a beam pattern allowable for the first communication device from a plurality of beam patterns formable by the first communication device; or
determine a beam pattern allowable for the first communication device on a basis of a beam movable range of the first communication device.

18. The communication control device according to claim 1,
wherein the processing unit determines transmission power to be used when the first communication device transmits the signal in the beam pattern.

19. The communication control device according to claim 1, further comprising
a transmission unit that transmits information indicating the beam pattern determined to the first communication device.

20. A communication control method comprising:
detecting a first communication device capable of transmitting a signal in a target period on a basis of setting information defining a period in which a plurality of communication devices is capable of transmitting the signal; and
determining a beam pattern allowable for the first communication device in the target period on a basis of an interference amount given to a protection target by the first communication device.

21. A communication device that performs transmission of a signal and reception of a signal in a time division manner,
the communication device comprising:
a reception unit that receives information regarding a beam pattern allowable for the communication device in a target period of a period in which the signal can be transmitted; and
a processing unit that transmits the signal using the beam pattern based on the information in the target period.

22. A communication method by a communication device that performs transmission of a signal and reception of a signal in a time division manner,
the communication method comprising:
receiving information regarding a beam pattern allowable for the communication device in a target period of a period in which the signal can be transmitted; and
transmitting the signal using the beam pattern based on the information in the target period.
